(19) United States
(12) Patent Application Publication
(10) Pub. No.: US 2026/0339496 A1
(43) Pub. Date: Oct. 29, 2026

(54) ELECTRONIC INFRASTRUCTURE FOR DYNAMIC WHEEL-TYPE DIGITAL INTERFACE

(71) Applicant: Gapodox LLC, San Juan, PR (US)

(72) Inventors: Roberto ZAYAS, San Juan, PR (US); Daniel REYNOLDS, Washington, MI (US); Niraj KUMAR, Guaynabo, PR (US)

(21) Appl. No.: 19/733,718

(22) Filed: Jul. 7, 2026

Related U.S. Application Data
(63) Continuation-in-part of application No. 18/737,715, filed on Jun. 7, 2024.
Application No. 18/737,715 is a continuation-in-part of application No. 18/370,852, filed on Sep. 20, 2023.
Application No. 18/370,852 is a continuation-in-part of application No. 17/948,156, filed on Sep. 19, 2022.
(60) Provisional application No. 63/295,668, filed on Dec. 31, 2021.
(60) Provisional application No. 63/408,425, filed on Sep. 20, 2022.

(51) Int. Cl. G06F 3/04845; G06F 3/0482

(52) U.S. Cl. CPC G06F 3/04845; G06F 3/0482

(57) ABSTRACT

A computer-implemented method and system for generating and dynamically updating a dynamic wheel-type digital interface rendered via a graphical user interface of a client computing device. A plurality of graphical elements of an interface may be arranged within a common region extending radially from an origin element, and may include concentrically-aligned annular regions, unique identifier values arranged about the periphery of annular regions, digital lines encoding qualitative or quantitative properties of the unique identifier values, and action-signal symbols encoding computed action states. One or more data streams may be received from a plurality of sources, normalized, and temporally aligned to generate one or more time-indexed datasets. One or more geometric relationships between two or more graphical elements may be computed from time-indexed datasets, and graphical elements may be incrementally updated in response to detected changes in one or more data streams. An interface may further support performance-based leaderboards, portfolio monetization, and collaborative sharing among user accounts.

### PRIORITY CLAIM AND RELATED APPLICATIONS

This disclosure is a continuation-in-part application of U.S. application Ser. No. 18/737,715, entitled “Real-Time Equity Monitoring System, Process and Interface,” filed Jun. 7, 2024, which is a continuation-in-part application of U.S. application Ser. No. 18/370,852, entitled “Real-Time Equity Monitoring System, Process and Interface,” filed Sep. 20, 2023, which claims the benefit of provisional U.S. Application No. 63/408,425, entitled “Real-Time Equity Monitoring System, Process and Interface,” filed Sep. 20, 2022, and which is a continuation-in-part application of co-pending U.S. application Ser. No. 17/948,156 entitled “Real-Time Equity Monitoring System, Process and Interface,” filed Sep. 19, 2022, which claims the benefit of provisional U.S. Application No. 63/295,668 entitled “Real-Time Equity Monitoring System, Process and Interface,” filed Dec. 31, 2021, the technical disclosures of which are all hereby incorporated by reference in their entireties.

### BACKGROUND

### 1. Field of the Present Disclosure

This application relates generally to methods and apparatus for controlling operation of a computer display to display efficiently information and, more specifically, to user-configurable methods using an apparatus for concurrently and graphically displaying a diverse data set within a common region of a computer display.

### 2.description of Related Art

Conventional control systems for displaying information such as financial information indicative of an equity's performance often divide the information into different sets. For example, charts can be created to display a trend of the equity's price over a defined period of time. Some systems will overlay a plurality of line graphs representing historical price trends for different equities over the defined period of time on the same chart. Viewers of such a chart can readily compare the historical performance of those different equities over the period of time represented.

However, aside from selecting the equities to be represented on the chart, and possibly the period of time encompassed by the chart, users are left with little flexibility to include additional, different information to be presented on a conventional chart for their analysis. Instead, users are required to access separately different information by navigating to a different portion of a network-accessible application. For example, users are typically required to navigate away from the displayed chart to a table of historical dividend information to view information about an equity's dividend history. Other information about the equity would also require navigating to a different interface of a network-accessible application to be viewed. In each instance, the various information viewable from the different interfaces of the network-accessible application must be remembered by the user, or written down for consideration while viewing other information. Navigating between different interfaces of a network-accessible application is not only time consuming and inefficient, but also prevents users from contemporaneously considering multiple different data sets.

More recently, bespoke applications have been developed to include interfaces that can present different data within a common interface. Bespoke solutions allow a plurality of equities to be selected for inclusion within the interface, but they are prohibitively expensive for most private users. Further, modifying bespoke solutions to vary the types of data to be included within a common interface requires amending the application at the program code level, involving dedicated software developers for such an undertaking.

### SUMMARY

Accordingly, there is a need in the art for a system, apparatus, platform and method of allowing users to configure an application to include a plurality of different categories of information, about a plurality of different tradeable assets in a common user interface. Configuration of the application can involve receiving user input specifying the categories of information from a menu included in a graphical user interface, optionally without modification of the application at a program code level.

According to one aspect, the subject application may involve a method for generating a dynamic interface with a computing system to display real-time information about a plurality of content items within a collection. A content item can include any item of content for which data is tracked or monitored, such as, for example, tradeable assets (e.g., stocks, bonds, cryptocurrencies, and the like), sports statistics, media engagement metrics, etc. A collection can include any grouping of content items, for example, a financial portfolio, a sports team roster, a watchlist, a curated media library, etc.

The method may include receiving data for one or more of a plurality of content items, wherein the data may be received in real-time. The method can further include generating a node for one or more content items of a plurality of content items based, at least in part, on data relating to the respective content item. A node may include a first characteristic indicative of a volume relative to a plurality of content items within a collection and a second characteristic indicative of an activity trend. An activity trend may include any directional or behavioral pattern associated with a content item, for example, trading momentum (e.g., price movement direction, velocity, and the like), athletic performance trends, engagement velocity, viewership trends, etc.

The method can further include generating a dynamic interface to display real-time information about a plurality of content items. A dynamic interface may include a node for at least one content item located within a circular common area of the dynamic interface. Nodes may be positioned between a center of a circular common area and an outer edge of the circular common area, the positions based, at least in part, on a first characteristic of a corresponding node. One or more nodes may have an angular movement based, at least in part, on a second characteristic, and a dynamic interface may update with real-time changes in data relating to any content item.

The method may further comprise receiving one or more data streams from a plurality of distinct sources, the one or more data streams comprising real-time updates and historical data records associated with one or more unique identifier values of one or more content items. One or more data streams may be normalized and temporally aligned to generate one or more time-indexed datasets organizing real-time updates and historical data records according to one or more unique identifier values and a time dimension. One or more geometric relationships between two or more graphical elements of a dynamic interface may be computed based at least in part on one or more time-indexed datasets, and the two or more graphical elements may be incrementally updated in response to detected changes in the one or more data streams based at least in part on one or more geometric relationships.

In another aspect, a subject application may involve a non-transitory computer readable medium. A non-transitory computer readable medium may store instructions that when executed by one or more processors cause the one or more processors to receive data for a plurality of content items, wherein the data may be received in real-time.

Instructions may further one or more processors to generate a node for one or more content items of the plurality of content items based, at least in part, on data relating to the one or more content items. Nodes may include a first characteristic indicative of a volume metric relative to the plurality of content items within a collection and a second characteristic indicative of an activity trend. The instructions may further cause one or more processors to generate a dynamic interface to display real-time information about plurality of content items. A dynamic interface may include a node for one or more content items located within a circular common area of the dynamic interface. One or more nodes may have a position between a center of a circular common area and an outer edge of the circular common area, the position based, at least in part, on a first characteristic of the respective node. One or more nodes may have an angular movement within a circular common area, the angular movement based, at least in part, on a second characteristic, and a dynamic interface may update with real-time changes in data of any of the plurality of content items.

The method may further comprise computing a performance score for individual ones of a plurality of user accounts based at least in part on electronic activity records occurring on or after a performance baseline date, ranking a plurality of user accounts within one or more participant categories, and rendering a leaderboard data structure within a graphical user interface. The method may further comprise facilitating monetization of content displays between user accounts via time-bounded access tokens, and establishing communication sessions among user accounts rendered in association with shared content displays, including aggregating asset holdings across two or more shared displays into a common holdings display region.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented in the pages that follow.

### BRIEF DESCRIPTIONS OF THE DRAWINGS

The present disclosure may take physical form in certain parts and arrangement of parts, embodiments of which will be described in detail in this specification and illustrated in the accompanying drawings which form a part hereof and wherein:

FIG. 1 shows an illustrative embodiment of a computer-based system for controlling operation of a display to generate an interface including different categories of content, for a plurality of different tradeable assets within a common region of the interface.

FIG. 2 is a flow diagram schematically illustrating an illustrative embodiment of a computer-implemented process for controlling operation of a display to generate a graphical user interface that concurrently presents different categories of content, for a plurality of different tradeable assets.

FIG. 3 shows an illustrative embodiment of a category content menu allowing user configuration of the categories of content to be represented in a graphical user interface.

FIG. 4 shows an illustrative embodiment of a tradeable asset menu allowing user configuration of the tradeable assets to be represented in a graphical user interface.

FIG. 5 shows an illustrative embodiment of an interface that includes a common region that concurrently displays graphical representations of numeric data and transaction data relating to a plurality of tradeable assets.

FIG. 6 is another flow diagram schematically illustrating an illustrative embodiment of a computer-implemented process for controlling operation of a display to generate a graphical user interface that concurrently presents different categories of content, for a plurality of different tradeable assets.

FIG. 7A shows an illustrative embodiment of a dynamic interface of a plurality of nodes representing tradeable assets.

FIG. 7B shows another illustrative embodiment of a dynamic interface of a plurality of nodes representing tradeable assets.

FIG. 8A shows an illustrative embodiment of a connection indicator between tradeable assets.

FIG. 8B shows an illustrative embodiment of industries and sectors regarding the connection indicator.

FIG. 9 shows an illustrative embodiment of a dynamic interface of a plurality of wedges representing tradeable asset classes.

FIGS. 10A-10B illustrate screenshots setting forth example leaderboards of ranked users/traders.

FIG. 11 illustrates a screenshot of an example “wheel” interface that concurrently displays graphical representations of numeric data and transaction data relating to a portfolio of tradeable assets.

FIG. 12 illustrates a screenshot displaying information to a user when the “Data” button of the screen shown in FIG. 11 is selected.

FIGS. 13A-13C illustrate a screenshot displaying example alerts displayed to a user regarding the tradeable assets in his portfolio or tradeable assets the user elects to follow.

FIG. 14 illustrates a screenshot of another embodiment of a dynamic wheel interface, where this wheel interface provides a dynamic visual representation tracking a plurality of tradeable assets.

FIG. 15 illustrates a screenshot displaying information to a user when the “Data” button of the screen shown in FIG. 14 is selected.

FIGS. 16A-16C illustrate a screenshot displaying example alerts to a user regarding the tradeable assets displayed in the interface of FIG. 15 when the “Alerts” button is selected.

FIG. 17 illustrates a screenshot of another embodiment of a dynamic wheel interface, where this wheel interface provides a dynamic visual representation tracking a plurality of assets comprising stock options.

FIG. 18 illustrates a screenshot displaying information regarding the option assets displayed on the wheel interface of FIG. 17 when the “Data” button is selected.

FIGS. 19A-19C illustrate a screenshot displaying example alerts to a user regarding the option assets displayed in the interface of FIG. 17 when the “Alerts” button is selected.

FIG. 20 illustrates a screenshot of another embodiment of a dynamic wheel interface, where this wheel interface provides a dynamic visual representation tracking a plurality of cryptocurrencies.

FIG. 21 illustrates a screenshot displaying information to a user when the “Data” button pf the screen shown in FIG. 20 is selected.

FIGS. 22A-22B illustrate a screenshot displaying example alerts to a user regarding the cryptocurrency assets displayed in the interface of FIG. 20 when the “Alerts” button is selected.

FIG. 23 illustrates a screenshot of a list of certain portfolios that are known through the platform.

FIG. 24 illustrates a screenshot of a different list of portfolios that are accessible through the platform.

FIG. 25 illustrates a screenshot of a list of portfolios that are being “followed” by a user of the platform.

FIG. 26 illustrates a screenshot of another embodiment of a dynamic wheel interface, where this wheel interface provides a dynamic visual representation tracking a plurality of tradeable assets commonly held in portfolios being “followed” by the viewing user.

FIG. 27 illustrates a screenshot displaying information regarding the commonly held assets displayed on the wheel interface of FIG. 26 when the “Data” button is selected.

FIGS. 28A-28B illustrates a screenshot displaying example alerts to a user regarding the option assets displayed in the interface of FIG. 26 when the “Alerts” button is selected.

FIG. 29 illustrates an embodiment of a computing system configured with the systems and/or processes disclosed herein.

### DETAILED DESCRIPTION

Certain terminology is used herein for convenience only and is not to be taken as a limitation on the present disclosure. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

References made throughout to equities, trading, markets, and the like are merely examples intended to illustrate one possible implementation of the present disclosure and are not meant to be limiting in any way. The present disclosure may be applied to any context in which real-time or dynamic data is associated with a plurality of content categories, for example, sports and athletic performance tracking, social media and engagement analytics, media consumption and viewership data, health and biometric monitoring, etc.

There is a need in the art for apparatus and methods for controlling operation of a computer display to generate an interface including different categories of content, for, for example, a plurality of different tradeable assets within a common region of the interface. For example, a migration of equities trading to electronic exchanges accessible over a communication network, such as the Internet, for example, has made real-time information readily available to traders conducting research on equities and other tradeable assets. Traders have traditionally been required to collect different types of information for individual equities from different interfaces, such as a summary page, a table of historical dividend payments, a compilation of insider transactions, etc. Different categories of information may then be separately considered by traders to make a decision regarding whether to buy, sell or hold an individual equity.

The above process is time consuming for traders with large portfolios because individual equities were researched separately. Further, the above process is substantially the same process performed by traders in the pre-Internet era, although using more up-to-date information. Rather than compiling different categories of information about equities from printed publications, real-time data is retrieved electronically from a database. The end result is that traders separately considered different categories of information about equities, individually, and then moved on to research the next equity of interest.

In contrast, the present disclosure controls operation of a computer display to generate an interface comprising a common region that concurrently displays content within a plurality of different categories, such as, for example, for a plurality of different tradeable assets such as equities. Such equities and tradeable assets may include any category of information for which dynamic data may be garnered and displayed to a user in the manner disclosed herein. For example, assets or equities may be financial in nature, such as corporate stocks or commodities like oil, gas, natural gas, and other energy industries, or may be non-financial or entertainment in nature, such as sports statistics and related data. The present disclosure may be user configurable, which may allow a user to select or otherwise specify, without modification at a program code level of an executable application: (i) different content items, and (ii) the different content items may be concurrently displayed in a common region of an interface for different content items. Data falling within different categories may be retrieved for selected content items over a communication network such as the Internet, for example, and concurrently and graphically represented within a common region of an interface. Upon viewing a common region of an interface, a user can readily glean for one or more categories, based, at least in part, on graphical elements within the common region, one, a plurality, or all of:
(i) whether one or more particular events has occurred and/or will occur,
(ii) a timing of any events that have occurred and/or will occur,
(iii) a quantity of events that have occurred,
(iv) whether an item offers an occasional distribution, and
(v) a recommendation whether to conduct a transaction involving the item.

Unlike traditional technologies, the present technology may allow users to configure a collection of content items, and all categories of content desired by the users to be concurrently displayed using graphical elements within a common region of an interface. As a result, significantly more information can be aggregated from remote terminals, and displayed within a region of an interface than if underlying data was displayed in a purely alpha-numeric format. Because much of the underlying data changes in real time based, at least in part, on activity occurring on electronic exchanges as sales, option grants/exercises, dividend payments, etc. occur, the present disclosure allows for consideration of large amounts of data in a timely fashion, before conditions change. A display controlled as described herein can therefore present a larger quantity of information than it otherwise could by displaying underlying data. Further, concurrently-displayed graphical elements may convey trends in underlying data that may not be immediately visible from a purely alpha-numeric display. Users may be able to evaluate all categories of content graphically represented within a common region of an interface, for a full collection of content items. Such an evaluation can occur without requiring users to navigate to various different interfaces and separately evaluate different categories of content, such as for an individual tradeable asset, greatly improving the efficiency of the interface. A collection configuration may optionally be saved by users in a user account, to be opened and updated without requiring a user to reconfigure the collection.

### Example System

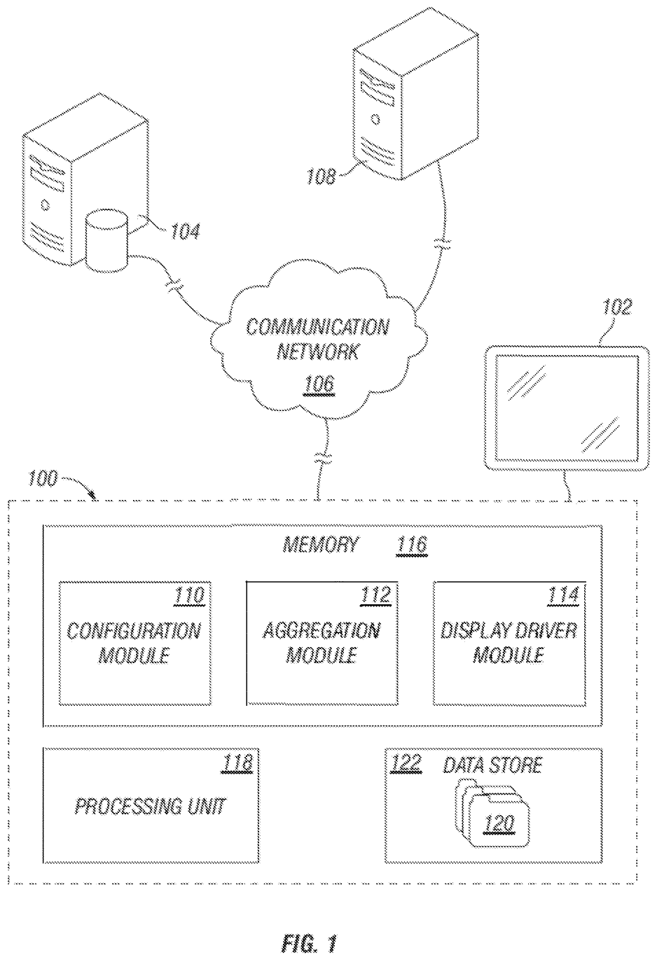

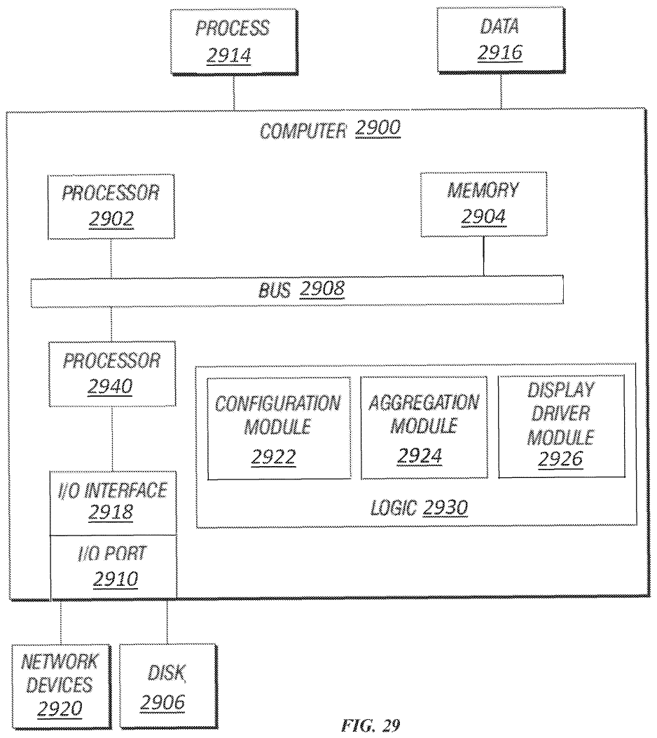

With reference to the drawings, FIG. 1 shows an illustrative embodiment of a computing system 100 for controlling operation of a computer display 102 to display a graphical user interface, as described below. A graphical user interface may include different categories of content, such as for a plurality of different tradeable assets, graphically represented within a common region of the interface. In one embodiment, the computing system 100 may be implemented as a computing device 2900 described in detail below with respect to FIG. 29. According to another embodiment, the computing system 100 may be a computing/data processing system including an application or collection of distributed applications for enterprise organizations. Applications and computing system 100 may be configured to operate with, or be implemented as a cloud-based networking system, a software as a service (SaaS) architecture, a node in a cluster computing system or another type of network architecture.

In one embodiment, the computing system 100 may be a centralized server-side application that performs at least the computerized functions disclosed herein and that electronically communicates with a plurality of nodes such as a database server 104, for example, over a communications network 106 such as the Internet. The computing system 100 and one or more remote terminals such as the database server 104 may optionally operate together to store and process data as described herein.

The present disclosure describes embodiments of the computing system 100 as a client-side application locally connected to the computer display 102 for the sake of brevity and clarity. However, alternate embodiments of the computing system 100 can be deployed as a server-side, hosted application that performs the functions described herein, for concurrent connections with a plurality of network-connected terminals. For example, web server 108 can be configured with a hosted application accessible by remote terminals such as the computing system 100 over the communication network 106. The web server 108 can access the database server 104 to retrieve data included in different categories of content as described herein, and to serve content over the communication network 106 to the computing system 100 to be displayed by the computer display 102.

One or more of the components of the computing system 100 can be embodied as program modules (e.g., configuration module 110, aggregation module 112, display driver module 114) stored in a memory 116 of the computing system 100. Program modules may be configured with instructions that, when executed by circuitry of at least a processing unit 118, cause the computing system 100 to perform the corresponding function(s).

As described in greater detail with reference to FIG. 29, the processing unit 118 can be, for example, one or more hardware processors, such as, a microprocessor, central processing unit (CPU), application-specific integrated circuit (ASIC), or similar hardware device, or array thereof. The processing unit 118 may be connected via circuitry (e.g., a bus) to the memory 116 and to the data store 122 via one or more input/output controllers. The memory 116 may be, for example, a non-transitory memory such as a cache memory of a processor, a flash memory, a random-access memory (RAM), cache memory or other active memory that stores instructions executed by the processing unit 118.

One or more data structures 120 storing data of a user account associated with a trader can be stored in the data store 122. The data store 122 can be, for example, a flash memory, hard-disk drive or similar volatile or non-volatile computer-storage media. Accordingly, the processing unit 118 uses the data store 122 and/or the memory 116 to store various data when performing the functions described herein. As shown in FIG. 1, the data store 122 may be integrated with the computing system 100. Of course, in other embodiments, the data store 122 can be implemented as a distributed storage that is shared among one or more remote devices such as the database server 104 and the web server 108, and the computing system 100 in a distributed file system.

As used herein, the communication network 108 may comprise a computer network hardware, software applications, public communication transmission components such as public telephone switching networks and the like to facilitate packetized or other communications between the computing system 100 and remote devices as described herein. For example, the communication network 108 can comprise a local area network (“LAN”), a wide area network (“WAN”), the Internet, or a combination thereof.

### Example Process for Generating an Interface

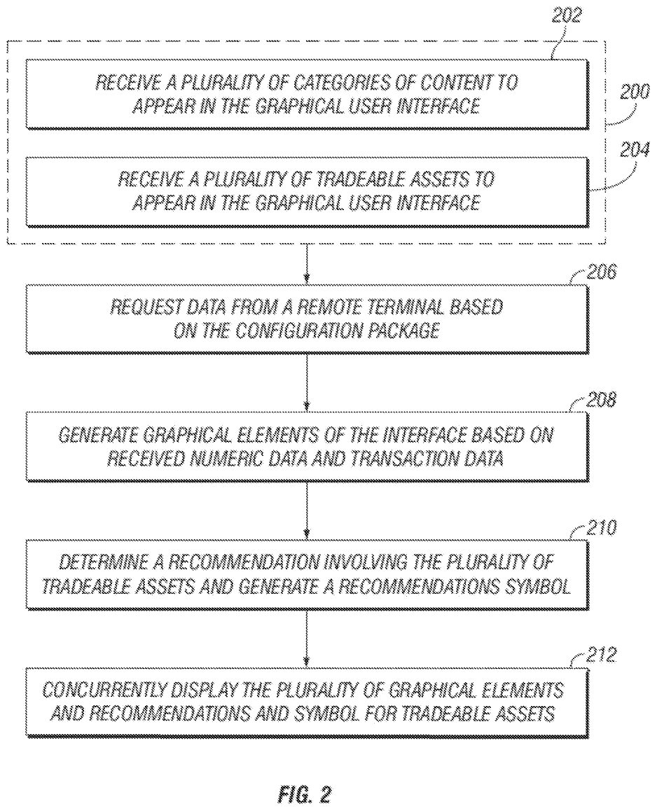

An illustrative embodiment of a computer-implemented process of controlling operation of the computer display 102 to generate a graphical user interface is shown in FIG. 2. The graphical user interface concurrently and graphically presents content in a plurality of different categories, for a plurality of different tradeable securities, within a common display region of the interface.

At block 200 in FIG. 2, a configuration module of a computing system may receive a configuration package that defines categories of content, and tradeable assets that may be concurrently displayed within a common region of an interface. For example, as part of a configuration package, a configuration module may receive user-defined categories of content at block 202, and a plurality of tradeable assets at block 204. Categories of content are described herein as being user-configurable, or user-defined, meaning a user of the present disclosure can individually select, or otherwise specify the categories the user desires to appear in an interface.

At block 206, an aggregation module may communicate with a remote server over a communication network to request and retrieve data within categories of content, and for tradeable assets specified in the configuration package. The data may request at least numeric data and transaction data corresponding to the tradeable assets. As an example, numeric data for selected tradeable assets may include, but is not limited to:
sales prices of a tradeable assets involved in transactions (e.g., sales) that occurred within a defined historical period of time preceding a date on which data is requested,
the current market price of a tradeable asset at a time data is requested, and
option strike prices for a tradeable asset at a time data is requested.

Examples of transaction data for tradeable assets selected may include, but is not limited to:

Historical trades (e.g., purchases, sales and option grants) involving insiders affiliated with a corporation related to a tradeable asset, or have access to information related to a tradeable security that is not publicly available. As specific examples, information about historical trades requested can include at least one of, for tradeable assets selected, a name and title of insiders who have traded the tradeable asset, dates on which the insiders have traded the tradeable asset, a volume of the tradeable asset traded by the insiders, and whether the insider has engaged in at least one of: (i) a purchase of the tradeable asset, (ii) a sale of the tradeable asset, (iii) an exercise of an option issued for the tradeable asset, and (iv) a receipt of a grant of the tradeable asset, and
upcoming dividend payments scheduled to be paid to holders of the tradeable security within a defined period of time from the date on which the data is requested.

At block 208 in FIG. 2, a display driver module may generate graphical elements of an interface, an illustrative embodiment of which is shown in FIG. 5, based, at least in part, on numeric data and transaction data received by an aggregation module. For example, the interface 500 can include a common region 502 (enclosed by broken lines) in which graphical elements may be concurrently displayed, to convey graphically information related to numeric data and transaction data received by an aggregation module.

Data received by an aggregation module from one or more remote sources may be characterized as one or more data streams. A data stream may refer to a continual or periodic flow of data records transmitted from a remote source to a computing system, the data records comprising real-time updates and/or historical data records associated with one or more unique identifier values. In addition to aggregating such data streams for display, an aggregation module may further process one or more data streams through a normalization and temporal alignment pipeline prior to computing geometric relationships used to position a plurality of graphical elements of a dynamic wheel-type digital interface.

A computing system may normalize and temporally align one or more data streams to generate one or more time-indexed datasets. As used herein, normalization may refer to the process of converting data records from a plurality of distinct formats into a common schema or representation, such that data from different sources may be processed and compared in a consistent manner. Temporal alignment may refer to a process of associating data records from a plurality of distinct sources with a common time dimension, such that data records received at different sampling rates or with different timestamps may be organized into a coherent temporal sequence for one or more unique identifier values. A time-indexed dataset may refer to a data structure that organizes data records according to both a unique identifier value and a time dimension, enabling a computing system to retrieve and compare data records for a particular unique identifier value at any particular point in time. For example, when data streams are received from a plurality of distinct sources at different sampling rates and in different formats, an aggregation module may apply normalization procedures to standardize one or more data streams into a common schema and may temporally align data records so that updates from different sources may be meaningfully combined and compared for one or more identifier values at any particular point in time. Resulting time-indexed datasets may associate individual data records with both a unique identifier value, such as a ticker symbol, an athlete identifier, a content item identifier, or any other content category identifier, and a timestamp, enabling a display driver module to compute one or more geometric relationships between graphical elements of the dynamic wheel-type digital interface based on consistently-structured, temporally-coherent underlying data.

One or more geometric relationships computed from one or more time-indexed datasets may define a topological correlation between a plurality of graphical elements of a graphical user interface. A topological correlation may refer to a spatial relationship between two or more graphical elements that reflects an underlying relationship in data from which those elements are derived. A topological correlation may comprise a visual framework that transforms uncorrelated variables, such as independently-sourced, heterogeneous data streams, into correlated visual outputs, such as a mixed digital signal used to determine one or more positional relationships among the plurality of graphical elements of a dynamic wheel-type digital interface. In this way, disparate data received from a plurality of distinct sources may be mapped through the time-indexed dataset structure into a coherent spatial arrangement on an interface, where the relative positions, sizes, and movements of graphical elements may reflect underlying data relationships in a visually meaningful and interpretable manner

A computing system may maintain a persistent streaming connection to one or more remote data sources to continually receive data stream updates as they occur at a source. A persistent streaming connection may refer to an open network connection maintained between a computing system and one or more remote data sources, through which data records may be received continually as events occur at respective data sources, rather than at fixed polling intervals. A computed indicator state value may refer to a derived value computed from one or more data records in the one or more data streams, a computed indicator state value representing a quantitative or qualitative property of a unique identifier value at a particular point in time. When a detected change in at least one computed indicator state value for one or more unique identifier values is identified from an incoming data streams, a system may trigger an incremental positional update to one or more graphical elements of a plurality of graphical elements of an interface. An incremental positional update may refer to an update applied to one or more individual graphical elements of an interface without performing a full re-render of the dynamic wheel-type digital interface. For example, if trading momentum of a single tradeable asset changes, only graphical elements associated with that asset, such as its corresponding digital line, digital field, or action-signal symbol, may be incrementally updated, while the remainder of an interface may remain unchanged. This incremental refresh approach may reduce computational overhead, minimize latency, and improve the responsiveness of the interface to real-time changes in the one or more data streams.

Referring again to FIG. 2, based, at least in part, on a totality of factors specified in a configuration package, a display driver module may determine, at block 210, a recommendation involving a plurality of tradeable assets represented in the common region (see FIG. 5) of the interface.

At block 212 in FIG. 2, a display driver module may control transmission of a signal to a display, to cause the display to present an interface to a user. Based, at least in part, on information graphically conveyed by an interface, a user can initiate a recommended transaction involving one or more tradeable assets. An interface may include a common region in which, for tradeable assets in a configuration package, an activity symbol may be arranged within a central region of the common region, a dividend symbol may overlay a portion of the activity symbol, and a recommendation symbol may be arranged about a perimeter region of the activity symbol. According to alternate embodiments, a display driver module can transmit a signal that may automatically trigger a transaction involving a tradeable asset, without human intervention, based, at least in part, on a recommendations determined by a display driver module.

### Example Menus

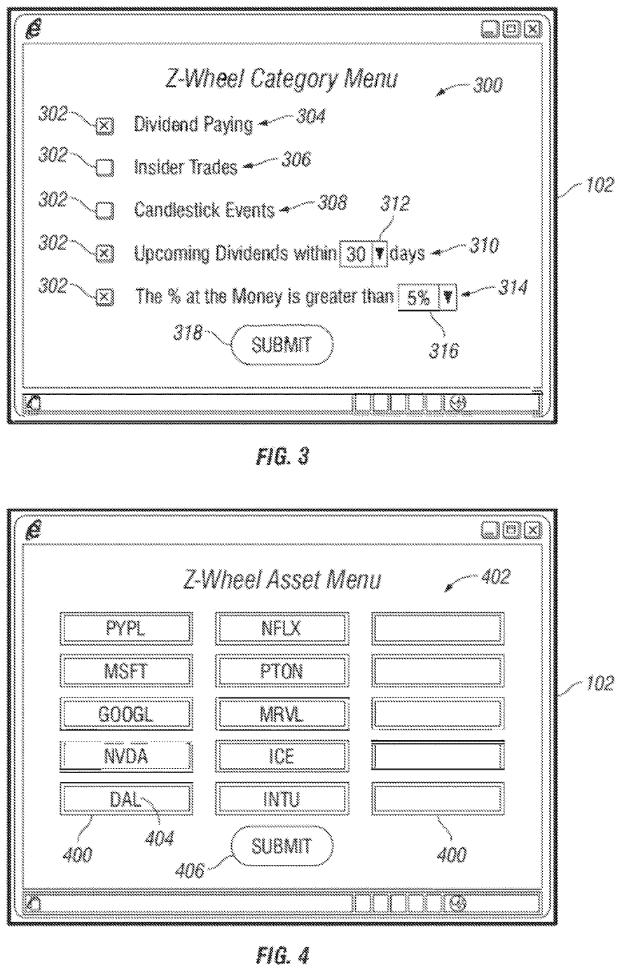

Turning to FIG. 3, by way of example, a defined list of available categories can be displayed in a menu 300 by a computer display as shown in the embodiment of FIG. 3. The user can select check boxes 302 for a plurality (but fewer than all available options), or all available options of categories available from the menu 300. According to alternate embodiments, any suitable selection mechanism other than check boxes 302, such as radio buttons, pull-down menus, text entry fields, etc. can be used in place of, or in addition to the check boxes 302 shown in FIG. 3.

For the embodiment shown in FIG. 3, the menu 300 includes the following available categories of content that may be included in an interface: dividend paying tradeable assets 304—designation of those tradeable assets selected for inclusion that issue occasional, and optionally regular distributions of currency. insider trades involving the tradeable asset 306—indications of whether trades have occurred within a defined time frame, involving a tradeable asset by any party that has access to information material to a price of the tradeable asset that is not available to the general public.

Candlestick events 308—a price chart format that can be used for technical analysis may include a graphic that concurrently displays high, low, open, and closing prices for a specific period for a particular financial instrument is referred to as a “candlestick” chart. Designed similar to a candlestick marker (discussed below in further detail and shown in FIG. 5), a candlestick may include an upper tail and lower tail that represent high and low prices, respectively, achieved for an instrument during a time period, typically a trading session, such as a day, for example. A body segment may be rectangular in shape, and may represent an opening and closing for a trading period, and can be color coded to represent whether an instrument closed at a higher or lower price than it opened. Patterns can be both simple and complex, and optionally user-definable through a selection of desired criteria via interfaces within the menu 300. For example, a user can establish candlestick criteria that includes at least one of a threshold: opening price, closing price, high price, and low price during a trading session. Satisfaction of at least one, a plurality (but less than all), or all the candlestick criteria during a trading session may constitute a candlestick event. Although the foregoing example describes a candlestick pattern as defining high, low, close and open prices, it is understood that other patterns indicative of market manipulation can constitute “candlestick” patterns, as used herein. For example, criteria can be user-defined in the menu 300 to be satisfied according to so-called EG Wyckoff distribution patterns can be used to determine when/if “candlestick” events have occurred. Wyckoff patterns are helpful to determine when large-volume investors build short positions or distribute long positions and surpass the activity of retail traders. Large-volume investors distribute positions gradually to avoid the price from changing significantly before they can complete their distributions. For the sake of brevity and clarity, however, embodiments utilizing the high, low, close open criteria of candlestick events are described herein.
upcoming dividend or other distribution 310 scheduled to be paid within a defined period of time 312 defined by a user from a date on which the data is to be requested; and
a percentage of at the money 314 exceeds a defined percentage 316 specified by a user—a percentage of a tradeable asset that is at a market price within the defined percentage 316 (or other tolerance) of an option strike price for a defined percentage of outstanding options to purchase the tradeable asset. However, other embodiments of the present disclosure can include a subset of the options in the menu 300, or additional options not shown in the embodiment of the menu 300 in FIG. 3. Upon selecting desired categories of content, a selection can be submitted for inclusion in a configuration package in response to selection of the confirmation button 318.

The menu 300 is provided as one example of a user interface for selecting categories of content and is not limited to financial or market-related implementations. In other configurations, the menu 300 can be adapted to present categories associated with other domains, such as sports metrics, performance analytics, health data, media consumption preferences, and/or other structured or semi-structured datasets, etc. For example, in a sports-related implementation, the categories of content can correspond to team statistics, player performance metrics, game outcomes, positional groupings, and/or historical trends, etc., and selection of such categories can be used to configure visualizations, filtering operations, and/or analytical outputs. Accordingly, the structure, labeling, and organization of the menu 300 can be modified based at least in part on an underlying dataset, user objectives, and/or application context, while maintaining similar interaction patterns for selecting and submitting categories of content for inclusion in a configuration package.

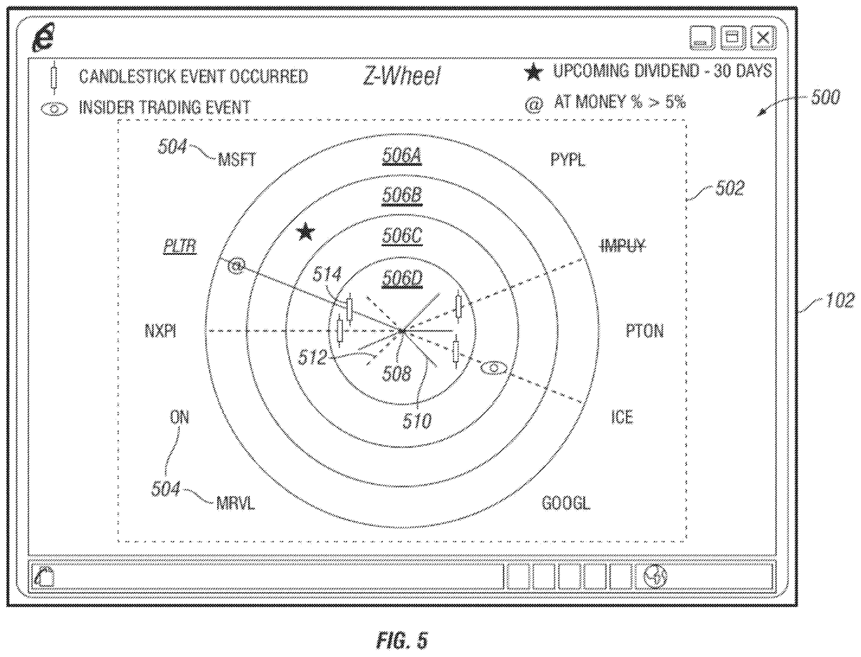

In addition to a desired categories of content, a user can also define a plurality of content items that may be included in an interface. For the illustrative embodiment shown in FIG. 4, ticker symbol entry fields 400 can be included in a tradeable asset selector 402. Stock ticker symbols representing equities of specific corporations can be entered in fields for inclusion in a configuration package defining tradeable assets represented in an interface. In FIG. 4, the ticker symbol DAL 404 is typed into one of the ticker symbol entry fields 400. In response to selection of the confirm button 406, the equities of Delta Airlines and other tradeable assets may be incorporated into a configuration package, to be included in an interface. According to alternate embodiments, a name, or a portion of a name of the corporation can be entered into the ticker symbol entry fields 400, and a lookup may be performed in the background. According to some embodiments, at least ten (10), and up to fifty (50) tradeable assets can be submitted in a configuration package for inclusion in an interface.

A configuration package may include user-definable settings for generation of an interface as described herein, and may be stored by a configuration module in a data structure in a data store. A data structure can also associate a configuration package with a user account of a user, allowing the user to save the configuration package for future evaluations of the user's portfolio. By specifying categories of content and tradeable assets that are to appear in an interface, a user is able to configure a computing system to display the desired content without modifying source/program code of a configuration module.

The tradeable asset selector 402 and associated ticker symbol entry fields 400 are provided as one example of a mechanism for identifying individual items to be included in an interface and are not limited to equities or ticker symbols. In other configurations, the selector 402 can be adapted to receive alternative identifiers corresponding to items in different domains, such as player names or team identifiers in a sports metrics implementation, sensor identifiers in an industrial monitoring system, media titles in a content platform, and/or other identifiers associated with domain-specific data, etc. For example, in a sports-related implementation, a user can input identifiers corresponding to athletes, teams, games, and/or statistical categories, and a system can perform a lookup based at least in part on provided identifiers to retrieve associated data for inclusion in an interface. Accordingly, the structure and input format of the selector 402 can vary based at least in part on the type of data being accessed, while maintaining functionality for specifying a set of items to be incorporated into a configuration package.

Similarly, a configuration package and associated data structure are not limited to financial portfolio evaluation and can be utilized across a range of application contexts. In other implementations, a configuration package can store user-defined settings corresponding to selected categories of content and identified items in domains such as sports analytics, health monitoring, media consumption, and/or other data-driven environments, etc. The association of a configuration package with a user account enables persistence of user preferences across sessions, allowing repeated generation of customized interfaces based at least in part on previously defined selections. By specifying categories of content and corresponding items for inclusion, a user can configure a computing system to generate tailored visualizations, filtering operations, and/or analytical outputs without modification of underlying program code.

### Example Wheel Interface

Referring to FIG. 5, an interface 500 that includes a common region 502 that concurrently displays graphical representations of numeric data and transaction data relating to a plurality of tradeable assets is shown. According to the embodiment shown in FIG. 5, the plurality of ticker symbols 504 defined a the configuration package are arranged about a periphery of a plurality of concentrically-aligned, annular regions 506A, 506B, 506C, 506D. Information pertaining to ticker symbols 504 may be designated by placement of one or more graphical elements in the annular regions 506A, 506B, 506C, 506D, extending in a radial direction from an origin 508 towards the respective ticker symbol 504. Placement of the ticker symbols 504 may be indicative of the volume of tradeable assets corresponding to the ticker symbols 504. In one embodiment, the placement of the ticker symbols 504 may be indicative on increasing volume, with volume increasing in a clockwise direction. For example, PYPL would have the smallest volume relative to the portfolio and MSFT would have the largest volume relative to the portfolio. In another embodiment, the placement of the ticker symbols 504 may be indicative on increasing volume, with volume increasing in a counterclockwise direction. For example, MSFT would have the smallest volume relative to the portfolio and PYPL would have the largest volume relative to the portfolio.

The interface 500 may further include a line extending from the origin 508 toward ticker symbols 504. Lines can be dividend symbols that include at least: (i) a first variable aspect, and (ii) a second variable aspect. An example of a first variable aspect can be an appearance of a line that graphically indicates whether a dividend is paid to holders of a tradeable asset. In FIG. 5, for example, a solid line 510 having a relatively-light line weight may indicate that a tradeable asset with a corresponding ticker symbol, GOOGL in this example, does not pay a dividend. In contrast, a broken line 512 having a relatively-heavy line weight may indicate that a tradeable asset with a corresponding ticker symbol, MRVL in this example, does pay a dividend. However, other graphical aspects of a line such as a color code, a size, a shape, or any other graphical element can be utilized as a first variable aspect. For example, a first color line (e.g., grey) may graphically indicate that a tradeable asset does not pay a dividend and a second color line (e.g., green) may indicate that a tradeable asset pays a dividend.

A second variable aspect of lines can graphically indicate a relative quantity of events that occurred, or are scheduled to occur involving a tradeable asset. According to the illustrative embodiment in FIG. 5, the longer the line, the greater the number of events that have occurred, or are scheduled to occur involving a tradeable asset. As a specific example, a number of events that have occurred involving the tradeable asset ICE is greater than a number of events that have occurred involving the tradeable asset PTON. However, other graphical aspects of a line such as a color code, a size, a shape, or any other graphical element can be utilized as a first variable aspect. According to some embodiments, examples of events may include, but are not limited to: candlestick events, insider trades, impending dividend events, any other event, and any combination thereof. Thus, for the embodiment shown in FIG. 5, a first variable aspect (e.g., solid, low-weight line v. broken, heavy-weight line) indicates whether a respective tradeable asset pays a dividend, and a second variable aspect (length of line) indicates a number of events that have occurred, or will occur.

In addition to lines, additional symbols can be arranged within the annular regions 506A, 506B, 506C, 506D, in a radial direction extending from the origin 508 to the respective ticker symbol 504. For example, a marker such as the “at” symbol (@) can be placed in annular region 506A, which can be designated for markers that identify tradeable assets for which an “at the money” percentage exceeds a user-configurable percentage specified in a configuration package. An “at the money” percentage is a percentage of outstanding options for a tradeable asset that, at a current market price, is within a defined tolerance of an option strike price. In the illustrative embodiment of FIG. 5, a defined tolerance was specified as five (5%) in a configuration package.

Similarly, annular region 506B can be designated to display markers such as a star (★), which is indicative of an upcoming dividend payment within a user-defined period from a date on which a numeric and transaction data is received by an aggregation module 112. In the example of FIG. 5, the star (★) may indicate that the tradeable asset MSFT has an upcoming dividend payment within the next thirty (30) days.

Annular region 506C can be designated to display markers such as an eye, which may indicate an insider trading event has occurred. Insider trades involve a transaction involving the respective tradeable asset by a party who has information that is not available to the general public. Whether an insider trading event has occurred may be determined by a display driver module based, at least in part, on transaction data received by an aggregation module.

Annular region 506D can be designated to display markers such as candlestick marker 514 in FIG. 5. The candlestick marker 514 may include a vertical, rectangular section that indicates an open and close prices of tradeable asset, an upward projecting line that identifies a high price achieved by the tradeable asset during a trading session, and a downward projecting line that identifies a low price achieved by the tradeable asset during the trading session. A configuration package can optionally be configurable by a user to specify a high, low, open close prices to be satisfied for designation of a tradeable asset with the candlestick marker 514.

The common region 502 may comprise additional annular regions. For example, an annular region may be designated to display markers indicative of a strong or weak lunar phase performance for a tradeable asset, which may be based, at least in part, on received data. If an asset performs better around a new moon phase, an indication may be presented notifying a user that a tradeable asset may be entering a historically better performing period. Alternatively, a different indication may be presented notifying a user that a tradeable asset may be entering a historically weaker performing period if in a full moon phase. Thus, it is advantageous to provide a user with indications of lunar cycle performance that enables the user to capitalize on forthcoming performances.

The common region 502 may also comprise a natural ratio region. A natural ratio region may be based, at least in part, on a correlation of a trading movement of a tradeable asset and the Fibonacci sequence. A natural ratio may be obtained by dividing successive pairs of Fibonacci numbers, yielding approximately 1.618 (or conversely 0.618). A natural region may utilize Fibonacci retracements, Fibonacci arcs, Fibonacci fans, Fibonacci zones, or any combination thereof to determine a natural ratio for a tradeable asset. A determination may also utilize other methods. For example, an annular region may be designated to display markers indicative of a strong or weak performance for a tradeable asset correlated to a natural ratio based, at least in part, on received data. If an asset is projected as performing better in the future, an indication may be presented notifying a user that the tradeable asset may be entering a historically better performing period. Alternatively, a different indication may be presented notifying a user that a tradeable asset may be entering a historically weaker performing period if projected to lose value.

The common region 502 may also comprise a crowded short selling region. A crowded short selling region may be based, at least in part, on data indicating a large amount of short selling positions for a tradeable asset, indicating increased risk in purchasing a short position on the tradeable asset. If an asset is demonstrating a crowded short sell tendency, an indication may be presented notifying a user that a tradeable asset may be entering a risky performing period. The common region 502 may also comprise a call option region and/or a put option region. Option regions may provide a user with information indicating whether other investors are predicting a strong or weak performance on a tradeable asset. An indication may be presented notifying a user that a tradeable asset may be entering a projected better performing period based, at least in part, on option positions. Accordingly, it may be advantageous to provide annular regions and corresponding indications in this manner because a user can make decisions with all pertinent information on one screen. Thus, a user can promptly execute trades, maximizing the value of the trades. Without having information presented in this manner, a user would not be able to execute prompt trades and fail to maximize a position.

In addition to markers described above, one or more concentrically-aligned annular regions of a dynamic wheel-type digital interface may further display one or more analytically-derived markers generated from computed financial metrics associated with one or more unique identifier values. In embodiments where one or more unique identifier values correspond to tradeable assets for which options data is available in one or more data streams, a computing system may perform covered call analysis to generate one such marker. A covered call position may refer to a financial position in which a holder of a long position in a tradeable asset simultaneously writes, or sells, a call option on that asset at a defined strike price. For at least one unique identifier value for which options data is available, a system may compute a net debit or net credit for one or more covered call positions. A net debit or net credit may refer to the net financial result of entering a covered call position, and may be computed based, at least in part, on a current market price, option premium, and strike price data received in the one or more data streams. A system may further compute an annualized return for at least one covered call position. An annualized return may refer to a projected return on investment expressed as a percentage on an annualized basis, and may be computed based at least in part on a net credit received and the duration of the option contract. For unique identifier values for which a computed annualized return meets or exceeds a defined threshold, which may be user-configurable via the configuration package, a display driver module may generate a covered call opportunity marker within one or more of the concentrically-aligned annular regions of a dynamic wheel-type digital interface. A covered call opportunity marker may refer to a graphical element placed within a concentrically-aligned annular regions of an interface to indicate to a user that a potentially attractive covered call opportunity may exist for a corresponding tradeable asset, enabling a user to evaluate and act on an opportunity directly from an interface without navigating to a separate screen.

While the covered call analysis described above is presented in the context of financial tradeable assets, the same analytical framework may be applied to other domains. For example, in a content licensing context, one or more unique identifier values may represent digital content items, and a system may compute potential licensing returns based on current content valuations, licensing premiums, and term durations, generating opportunity markers within concentrically-aligned annular regions of the interface for content items whose projected licensing returns meet a defined threshold. In a sports analytics context, unique identifier values may represent athletes or teams, and a system may compute projected performance returns based, at least in part, on current market valuations and historical performance data, generating corresponding markers in an interface. In a real estate context, unique identifier values may represent properties or real estate investment trusts, and a system may compute projected rental yield or capitalization rate metrics, generating markers for assets meeting a defined performance threshold.

The interface 500 and associated visual arrangement are provided as one example of a graphical representation for presenting relationships among selected items and corresponding data, and are not limited to financial assets or ticker symbols. In other configurations, the interface 500 can be adapted to display items from other domains, such as teams, players, or events in a sports metrics implementation, devices or signals in a monitoring system, media items in a content platform, and/or other domain-specific entities, etc. A radial layout, annular regions, and relative positioning can be defined based at least in part on domain-relevant attributes, such as performance metrics, activity levels, rankings, or other quantitative or categorical measures, while maintaining a centralized visualization structure.

Similarly, the use of lines, markers, and annular regions to convey multiple dimensions of information is not limited to dividend indicators, trading events, or financial metrics. In other implementations, graphical elements can be configured to represent domain-specific attributes, such as player performance trends, injury status, upcoming games, and/or statistical thresholds in a sports context, or alerts, usage patterns, and/or anomaly indicators in other data environments, etc. Variable aspects of such graphical elements, including length, color, shape, and/or placement, can be defined based at least in part on underlying data values and user-defined criteria to provide layered information within a unified interface.

Further, the inclusion of specialized regions, such as those corresponding to lunar phase performance, natural ratios, short selling activity, or options data, is illustrative and can be adapted or replaced in other domains with regions corresponding to alternative analytical constructs. For example, regions can be designated for predictive indicators, historical trends, comparative benchmarks, and/or risk assessments, etc., depending on the application context. Accordingly, the number, type, and function of annular regions and associated indicators can vary based at least in part on a dataset and analytical objectives, while preserving the ability to present multiple categories of information concurrently within a single interface.

### Artificial Intelligence

In the above-described embodiments for tradeable assets, artificial intelligence (AI) may be employed to manage a user's investments based performance. An AI may suggest trading recommendations based on, for example, a user's trading tendencies. For example, an AI may provide buy or sell recommendations for a user's tradeable assets based, at least in part, on the user's historical actions for candlestick events, insider trading events, upcoming dividends (or no dividends), at the money, and/or natural ratio occurrence. An AI may provide buy or sell recommendations for a user's tradeable assets based, at least in part, on the user's historical actions with a same asset or similar assets. Additionally, an AI may ask a user questions about a portfolio to optimize holdings. For example, an AI may learn that a user has a preference for assets within a certain class or sector (e.g., energy, finance, healthcare, telecommunications, etc.) and may provide recommendations for assets within that class or sector. Further, an AI may learn that a user has a preference for characteristics (e.g., pays dividends, short selling, etc.) of these assets and provide recommendations for assets within that class or sector that match the user's preferred characteristics.

According to some embodiments, a recommendation for tradeable assets can be to purchase a quantity of a tradeable asset, to sell a quantity of the tradeable asset, or to hold the tradeable asset. A recommendation symbol such as a unique typeface for the ticker symbols 504, or other distinguishing feature or icon for the ticker symbols 504 to graphically convey the recommendation to a user. By way of example, a display driver module may recommend selling the tradeable asset IMPUY by formatting the ticker symbol 504 bold, with strikethrough. As another example, a recommendation determined by a display deriver module may be to hold a tradeable asset with ticker symbol PLTR, as indicated by the italicized, underlined text. Remaining tradeable assets have received “buy” recommendations, as indicated by standard block lettering. A “buy” recommendation may inform a user that conditions specified in a configuration package have been satisfied, justifying purchase of quantities of a corresponding tradeable asset. However, any other distinguishing feature such as color, letter case, stylized font, any other symbol, etc. can be used to convey graphically a recommendation to a user. The interface 500 may further be configured to incorporate alerts and/or sounds to notify a user of a trade recommendation. A user may receive a blinking or static red indication to sell a tradeable asset. A user may receive a blinking green indication to buy a tradeable asset. A user may receive a blinking or static red indication to sell a tradeable asset. A user may receive a blinking or static yellow indication to hold a tradeable asset. Color and presentation (e.g., blinking) may vary. Additionally, a user may receive notifications (e.g., email, mobile application, text messaging) concerning trade recommendations.

The use of artificial intelligence to generate recommendations for tradeable assets is provided as one example of how learned user behavior and data patterns can be utilized to guide decision-making, and is not limited to financial portfolios or trading activities. In other configurations, AI can be applied to analyze user interactions and historical data in domains such as sports analytics, health monitoring, media consumption, and/or other data-driven environments, etc. For example, in a sports-related implementation, the AI can recommend players to monitor, games to analyze, or strategies to consider based at least in part on prior user selections, observed performance trends, and/or user-defined preferences. Accordingly, the AI can adapt recommendations based at least in part on similarities across items, user tendencies, and contextual data, while optionally prompting the user for additional input to refine outcomes.

Similarly, a graphical representation of recommendations within an interface is not limited to buy, sell, or hold indicators for financial assets. In other implementations, visual cues such as font variations, color schemes, icons, alerts, and/or notifications can be configured to convey domain-specific recommendations or statuses, such as highlighting high-performing players, flagging anomalies in monitored systems, or identifying preferred content, etc. The form and presentation of such indicators, including visual emphasis, animations, and/or communication channels, can be defined based at least in part on user preferences and application context, while maintaining the ability to communicate actionable insights through an interface.

### Socialization

The interface 500 may further be configured for socialization among users such as to present shared top performing portfolios of other traders and/or the portfolio of traders a user is following. In at least one embodiment of socialization, the interface 500 may be configured to display a common holdings of every portfolio a user is following. A common holding may be any predetermined number (e.g., 1 or more) set by a user. For example, by setting a common holding threshold at 2, the interface 500 may present every tradeable asset that at least two other traders are currently holding. An advantage of this type of socialization presentation is that a user is able to determine common assets that are held by other traders and assess the assets on a single screen, thereby increasing the efficiency of the decision-making process. For example, users following the top performers can view their shared portfolios and related metrics, including a number of stocks in a portfolio, an average return for the portfolio, and total portfolio value.

Additionally, with such socialization a user may have access to shared portfolios of other users, observing details such as which assets they are buying, selling, and/or holding, and the volumes. The interface 500 may further be configured to enable a user to select an adjustment feature to mimic a top performing portfolio. For example, if a user selects an adjustment feature, the user may trade into the same positions as another portfolio, based, at least in part, on (for example) proportionality of available assets.

In addition to enabling individual users to follow and optionally mimic positions of other users'shared portfolio displays, a computing system may further aggregate asset holdings across two or more shared portfolio displays into a consolidated view. A computing system may incorporate asset holdings from one or more shared portfolio displays into a common holdings display region of a dynamic wheel-type digital interface. A common holdings display region may refer to a portion of a graphical user interface that aggregates asset holdings across two or more shared portfolio displays and presents a consolidated view of assets commonly held across those displays. A common holdings display region may update incrementally in response to detected changes in any of the aggregated portfolio displays. For example, if a user is following three other users'shared portfolio displays, a common holdings display region may identify unique identifier values, such as ticker symbols, held across two or more of those shared portfolio displays, presenting a consolidated view of commonly-held assets and their associated graphical elements within the dynamic wheel-type digital interface. As an underlying portfolio displays change in response to incoming data streams, a common holdings display region may be incrementally updated to reflect additions, removals, or changes in aggregated asset holdings, without performing a full re-render of the dynamic wheel-type digital interface, enabling a following user to monitor commonly-held assets across multiple shared portfolios in real time from a single consolidated view.

While the sharing, communication, and common holdings display features described above are presented in the context of financial portfolio displays, the same framework may be applied to other content domains. For example, users may share and collaboratively discuss sports analytics dashboards, real estate portfolio displays, content performance metrics displays, cryptocurrency holdings displays, or any other dynamic wheel-type digital interface as disclosed herein. The sharing configuration, communication session establishment, and common holdings aggregation mechanisms may operate across all supported content categories.

The socialization features described for interface 500 are provided as one example of enabling interaction and information sharing among users and are not limited to financial portfolios or trading activities. In other configurations, similar functionality can be applied to domains such as sports analytics, health tracking, media platforms, and/or other collaborative data environments, etc. For example, in a sports-related implementation, the interface 500 can present commonly selected players, teams, or strategies across multiple users, based at least in part on a user-defined threshold, allowing identification of shared interests or trends. Such shared views can include aggregated metrics, rankings, or performance indicators associated with commonly selected items, enabling users to evaluate patterns within a unified display.

Similarly, the ability to access and replicate selections of other users is not limited to mimicking financial portfolios. In other implementations, users can view selections, configurations, or preferences of other users and apply corresponding adjustments within their own interface, such as adopting similar player lineups, monitoring configurations, or content preferences, etc. An adjustment feature can be configured to apply changes based at least in part on proportionality, weighting, or other criteria, enabling alignment with another user's configuration while accommodating user-specific constraints.

### Example Process for Generating a Real-Time Interface

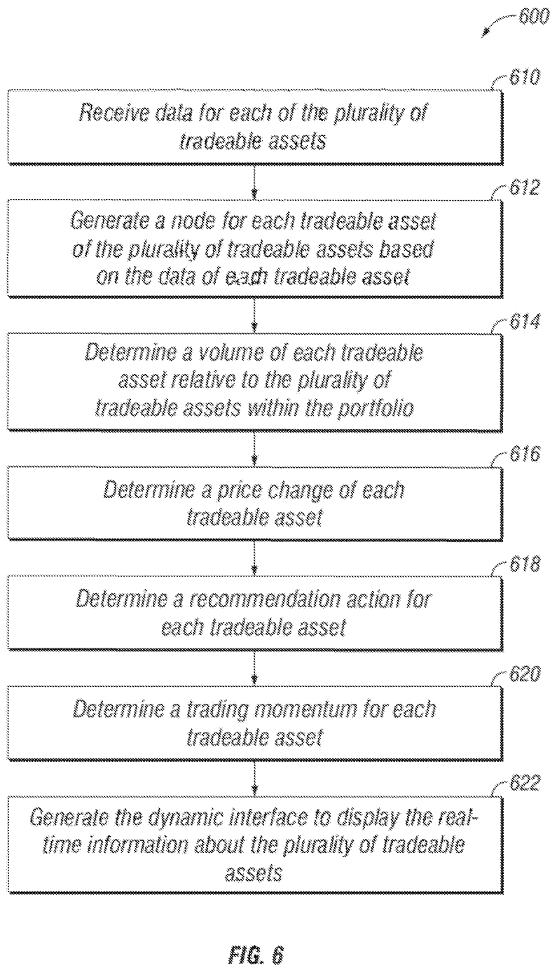

With reference to FIG. 6, a flow diagram of a process 600 for generating a dynamic interface with a computing system to display real-time information about a plurality of tradeable assets within a portfolio is illustrated. The process 600 may include receiving 610 data for a plurality of tradeable assets. Data may be received from multiple databases and aggregated. A node may be generated 612 for one or more tradeable asset based, at least in part, on data. A determination 614, 616, 618, 620 of a volume, price change, recommendation action, and trading momentum may be made for tradeable assets. A dynamic interface may be generated 622 to display real-time information about a plurality of tradeable assets.

The process 600 is provided as one example of generating a dynamic interface based, at least in part, on data associated with a plurality of items and is not limited to tradeable assets or financial portfolios. In other configurations, the process 600 can be adapted for use with data from other domains, such as sports metrics, system monitoring, media analytics, and/or other data-driven environments, etc. For example, the received data can correspond to performance statistics, usage data, engagement metrics, and/or other domain-specific information, and nodes can be generated to represent corresponding entities such as players, devices, or content items. Determinations relating to volume, price change, recommendation action, and trading momentum can be replaced or supplemented with domain-relevant attributes, such as activity levels, performance trends, predicted outcomes, and/or other analytical measures, etc. Accordingly, a dynamic interface can be generated based at least in part on an underlying dataset and selected attributes to present real-time or near real-time information in a structured visual format.

### Example Dynamic Interfaces

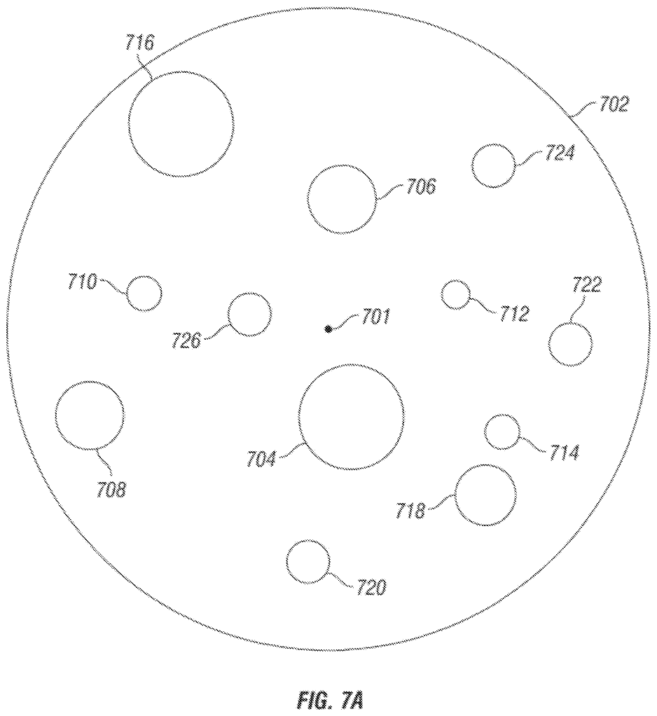

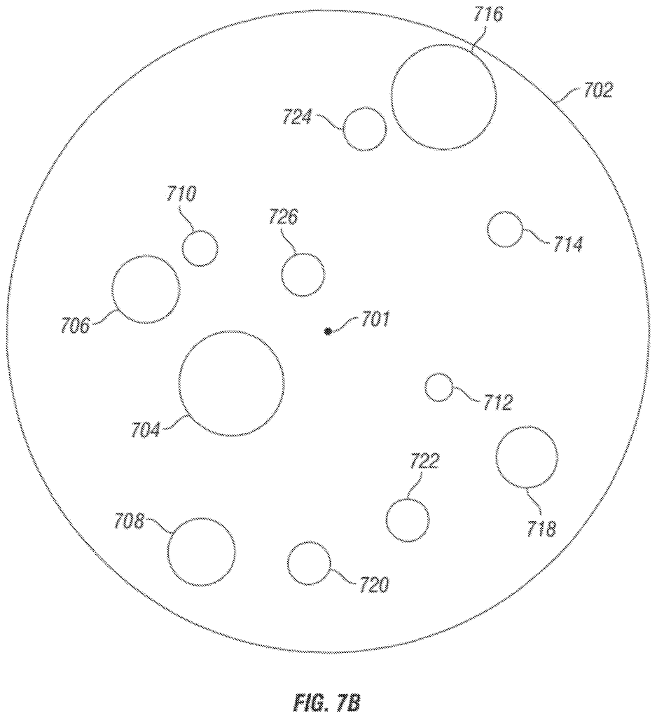

Referring to FIG. 7A and FIG. 7B, dynamic interfaces of a plurality of nodes representing tradeable assets are illustrated at two different time periods. A dynamic interface may include a circular common area 702 where a plurality of nodes may be positioned. As described herein, a plurality of nodes may include characteristics based, at least in part, on data related to tradeable assets.

### Example Characteristics

A first characteristic may be indicative of a volume owned by a user relative to a plurality of tradeable assets within a portfolio. Tradeable assets may be positioned between a center 701 of a circular common area and an outer edge of the circular common area, with a position based, at least in part, on a first characteristic. In one embodiment, tradeable assets having a larger volume may be positioned towards the center 701 and tradeable assets having a smaller volume may be positioned towards an outer edge. Additionally, the circular common area 702 may be segmented into bands corresponding to various ranges of volume. For example, node 704 may have a larger volume relative to a portfolio because it is positioned towards the center 701. In contrast, node 722 may have a smaller volume relative to a portfolio because it is positioned towards an outer edge of a circular common area. In another embodiment, tradeable assets having a larger volume may be positioned towards an outer edge and tradeable assets having a smaller volume may be positioned towards center 701 of a circular common area. For example, node 716 may have a larger volume relative to a portfolio because it is positioned towards an outer edge. In contrast, node 722 may have a smaller volume relative to a portfolio because it is positioned towards the center 701 of a circular common area.

A second characteristic may be indicative of a trading momentum of a tradeable asset. Nodes of a tradeable asset may have an angular movement based, at least in part, within a circular common area, with the direction indicating how the asset is trading (e.g., asset is increasing or decreasing in value). Tradeable assets having a positive trading momentum may have a clockwise angular movement, with the speed of the angular movement increasing with a larger positive trading momentum value. Tradeable assets having a negative trading momentum may have a counterclockwise angular movement, with the speed of the angular movement increasing with a larger negative trading momentum value. The speed of trading momentum can be based, at least in part, on a specific time period, such as, for example, a 10-day trend. The 10-day trend may be defined as the change (if any) between a previous closing session price and a closing price 10 days prior. Alternatively, a trend may be based, at least in part, on a different number of days. The speed of trading momentum can be segmented into groups (e.g., quartiles) corresponding to a degree of change in a trend. For example, a trading momentum in a first quartile may correspond to a change between (±) 0%-2% and may correlates to a node having a first rotation speed (e.g., very slow rotation). A trading momentum in the second quartile may correspond to a change between (±) 3%-6% and may correlate to a node having a second rotation speed (e.g., slow rotation). A trading momentum in a third quartile may correspond to a change between (±) 7%-10% and may correlate to a node having a third rotation speed (e.g., medium rotation). A trading momentum in a fourth quartile may correspond to a change between (±) 10% and may correlate to a node having a fourth rotation speed (e.g., fast rotation).

For example, nodes 704, 710, 712, 716, 726, and 722 may have a positive trading momentum with a clockwise angular movement, indicating that a value of a corresponding asset is increasing. Further, node 722 may have a large positive trading momentum because its position has drastically changed during a time period, indicating that a value of a corresponding asset may be rapidly increasing. In contrast, node 710 may have a small positive trading momentum because its position has minimally changed during a time period, indicating that a value of a corresponding asset may be slowly increasing. Trading momentum may be based, at least in part, on percentage of new buyers/sellers of a tradeable assets and/or the volume of the tradeable asset that is being purchased or sold. Trading momentum may additionally or alternatively be based, at least in part, on a rate of change in a market price of a tradeable asset.

Nodes 706, 708, 714, 718, and 724 may have a negative trading momentum with a counterclockwise angular movement, indicating that a value of a corresponding asset is decreasing. Node 714 may have large negative trading momentum because its position has drastically changed during a time period, indicating that a value of a corresponding asset may be rapidly decreasing. In contrast, node 718 may have a small negative trading momentum because its position has minimally changed during a time period, indicating that a value of a corresponding asset may be slowly decreasing. Node 720 may not have a trading momentum because it is in a same position, indicating that a value of a corresponding asset has not changed. It is advantageous to provide a user with the above information in this manner because the user can assess their entire portfolio in a single window. For example, a user can assess whether a heavily held asset is rapidly losing value that they should decrease their position. Alternatively, a user can assess whether a nominally held asset is rapidly gaining value that they should increase their position.

With continued reference to FIGS. 7A and 7B, a third characteristic that may be indicative of a price change is a size of a node, with increasing size correlated to increasing value and decreasing size correlated to decreasing value. A third characteristic may be based, at least in part, on a market open price of a tradeable asset. For example, node 716 may have a large node size, indicating that a value of a corresponding asset may have significantly increased since a market open price of the asset. In contrast, node 714 may have a small node size, indicating a value of a corresponding asset may have marginally decreased since a market open price of the asset. Further, the size of nodes may be segmented into a plurality of sizes. For example, nodes may be segmented into a small size correlating to a change between a change between (±) 0%-0.5%, a medium size correlating to a change between a change between (±) 0.5%-1%, a large size correlating to a change between a change between (±) 1%-4%, and an extra-large size correlating to a change between a change between (±) 4%.

Additionally, tradeable assets may have a fourth characteristic indicative of a recommended trading action. Similar to the recommendation described in FIG. 5, a recommended trading action may correlate to a buy recommendation, a sell recommendation, or a hold recommendation. For example, an asset corresponding to node 722 may have a buy recommendation because of a large positive trading momentum and large volume. Additionally, an asset corresponding to node 714 may have a sell recommendation because a corresponding asset may be rapidly losing value and may have a large volume. Additionally, an asset corresponding to node 718 may have a hold recommendation because a corresponding asset may not be rapidly losing value. In some examples, a buy recommendation may be a green node, a sell recommendation may be a red node, and a hold recommendation may be a yellow node.

A fifth characteristic may also be indicative of a daily price change of a tradeable asset, with nodes exhibiting a visual indicator. For example, a visual indicator of nodes may be a color, with yellow correlating to a ±0.5% change, green correlating to a change above 0.5%, and red correlating to a change below −0.5%. Further, an intensity (or darkness) of a node may indicate a greater percentage change. For example, a dark green node may correlate to a change significantly greater than 0.5%, and a light (or faint) red node may correlate to a change at (or slightly above) −0.5%.

A sixth characteristic may also be indicative of a daily price change of a tradeable asset, with nodes exhibiting an audio indicator. For example, an audio indicator of nodes may be a sound, with a bird (or chirping) sound correlating to a positive change, a beeping sound correlating to a negative change, and no sound correlating to no (or an insignificant) change. Further, an intensity of sound may indicate a greater percentage change. For example, a rapidly chirping sound may correlate to significant positive change (e.g., greater than 5%), and a slow (or intermittent) beeping sound may correlate to a slight negative change (e.g., less than 0.5%).

A seventh characteristic may be indicative of one or more performance indicators of a tradeable asset. While tradeable assets are generally presented as nodes, tradeable assets may be presented in other shapes corresponding to a performance indicator. Additionally, shapes of performance indicators may also include visual indicators, as described above. Performance indicators may include a Bollinger Band, V-Weighted Average Price (VWAP), Relative Strength Index (RSI), and Intraday Momentum Index (IMI). In one embodiment, a Bollinger Band indicator may be represented by a triangle shape, a VWAP may be represented by a square shape, an RSI may be represented by a hexagonal shape, and an IMI may be represented by a diamond shape. For example, when an upper and lower Bollinger Bands are close together (e.g., bandwidth), the visual indicator of the triangle may appear green, indicating low volatility. On the other hand, when an upper and lower Bollinger Bands are far apart (e.g., bandwidth), the visual indicator of the triangle may appear red, indicating high volatility. When a VWAP is above a current trading price of a tradeable asset (i.e., undervalued), a visual indicator of a square may appear green. Alternatively, when a VWAP is above a current trading price of a tradeable asset (i.e., overvalued), a visual indicator of a square may appear red. When an RSI of a tradeable is below a first threshold value (e.g., 30), a visual indicator of a hexagon may appear green. Alternatively, when an RSI of a tradeable is above a second threshold value (e.g., 70), a visual indicator of a hexagon may appear red. Similarly, when an IMI of a tradeable is below a first threshold value (e.g., 30), a visual indicator of a hexagon may appear green. Alternatively, when an IMI of a tradeable is above a second threshold value (e.g., 70), a visual indicator of a hexagon may appear red. It is understood that a user may be able to set threshold values for performance indicators. In another embodiment, a visual indicator may be a star-shape when multiple performance indicators are triggered.

The dynamic interfaces illustrated in FIGS. 7A and 7B and the associated node-based representations are provided as one example of visualizing multiple characteristics of a plurality of items over time and are not limited to tradeable assets or financial data. In other configurations, nodes can represent entities from different domains, such as players, teams, devices, or content items, etc., with positioning within a common area based at least in part on domain-relevant attributes such as usage levels, rankings, or other quantitative measures. Similarly, movement of nodes within an interface can represent changes in performance, activity, or other trends, with direction and speed corresponding to increases, decreases, or rates of change in the underlying data.

Further, the use of node size, color, motion, and other visual or audio indicators to represent multiple characteristics is not limited to price change, trading momentum, or recommendation actions. In other implementations, such characteristics can correspond to domain-specific metrics, such as performance improvements, engagement levels, system status, or predictive outcomes, etc., and can be conveyed through configurable visual and/or auditory cues. Additionally, the use of shapes and indicators corresponding to analytical models or performance measures can be adapted to represent alternative metrics, thresholds, or composite indicators, with user-defined parameters controlling how such indicators are triggered and displayed. Accordingly, the number, type, and mapping of characteristics to visual elements can vary based at least in part on the dataset and application context while maintaining a dynamic, multi-dimensional interface.

### Artificial Intelligence

In the above-described characteristics for a tradeable assets/nodes, artificial intelligence (AI) may be employed to manage a user's investments based performance. An AI may suggest trading recommendations based, at least in part, on, for example, a user's trading tendencies. For example, an AI may provide buy or sell recommendations for a user's tradeable assets based, at least in part, on a user's historical threshold values of performance indicators. Additionally, an AI may provide buy or sell recommendations for a user's tradeable assets based, at least in part, on the user's historical actions with a same asset or similar assets. For example, an AI may understand when a user prefers to buy or sell at certain trading momentum speed, momentum direction, percent change in price, etc.

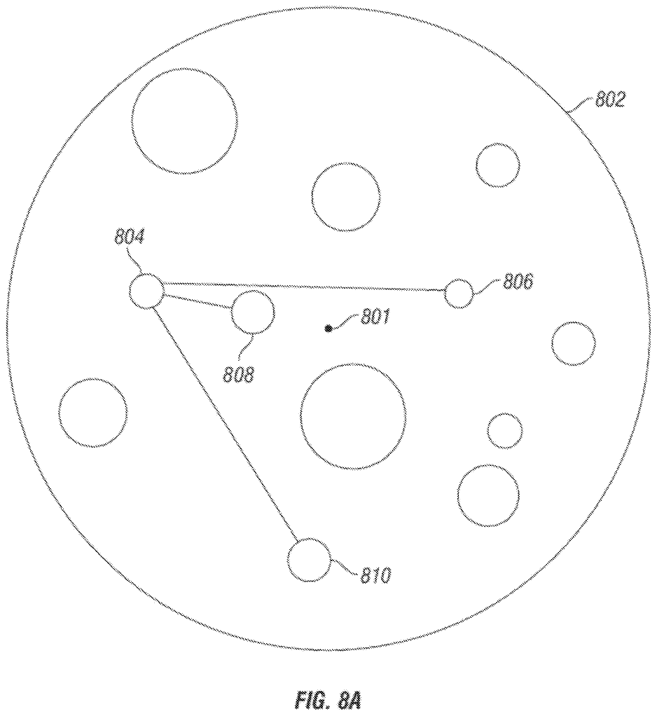

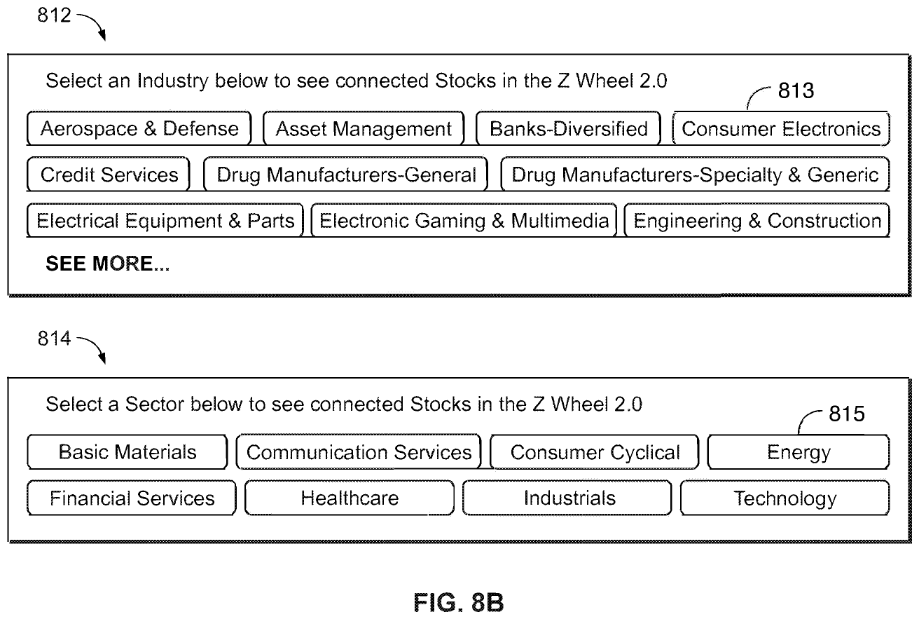

Referring to FIG. 8A and FIG. 8B, illustrations of a connection indicator between tradeable assets corresponding to industries and sectors are illustrated. A user may select a node within the circular common area 802 to identify assets that are part of the same industry 812 and/or sector 814. For example, if a user selects node 804 and the drug manufacturing industry 813 or technology sector 815, a dynamic interface may display a connection indicator between node 804 and nodes 806, 808, and 810. A connection indicator may provide a user with a quick assessment of which of their assets are in their portfolio, how those assets are trading, and the size of their position in an industry or sector relative to a portfolio. An industry may be, for example, aerospace, asset management, banking, consumer electronics, credit services, drug manufacturing, electrical equipment, multimedia, engineering, and construction. A sector may be, for example, basic materials, communication services, consumer cyclical, energy, financial services, healthcare, industrials, and technology.

AI-based recommendation functionality is provided as one example of using learned behavior and historical data to generate suggestions within an interface and is not limited to tradeable assets or financial decision-making. In other configurations, similar AI techniques can be applied to domains such as sports analytics, health monitoring, media recommendation systems, and/or other data-driven environments, etc. For example, in a sports-related implementation, an AI can generate recommendations based at least in part on historical user interactions with players, teams, or performance thresholds, including tendencies to select or prioritize certain performance ranges, outcomes, or statistical patterns. Accordingly, AI-driven recommendations can be adapted to identify preferred behaviors, refine suggested actions, and/or adjust outputs based, at least in part, on observed user patterns across a selected dataset.

Similarly, the use of connection indicators to relate selected items to industries, sectors, or other groupings is not limited to financial classifications. In other implementations, connection indicators can represent relationships such as team affiliations, positional groupings, content categories, or system-level classifications, etc., depending on the application context. Selection of a node can trigger display of related entities based at least in part on shared attributes, enabling identification of clusters, group memberships, or thematic relationships within the dataset. Accordingly, industry and sector mappings can be replaced or supplemented with domain-specific organizational structures while maintaining the ability to visually represent relationships among selected items.

### Example Interface With Tradeable Asset Classes

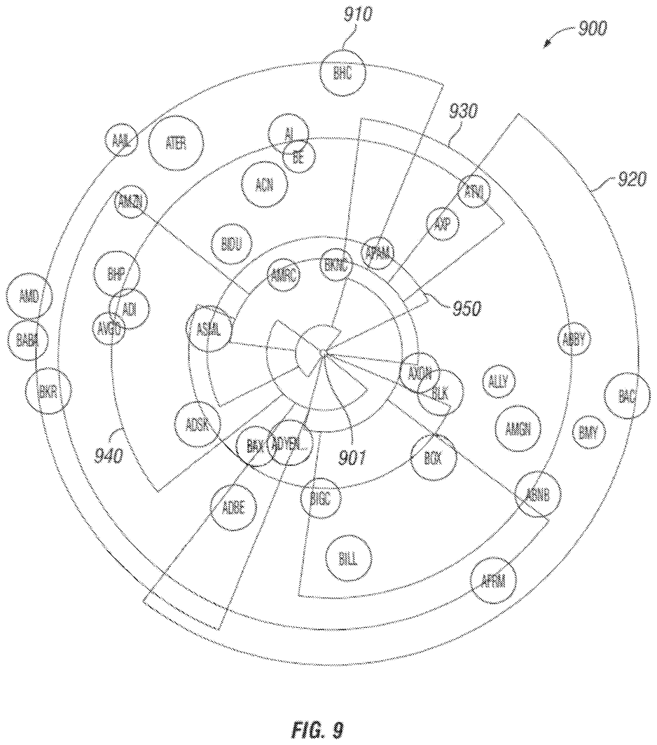

FIG. 9 is an illustration of a dynamic interface 900 of a plurality of wedges representing tradeable asset classes. The dynamic interface 900 may comprise a plurality of nodes 910 disposed within a common area. The dynamic interface 900 may further comprise a plurality of wedges 920, 930, 940, and 950 arranged within a common area. The plurality of wedges 920, 930, 940, and 950 may correspond to various asset classes. The plurality of wedges 920, 930, 940, and 950 may revolve around a center point 901 of a common area. The plurality of wedges 920, 930, 940, and 950 may comprise characteristics based, at least in part, on data of an asset classes. A first characteristic may be indicative of a volume of tradeable assets within an asset class relative to a portfolio is the size of a wedge. Wedges with larger sizes may correspond to a user holding a large amount of tradeable assets within a class relative to a portfolio. In contrast, wedges with smaller sizes may correspond to a user holding a small amount of tradeable assets within a class relative to a portfolio. For example, wedge 920 is larger than wedge 950, which may indicate that a user holds significantly more assets corresponding to a class in wedge 920 than those in wedge 950.

A second characteristic may be indicative of a trading momentum of an asset class. Similar to nodes described in FIGS. 7A and 7B, wedges of an asset class may have an angular movement based, at least in part, within a common area, with the direction indicating how the class is trading (e.g., asset class is increasing or decreasing in value). Asset classes having a positive trading momentum may have a clockwise angular movement, with the speed of the angular movement increasing with a larger positive trading momentum value. Asset classes having a negative trading momentum may have a counterclockwise angular movement, with the speed of the angular movement increasing with a larger negative trading momentum value.

A third characteristic may be indicative of a recommended trading action. Similar to the recommendation described in FIGS. 7A and 7B, a recommended trading action may correlate to a buy recommendation, a sell recommendation, or a hold recommendation. In this example, a buy recommendation for a particular asset class may correspond to recommending that a user increase their position in assets already in their portfolio. Alternatively, a buy recommendation for a particular asset class may correspond to recommending that a user purchase additional assets within a class that are not already held in their portfolio. Similarly, a sell recommendation for a particular asset class may correspond to recommending that a user decrease their position in assets already in their portfolio. In some examples, a buy recommendation may be a green wedge, a sell recommendation may be a red wedge, and a hold recommendation may be a yellow wedge. An asset class may be, for example, pharmaceutical, social media, electric vehicles, and energy.

In another embodiment, the dynamic interface 900 may further be configured to present additional information of a tradeable asset and/or tradeable asset class. For example, by hovering over a node or wedge in the dynamic interface 900, a user may be able to view detailed information about an asset, which is advantageous because a user can further investigate an asset after identifying on the dynamic interface 900 because of its characteristics. Detailed information may include Bollinger Band values, VWAP, RSI, IMI, share price, share price change, and percent change in share price.

### Socialization

The dynamic interface 900 may further be configured for socialization such as to present shared top performing portfolios of other traders and/or the shared portfolio of traders the user is following. Such sharing of portfolios with other users provides socialization that enables traders to view the shared or presented portfolios of others. Such socialization of portfolios may permit a user to follow other users to improve their own portfolio performance. A user may be able to share their portfolio with other users via email. In at least one embodiment of such socialization, the dynamic interface 900 may be configured to display a common holdings of every shared portfolio or portfolio a user is following. A common holding may be any predetermined number (e.g., 1 or more) set by a user. For example, by setting a common holding threshold at 2, the dynamic interface 900 may present every tradeable asset that at least two other traders are currently holding. An advantage of this presentation is that a user may be able to determine common assets that are held by other traders and assess the assets on a single screen, thereby increasing the efficiency of the decision-making process.

### Artificial Intelligence

In the above-described characteristics for tradeable assets/wedges, artificial intelligence (AI) may be employed to manage a user's investments based, at least in part, on performance. An AI may suggest trading recommendations based, at least in part, on, for example, a user's trading tendencies. For example, an AI may provide buy or sell recommendations for a user's tradeable assets based, at least in part, on the user's historical threshold values of performance indicators. Additionally, an AI may provide buy or sell recommendations for a user's tradeable assets based, at least in part, on the user's historical actions with a same asset or similar assets. For example, an AI may understand when a user prefers to buy or sell at certain trading momentum speed, momentum direction, percent change in price, etc.

The dynamic interface 900 and wedge-based representation of asset classes are provided as one example of organizing and displaying grouped data within a common visualization and are not limited to financial asset classes or portfolio analysis. In other configurations, the wedges 920, 930, 940, and 950 can represent groupings in domains such as sports categories, media genres, product classifications, or system-level clusters, etc., with wedge size corresponding to a quantity or aggregate measure associated with a group. The rotational movement and angular behavior of wedges can similarly represent changes in performance, activity, or other time-varying metrics associated with the corresponding groupings, with direction and speed reflecting increases or decreases in the underlying values.

Similarly, the use of visual indicators for recommended actions, such as color-coded or otherwise distinguishable wedges, is not limited to buy, sell, or hold recommendations for financial assets. In other implementations, such indicators can represent suggested actions, status conditions, or prioritization signals in other domains, such as highlighting trending categories, recommending content shifts, or indicating resource allocation adjustments, etc. The optional display of detailed information on interaction, such as hovering over a node or wedge, can likewise be adapted to present domain-specific attributes, enabling contextual access to underlying data associated with a selected element.

AI-based analysis and recommendation functionality associated with wedges is also not limited to managing financial investments. In other configurations, AI can analyze user behavior and historical interaction patterns across domains such as sports analytics, content recommendation systems, and operational monitoring, etc., to generate personalized suggestions or predictive outputs. Recommendations can be based at least in part on observed thresholds, interaction tendencies, or similarities among selected items, enabling adaptive guidance tailored to user-specific behavior across different datasets and application contexts.

### Gamification

The embodiments of the above-described interface 500 and dynamic interface 900 may be combined with “gamification” features. Any of a variety of ways to “gamify” these embodiments can be used, for example, to encourage feedback, to reward users for attaining a status level (e.g., labeled as a top or successful trader), competition among users, to simply encourage more use of the platform or service in general, to encourage collaboration between users, and/or enable users to monetize their trading skills. In some embodiments, a leaderboard can be generated that identifies some top performing portfolios and related metrics and which is displayed to users.

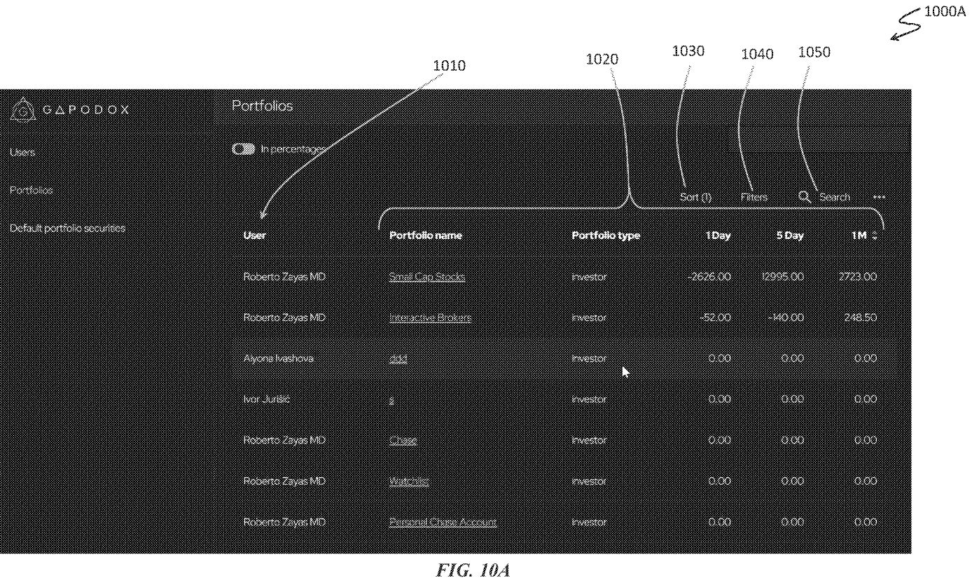

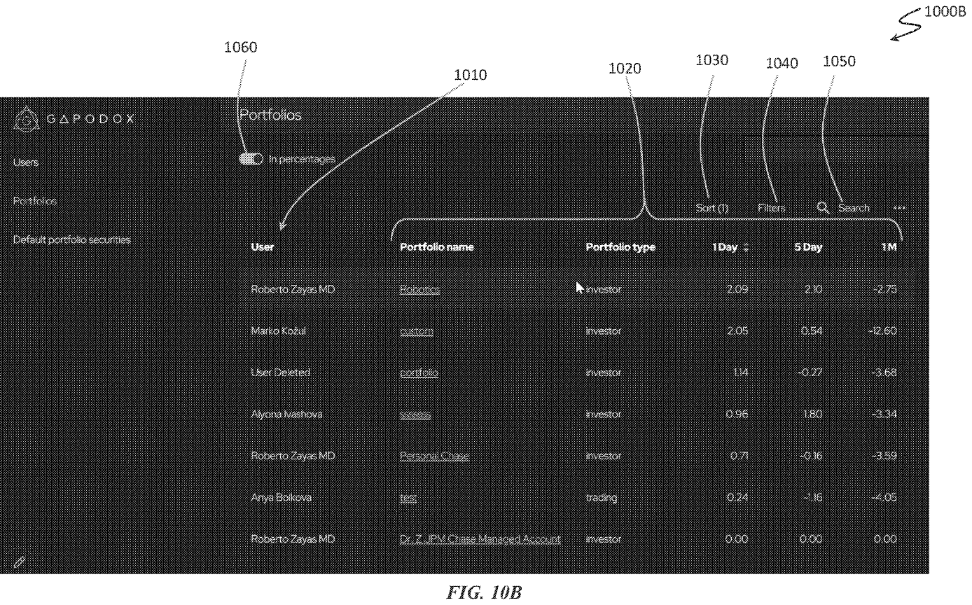

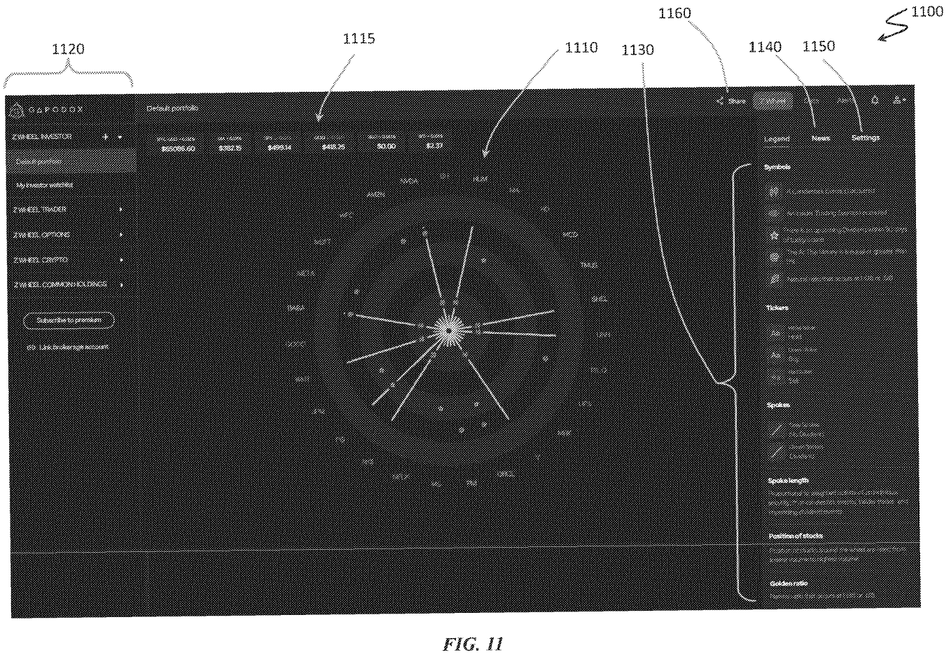

Looking at FIGS. 10A-10B, illustrated are screenshots setting forth example leaderboards of ranked users/traders. FIG. 10A illustrates a screenshot 1000A of a leaderboard of users/traders 1010 where a ranking on a leaderboard is done based, at least in part, on increases or decreases in dollar values of portfolios being ranked. A list of users/traders on a leader board may be provided under a “User” column 1010. Data 1020 for a ranked portfolio may be provided in associated columns corresponding to a row of a user/trader. Example metrics for ranking users/traders on a leaderboard may include the number of stocks in the portfolio, the average return for the portfolio, and total portfolio value, and thus the position or ranking of one or more user's portfolio among these shared portfolios.

To compute such in a consistent and verifiable manner, a computing system may employ a structured performance score computation process in which metrics used to generate rankings may be derived from electronic activity records associated with user accounts during a defined period of time. A performance score may refer to a numerical value computed from one or more quantitative metrics associated with a user account's electronic activity records, representing the relative performance of that user account within a defined population of user accounts. One or more quantitative metrics may be calculated from electronic activity records occurring on or after a performance baseline date. A performance baseline date may refer to a reference date used to define the period of activity considered in computing a performance score, and may correspond to the earlier of an account creation date or a portfolio import date, such that performance scores may reflect only activity of a user account on a platform and may not be affected by historical activity predating the user's participation in the platform. An account creation date may refer to a date on which a user account was first created on a platform. A portfolio import date may refer to a date on which a user account imported a pre-existing portfolio into a platform. Quantitative metrics used to compute a performance score may comprise one or more of: realized return, unrealized return, risk-adjusted return, portfolio diversification across asset categories, consistency of returns over a defined evaluation period, and/or the like. A computing system may rank a plurality of user accounts according to their respective computed performance scores within one or more trader categories, such as equity investor, active trader, options trader, cryptocurrency trader, Forex trader, and/or the like. A computing system may generate a leaderboard data structure associating ranked user accounts with their respective computed performance scores and trader category rankings. A leaderboard data structure may refer to a data structure that associates ranked user accounts with their respective performance scores and category rankings, and that may be rendered within a graphical user interface, for example as illustrated in FIGS. 10A and 10B.

While performance score computation and leaderboard features described above are presented in the context of financial trading activity, the same framework may be applied to other content domains. For example, in a sports analytics context, performance scores may be computed for user accounts based, at least in part, on electronic activity records related to sports prediction, fantasy sports performance, or athletic performance metrics. In a content creation context, performance scores may be computed based, at least in part, on engagement metrics, content reach, or monetization activity. Trader categories may be replaced with any relevant participant categories appropriate to the content domain, and a leaderboard data structure may rank participants within those categories accordingly.

In the illustrated screen 1000A of FIG. 10A, the displayed data 1020 may include the portfolio name, which may be provided by users, and a portfolio type. Additionally, a dollar value gained or lost for one or more portfolios held by one or more ranked users may be provided for a plurality of timeframes. In this illustrated embodiment, a dollar value gains or losses may be provided for 1 Day, 5 Day, and 1 Month time periods. In similar embodiments, additional columns for any other periods of time may also be provided, such as 3 Months, 6 Months, and 1 Year intervals. A leaderboard of dollar values may be sorted by any one of these time periods, which in turn re-ranks users along a leaderboard. As such, one leaderboard for the most gained in 1 Day can be created, while a different leaderboard for the most gained in 1 Month can then be created. Also, rankings may be sorted greatest to least or vice versa by clicking the appropriate icon at the top of a column. In other embodiments, instead of gains/losses over certain periods of time, an overall value of a portfolio for a predetermined or selected period of time may be used to rank a leaderboard of users. Additionally, a column giving a viewing user an option to “follow” or “unfollow” ranked portfolios may also be provided. Additionally, an icon or hyperlink may be associated and displayed with ranked portfolios, and selecting (e.g., clicking or hovering over it with a cursor) may cause display, to a user or perhaps just a user “following” a ranked portfolio, of one or more tradeable assets within an associated portfolio, and/or display of details regarding buying, selling, and/or holding activities of one or more tradeable assets within the associated portfolio.

Ranked users or portfolios may be altered by using a “Sort” button 1030, where various additional metrics can be used to sort users or portfolios. Information and portfolios may also be filtered by a viewing user using a “Filters” button 1040. Not only may ranked results be viewed, but also metrics and measures by which a leaderboard of users or portfolios are ranked may be altered as well. Such filters may be used to change ranking columns being displayed and employed to generate a leaderboard. Leaderboards such as the one illustrated in FIG. 10A may be created by a platform or users. For example, a platform may provide default dynamic leaderboards for any of a number of categories, such as overall portfolio value or performance of all users of a platform over example periods discussed above, and which may be measured by any of a number of time frames or even simply on the current day a leaderboard is viewed by a user. Leaderboards may also be provided based, at least in part, on just users “followed” by a viewing user. Default leaderboard ranking may be set by a platform, such as portfolio value or gain across a certain period of time, and then adjustable by a user as desired.

FIG. 10B illustrates a screenshot 1000B of a leaderboard of users/traders 1010 where a ranking on a leaderboard may be done based, at least in part, on increases or decreases in percentage increases or decreases of portfolios being ranked. To create such leaderboards, a user can turn on an “In percentages” button 1060 that ranks users or portfolios in percentage increase or loss in value over one or more of the plurality time periods discussed above. A list of the users/traders on such leaderboards may again be provided under a “User” column 1010, while the data 1020 identified above for ranked portfolios may be provided in associated columns corresponding to rows of users/traders. The Sort 1030, Filters 1040, and Search 1050 may again also be available to a viewing user to manipulate displayed information in the screen 1000B.

Beyond the illustrated embodiments in FIGS. 10A and 10B, a ranking of performance of traders/users can be based, at least in part, on any of a number of such metrics or other classes, categories, groupings, etc. For example, a leaderboard could be of top traders based, at least in part, on overall portfolio value or overall return-on-investment (ROI), top traders (in volume or gain) for any user-selected period of time, top traders among a certain profession or group of users, such as notable stockbrokers, celebrities, certain demographic(s) (e.g., top traders under-25 or top female traders), top traders within a certain class of investment (e.g., technology stocks versus energy stocks versus commodities versus cryptocurrencies), and/or any other measure of status possible. Any of these or other possible measures of portfolio performance may also provide a reward of some type of those users/traders on a particular leaderboard. Such reward system may be simply monetary awards paid to certain leaderboard portfolios, or may be based, at least in part, on a reward system unique to the platform. Such reward system may include awarding and accumulating “points” or other measure of value unique to a platform, where certain numbers of points can be redeemed with the platform for something in return, such as free or reduced-cost access to certain paid features of the platform. In still other embodiments, mere “bragging rights” may be a reward for moving up ranks of a particular leaderboard, especially leaderboards formed of followed users or a group of users who are otherwise friends and are engaged in friendly competition on a platform.

Gamification features associated with interface 500 and dynamic interface 900 are provided as one example of enhancing user engagement and interaction with the displayed data and are not limited to financial trading or portfolio management contexts. In other configurations, similar gamification mechanisms can be applied to domains such as sports analytics platforms, fitness tracking systems, educational tools, media engagement applications, and/or other interactive data environments, etc. For example, leaderboards can be generated based at least in part on user performance metrics, participation levels, or achievement criteria associated with domain-specific activities, enabling comparative ranking and competitive interaction among users.

Similarly, leaderboard generation, sorting, and filtering functionality is not limited to portfolio value or investment returns. In other implementations, ranked lists can be constructed based, at least in part, on alternative metrics such as player performance statistics, content engagement scores, activity completion rates, or system usage measures, etc. Users can adjust ranking criteria, time windows, and grouping parameters to dynamically generate customized leaderboards reflecting selected dimensions of performance. Additionally, reward mechanisms such as points, status levels, or access-based incentives can be adapted to non-financial systems to encourage participation, collaboration, or sustained engagement within the platform.

### Monetization

In one embodiment, users can charge others to access their portfolio (e.g., view their interface 500 and/or dynamic interface 900, or any interface and related portfolio as disclosed herein). This monetization aspect may be advantageous when a user has developed a reputation as a successful trader and gained attention (or followers), thereby increasing the amount of money or other reward a user can make for allowing access to their portfolio. In some embodiments, a user can charge a fee for another user requesting access to follow a portfolio. In example embodiments, a fee charged by a user to share their portfolio or interface with a paying user can be predetermined based, at least in part, on a leaderboard ranking of a user among multiple shared portfolios visible to a user. In some embodiments, fees charged by users may increase as their portfolio rises up a leaderboard. Additionally, in some embodiments, users may be encouraged/rewarded for posting/sharing their portfolios, for example, to see if other users are interested in their investments. Still further, rewards for sharing a portfolio may be paid by a platform, with or without rewards being paid by following users.

To facilitate portfolio access arrangements in a structured and programmatically enforceable manner, a computing system may support a monetization configuration mechanism through which terms of portfolio access may be specified, authorized, and enforced between user accounts. A monetization configuration may refer to a set of parameters submitted by a first user account that specifies a content access type, an access price, and an access duration. A content access type may refer to a category of information that a first user account is making available to other users, and may comprise at least one of a point-in-time portfolio snapshot, a portfolio activity feed, or a trading history record. A point-in-time portfolio snapshot may refer to a static representation of a first user account's portfolio holdings at a specific moment in time. A portfolio activity feed may refer to a continually or periodically updated stream of portfolio activity records associated with a first user account. A trading history record may refer to a historical record of transactions executed by a first user account over a defined period of time. An access price may refer to a monetary amount specified by a first user account as the cost for a second user account to access a content access type. An access duration may refer to a defined period of time during which a second user account may access a content access type upon authorization. A second user account may submit a payment authorization for an access price specified in the monetization configuration. A payment authorization may refer to an authorization submitted by the second user account approving payment of the access price, which may be processed via a payment processing service integrated with a platform.

Upon confirmation of the payment authorization, a computing system may generate a time-bounded access token associated with a second user account and a content access type of a first user account. A time-bounded access token may refer to a digital credential that defines the scope of a second user account's access rights and the duration for which those rights remain active. A computing system may then transmit, via a network interface, a data representation of a content access type of a first user account to a computing device associated with a second user account for an access duration specified in a monetization configuration. Upon expiration of an access duration, a time-bounded access token may be automatically revoked, terminating a second user account's access to a first user account's content. An access price may be determined by a first user account, or may be set or recommended by a platform based, at least in part, on the first user account's ranking on one or more leaderboards, portfolio performance metrics, or other measures of user performance.

While the monetization framework described above is presented in the context of financial portfolio information, the same framework may be applied to other content domains. For example, a first user may monetize access to a sports analytics dashboard, a real estate portfolio display, a content creator's engagement metrics display, a cryptocurrency holdings display, or any other dynamic wheel-type digital interface as disclosed herein. A content access type, access price, and access duration may be configured by a first user account regardless of the content domain, and the time-bounded access token mechanism may operate across all supported content categories.

In some embodiments, displaying a leaderboard of organized portfolios and users associated therewith may include displaying organized portfolios having a collectable value of tradeable assets substantially similar as collectable values of tradeable assets of other users to whom the leaderboard is displayed. In such embodiments, a leaderboard may be limited to displaying such substantially similar portfolios. Such limitation may be advantageous to users “following” shared portfolios of substantially similar collective value because it permits the following user to more closely related their portfolio to the followed portfolio, and thus any copying of the followed, shared portfolio is more closely related to buying, selling, and/or holding activities that may be implemented in their own portfolio. For example, while following a shared multi-billion dollar portfolio may be entertaining to a following user, activities taken with assets in that shared portfolio may not translate into similar activities the following user could take with assets in their own portfolio. Similarly, following a large value portfolio that experiences substantially large changes in monetary value or percentages of values may again not translate into actions a following user could take with the assets in their own portfolio. In such cases, large changes in monetary or percentage of value may be indicative of a high level of risk or risk tolerance by the owner of that high-changing portfolio. As such, a following user may not have a same risk tolerance as that owner sharing their portfolio, and thus the risky actions taken with assets in that portfolio would again not likely be an acceptable level of risk to a following portfolio owner.

Moreover, as with all portfolios associated with a platform hosting an interface as disclosed herein, owners may choose to share their portfolios with one or more other users for free or for payment of a fee or other reward. For example, an owner may choose to share their portfolio and details associated therewith with friends and family for free or a smaller fee/reward, than a fee or reward to be paid by other users of a platform. Also, any sharing of portfolios may be only for a predetermined amount of time, which may or may not be in proportion to the amount of a fee or reward paid to an owner by a platform and/or other users. In some embodiments, such a reward may be associated with publication of information, e.g., on a platform, regarding trading of tradeable assets within a shared portfolio by an owner/rewarded user. Such shared information or details may comprise sharing buying, selling and/or holding activity of tradeable assets in a shared portfolio by the owner or an owner's representative. An amount of reward paid to a sharing owner may be in proportion to an amount of details/information being publicly shared by a sharing owner.

Monetization of portfolio access is provided as one example of enabling user-to-user exchange of access rights within a data-driven interface and is not limited to financial trading systems or portfolio visualization. In other configurations, similar access-based monetization can be applied to domains such as sports analytics, fitness coaching platforms, content subscription systems, educational performance dashboards, and/or other collaborative data environments, etc. For example, users may charge or be rewarded for providing access to their curated datasets, analytical configurations, or performance profiles, with pricing or access levels determined based at least in part on reputation, ranking, or engagement metrics within a platform.

Similarly, restrictions or grouping of shared leaderboards based on similarity of aggregate characteristics is not limited to portfolio value or investment risk profiles. In other implementations, grouping criteria can be based, at least in part, on comparable performance levels, engagement profiles, skill ratings, or activity distributions in other domains, such as sports performance tiers, gaming skill brackets, or learning progression levels, etc. Limiting shared comparisons to users with similar aggregate characteristics can improve relevance of comparisons across datasets where absolute values differ significantly while preserving meaningful relative evaluation.

Additionally, user-controlled sharing of data, including time-limited access and differentiated sharing conditions, can be applied outside financial contexts to other systems involving user-generated or user-curated content. In such implementations, access permissions, duration, and compensation structures can vary based at least in part on the type and granularity of shared information, such as detailed analytics, behavioral logs, or curated recommendations. Reward structures can be configured by a platform or distributed among users to incentivize contribution, sharing, or publication of higher-resolution or higher-frequency data within the system.

### Additional Example “Wheel” Interfaces

FIG. 11 illustrates a screenshot 1100 of an example “wheel” interface 1110 that concurrently displays graphical representations of numeric data and transaction data relating to a portfolio of tradeable assets. In this example, tradeable assets may be publicly traded companies, such as Amazon (AMZN) and Nvidia (NVDA). As such, this wheel interface 1110 may be a display for an “investor”, as denoted in the selectable menu 1120 on a left side of the display screen 1100. While the illustrated interface 1110 is a “default portfolio” of tradeable assets, which may be selected by an administrator of interface platform/site (e.g., GAPODOX, in this embodiment), such an investor may select a specific tradeable assets they prefer to see simultaneously displayed on the interface 1110. This option may be selected using the “My investor watchlist” button in the menu 1120.

Additionally, an example screen may also display one or more selected tradeable assets 1115 along a top of a screen, for easy reference to a user. Specifics assets being displayed may be selectable by a user, or may be chosen by an administrator. Information related to these assets displayed may also be selectable, where, in the illustrated embodiment a current value of one or more assets is displayed. In some embodiments, displayed assets may be based, at least in part, on a portfolio of a particular user, such as a best performers of the user's portfolio, or perhaps a most valuable. Moreover, the number of such assets may be selectable, or no assets displayed at all. Further, an assets display may be revised in real-time as a user hovers over a part of a wheel interface, or perhaps clicks on certain assets to view.

As with the interface embodiment shown in FIG. 5, for the interface 1100 in FIG. 11, a plurality of tradeable assets/companies (shown by their ticker symbol) in the displayed portfolio may be arranged about a periphery of a plurality of concentrically-aligned annular regions. Information pertaining to ticker symbols may be designated by placement of one or more graphical elements in annular regions, extending in a radial direction from an origin (i.e., at the center of a wheel interface) towards a respective ticker symbol. Placement of ticker symbols may be indicative of a volume of tradeable assets corresponding to the ticker symbols. In one embodiment, placement of ticker symbols may be indicative on increasing volume, with volume increasing in a clockwise direction. In another embodiment, placement of ticker symbols may be indicative on increasing volume, with volume increasing in a counterclockwise direction.

Also as before, the interface 1100 may further include lines extending from an origin toward ticker symbols. Lines can, for example, be dividend symbols that include at least: (i) a first variable aspect, and (ii) a second variable aspect. An example of a first variable aspect can be an appearance of a line (such a different colors) that graphically indicates whether or not a dividend is paid to holders of a tradeable asset. While in the interface of FIG. 5 solid versus broken lines, as well as light versus heavy line weights, provided such indications, in the interface 1100, line colors may be used to provide such information. A second variable aspect of lines can graphically indicate a relative quantity of events that occurred, or are scheduled to occur involving tradeable assets displayed on the interface 1110. For example, the longer a line, the greater a number of events that have occurred, or are scheduled to occur involving tradeable assets. However, other graphical aspects of a line such as a color code, a size, a shape, or any other graphical element can be utilized as a first variable aspect.

According to some embodiments, examples of events may include, but are not limited to: candlestick events, insider trades, impending dividend events, any other event, and any combination thereof. In this example screen 1100, a Legend 1130 is provided along one side of a display screen to explain to a user what certain symbols mean for a particular asset. Such symbols can be arranged within annular regions in a radial direction extending from an origin to a respective ticker symbol. For example, a marker, such as the “at” symbol (@), can be placed in an annular region, which can be designated for markers that identify tradeable assets for which an “at the money” percentage exceeds a percentage specified in a configuration package, which may be user-defined. An “at the money” percentage may be a percentage of outstanding options for a tradeable asset that, at a current market price, is within a defined tolerance of an option strike price. In the illustrative embodiment of FIG. 11, a defined tolerance was again specified as five (5%) in a configuration package. Similarly, another or a same annular region can be designated to display markers such as a star (★), which may be indicative of an upcoming dividend payment within a predefined period (perhaps by a user as well) from a date on which numeric and transaction data is received by an aggregation module 112. In the example of FIG. 11, stars (★) indicate that five tradeable assets have an upcoming dividend payment within the next thirty (30) days.

A display marker that is an eye may also be used in one or more annular regions to indicate that an insider trading event has occurred. As mentioned above, insider trades involve a transaction involving a respective tradeable asset by a party who has information that is not available to the general public. Whether an insider trading event has occurred may be determined by a display driver module based, at least in part, on transaction data received by an aggregation module. Also as before, a display marker that is a candlestick marker may also be displayed in an annular region to indicate a candlestick event has occurred, which are explained above. Any one or more of the visual indicators described above for other embodiments of a wheel interface in accordance with the disclosed principles may also be included on the wheel interface 1110 of FIG. 11. For example, a natural ratio marker (shown in the Legend 1130) may be displayed on the interface 1110 based, at least in part, on a correlation of trading movement of a tradeable asset and the Fibonacci sequence. As described in detail above, a natural ratio may be obtained by dividing successive pairs of Fibonacci numbers, yielding approximately 1.618 (or conversely 0.618). A natural region may utilize Fibonacci retracements, Fibonacci arcs, Fibonacci fans, Fibonacci zones, or any combination thereof to determine a natural ratio for a tradeable asset. A determination may also utilize other methods. For example, an annular region may be designated to display markers indicative of a strong or weak performance for a tradeable asset correlated to a natural ratio based, at least in part, on received data. If an asset is projected as performing better in the future, an indication may be presented notifying a user that the tradeable asset may be entering a historically better performing period. Alternatively, a different indication may be presented notifying a user that a tradeable asset may be entering a historically weaker performing period if projected to lose value.

Aside a clickable “Legend” button used to display the Legend 1130 are a “News” button 1140 and a “Settings” button 1150. Clicking the “News” button 1140 may replace the displayed Legend 1130 information with current or at least recent important news stories or blurbs regarding tradeable assets being displayed on the wheel interface 1110. In some embodiments, such news information may be provided as clickable links which when clicked accesses a source providing the news information. In other embodiments, selecting a news blurb may display a pop-up with a full news story or other information. Similarly, next to the News button 1140 may be a “Settings” button 1150. Clicking this button may then display a number of options for a user to select that affects the information displayed on the wheel interface 1110. For example, which tradeable assets being displayed may be altered by a user, as well as particular information being displayed about displayed tradeable assets. Other settings may include timeframes for displaying asset information on the interface 1110, as well as labels to add to and display on the interface 1110 such as price, volume, etc. There may also be provided an option to set a user's interface as “public” where sharing will all users of a platform is provided. Of course, other general settings may also be accessed by a user, such as altering screen colors, fonts, sizes, etc. used to present the wheel interface 1110.

As before, the wheel interface 1110 may further be configured for socialization by a user electing to share his interface/portfolio by selecting a “Share” button 1160. Electing to share his interface/portfolio may be made as an open request for any other user to accept (or ignore), or it may be done in response to specific requests by other users to view a user's interface/portfolio. For example, pressing the “Share” button 1160 may access a screen that displays any requests by other users for access to a user's interface/portfolio, and the user may then elect which request to acquiesce to, as desired. Such requests may be made through a platform, such as via messaging or chat, or may be in response to a received communication such as an email request. Such sharing in response to a request may be manifested as an acceptance by other users to “follow” a user's interface/portfolio as well. Such sharing of portfolios with other users may provide socialization that enables traders to view shared or presented portfolios of others, and which thereby may permit users to follow other users to improve their own portfolio performance. Socialization may also include any of the embodiments and features discussed herein. Socialization may further include facilitating communication between an owner of a shared/follower portfolio and a following user. Such communication may be via a chat or message feature provided by a platform. Moreover, AI may again be employed in this embodiment of the wheel interface 1110 in any of the manners and embodiments discussed above, including providing suggests to a user of what other users to follow based, at least in part, on any one or more characteristics determined by an AI as being beneficial for the user to follow.

To enable such socialization in a structured manner, a computing system may support a sharing configuration mechanism through which a user account may specify terms under which a portfolio display is shared with one or more other user accounts. A sharing configuration may refer to a set of parameters submitted by a user account that specifies which portfolio display is to be shared, which user accounts are designated as authorized recipients, and optionally a duration or scope of a sharing arrangement. Upon receiving and processing a sharing configuration, a computing system may transmit, via a network interface, a data representation of a shared portfolio display to computing devices associated with one or more designated recipient user accounts, enabling those users to view a shared portfolio display, including a dynamic wheel-type digital interface and its associated graphical elements, on their respective computing devices.

A computing system may further establish a communication session among a sharing user account and one or more designated recipient user accounts. A communication session may refer to an interactive channel established between two or more user accounts that enables real-time communication in association with a shared portfolio display. A communication session may comprise at least one of a text-based messaging channel and a video conferencing channel rendered in association with a shared portfolio display. A text-based messaging channel may refer to a messaging interface rendered as a panel adjacent to or overlaid on the dynamic wheel-type digital interface, enabling users to exchange text messages about a shared portfolio information in real time. A video conferencing channel may refer to a live video communication interface rendered in association with a shared portfolio display, enabling users to discuss the shared portfolio information via live video while simultaneously viewing a dynamic wheel-type digital interface. By enabling communication sessions to be established and rendered in association with the shared portfolio display, a platform may enable users to collaborate on portfolio analysis and trading decisions without navigating away from a dynamic wheel-type digital interface.

The wheel interface 1110 and associated display elements are provided as one example of a circular visualization for presenting multi-dimensional data associated with a plurality of items and are not limited to financial assets or portfolio analysis. In other configurations, the wheel interface 1110 can be adapted for domains such as sports analytics, content recommendation systems, system monitoring dashboards, and/or other structured data environments, etc. In such implementations, items displayed around the wheel can correspond to entities such as players, teams, content categories, or monitored resources, with radial placement and annular structuring based at least in part on domain-specific metrics such as activity levels, rankings, engagement, or performance indicators.

Similarly, a selectable menu, watchlist functionality, and dynamic asset selection features are not limited to investor portfolios. In other implementations, such controls can be used to configure sets of entities for monitoring or analysis in other domains, such as tracking selected athletes, media items, or system components, etc., with user-defined groupings determining what is displayed in the interface. The ability to adjust displayed items in real time based on interaction is likewise applicable across domains where dynamic filtering and contextual visualization of selected entities is useful.

Additionally, the legend, news integration, settings controls, and sharing functionality are not limited to financial information systems. In other configurations, these features can provide contextual explanations, external information feeds, customization options, and collaboration tools for other types of data-driven interfaces. For example, news elements can be replaced with domain-specific updates, and sharing mechanisms can support collaborative viewing or analysis of selected datasets among users. Socialization and AI-based recommendation features can similarly operate across non-financial domains by suggesting relevant entities, connections, or configurations based at least in part on user behavior and historical interaction patterns.

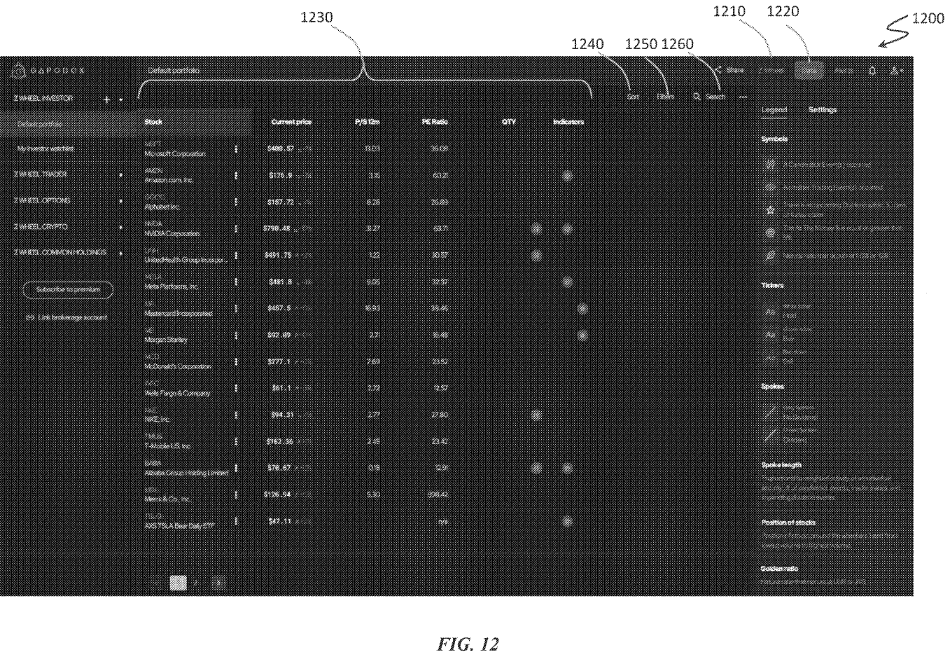

While presentation of the wheel interface 1110 is provided to a user when selecting the “Z Wheel” button 1210, adjacent to this button is a “Data” button 1220. FIG. 12 illustrates a screenshot 1200 displaying information to a user when the “Data” button 1220 is selected. For example, as illustrated the displayed data may be organized in rows, where one or more rows are dedicated to a particular tradeable asset, such as the stocks shown. Columns may then be provided for one or more rows to provide certain information, such as current price, quantity of assets owned by a user, visual indicators corresponding to those displayed on the wheel interface 1110, and any other information or data useful to users regarding the type of tradeable assets being presented. Presented data in columns may be sorted as desired with a “Sort” button 1240, as well as filtered by a “Filter” button 1250. Also, a user may search for a particular tradeable asset using a “Search” field 1260. While the same Legend 1130 may be provided along the side of the screen 1200, once again selecting the “Settings” button 1150 can access various items a user may select or change in order to alter the data being displayed in columns for one or more tradeable assets.

The “Data” view 1200 associated with the wheel interface 1110 is provided as one example of an alternative structured representation of the same underlying dataset and is not limited to financial tradeable assets or portfolio data. In other configurations, the tabular layout can be adapted to present domain-specific entities such as players, teams, content items, devices, or monitored system components, etc., with rows corresponding to individual entities and columns corresponding to associated attributes, metrics, or status indicators. The displayed attributes can vary based at least in part on the application context and may include performance measures, usage statistics, categorical labels, or other structured data elements relevant to the selected domain.

Similarly, sorting, filtering, and search functionality is not limited to tradeable asset selection or financial data analysis. In other implementations, such tools can be used to organize and query datasets in sports analytics platforms, content libraries, operational dashboards, and/or other data management systems, etc. User-configurable settings that control which fields are displayed and how information is organized can likewise be applied across different domains to support customized data views aligned with user preferences and analytical objectives.

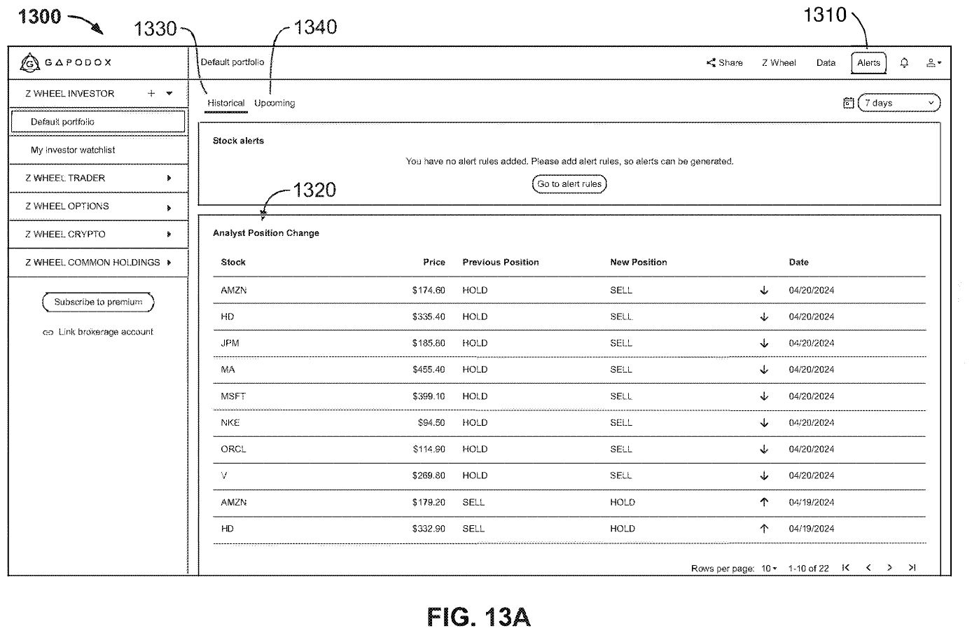

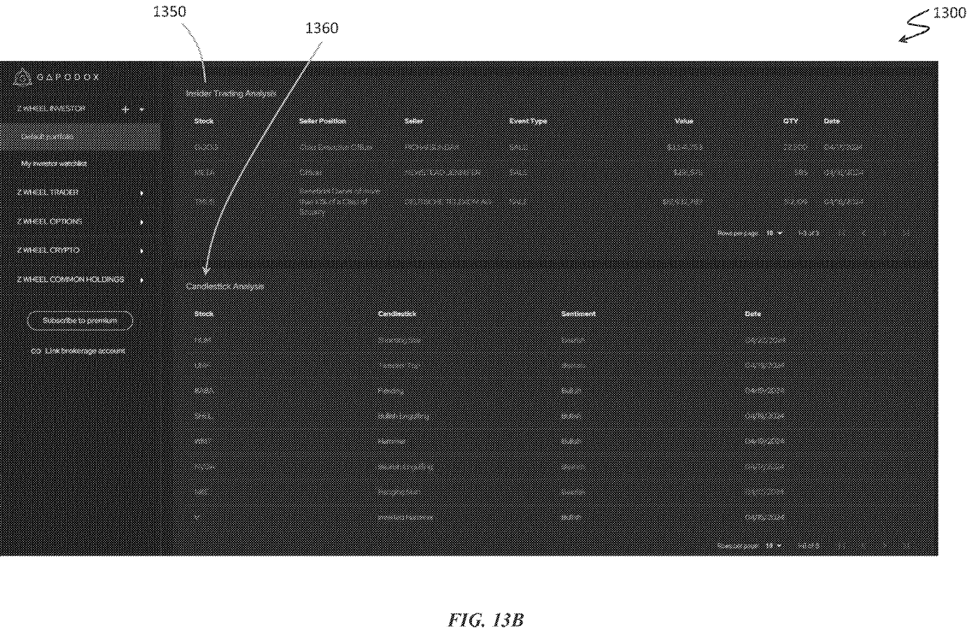

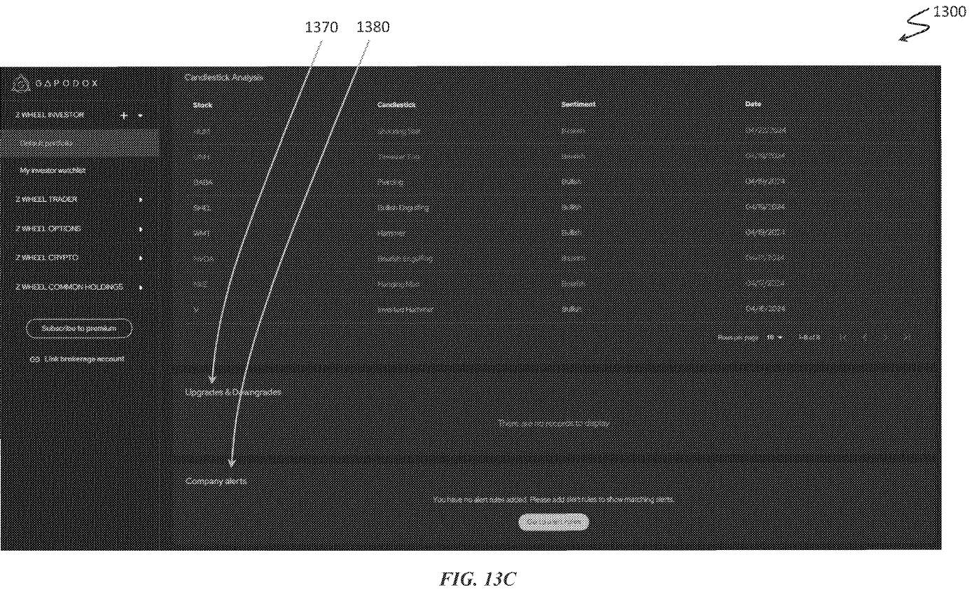

Looking now at FIG. 13A, illustrated is a screenshot 1300 displaying example alerts displayed to a user regarding tradeable assets in his portfolio, or perhaps tradeable assets a user simply elects to follow. This screen may be accessible by a user selecting an “Alerts” button 1310 located adjacent to the “Data” button discussed above. As illustrated, a first portion of the alerts screen 1300, entitled “Analyst Position Change” 1320, provides information regarding an increased or decreased value of one or more tradeable assets, or perhaps suggestions by a platform (either via AI or tracking of other users'actions regarding the same or similar tradeable assets) of what to do with a tradeable asset (e.g., sell, buy, or hold). Such alerts may be customizable by users using “Alert Rules” or other settings, or may be provided as default alert settings set by a platform or an AI engine affiliated with the platform. Both a “Historical” tab 1330 and an “Upcoming” tab 1340 may also be provided to permit a user to view prior alerts as well as upcoming alerts, respectively, selectable for specified periods of time.

FIG. 13B illustrates a lower portion of the “Alerts” screenshot 1300 introduced above. In this scrolled-down portion of the Alerts screen 1300, additional alerts are displayed to a user. In the illustrated embodiment, an “Insider Trading Analysis” section 1350 displays information to a user pertaining to known or perceived “insider trading” events regarding certain tradeable assets. Another section 1360 of the screen 1300 displays information to a user pertaining to “candlestick” events regarding certain tradeable assets. FIG. 13C illustrates a further lower portion of the screen 1300 of FIGS. 13A and 13B. This lowest area of the screen 1300 includes an “Upgrades & Downgrades” section 1370, as well as a “Company alerts” section 1380, where both sections can provide relevant alerts and accompanying information to the user.

The alerts interface 1300 and associated sections are provided as one example of a notification-based view of underlying data and are not limited to tradeable assets or financial portfolio monitoring. In other configurations, similar alert structures can be applied to domains such as sports analytics, system performance monitoring, content updates, and/or other event-driven data environments, etc. For example, alerts can be generated based at least in part on changes in player performance, team status updates, content availability changes, or system anomalies, with notifications organized according to category or event type.

Similarly, the “Analyst Position Change,” “Insider Trading Analysis,” “Candlestick Events,” “Upgrades & Downgrades,” and “Company Alerts” sections represent examples of categorized event streams that can be adapted to other domains. In alternative implementations, these sections can correspond to domain-specific events such as performance shifts, ranking changes, operational alerts, or recommendation updates, etc., depending on the application context. Historical and upcoming tabs, along with configurable alert rules, can likewise be used to manage past and predicted events across non-financial datasets, enabling users to customize which types of changes or conditions trigger notifications and how such information is presented.

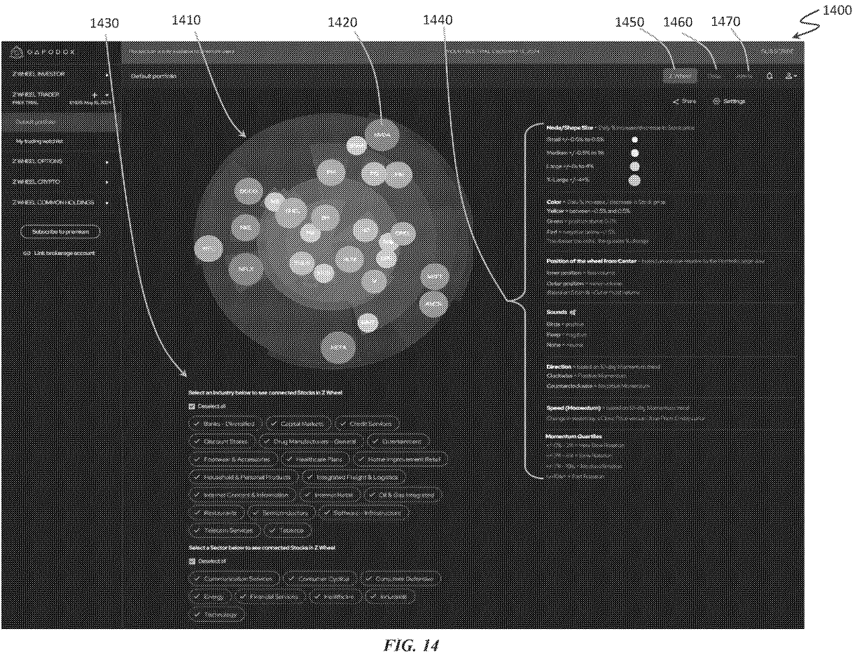

Turning now to FIG. 14, illustrated is a screenshot 1400 of another embodiment of a dynamic wheel interface 1410, where this wheel interface 1410 provides a dynamic visual representation tracking a plurality of tradeable assets. In this “Trader” wheel 1410, tradeable assets being tracked may or may not be tradeable assets held by a user viewing the interface 1410, but instead may be assets selected by a user to dynamically track. Similar to the interface 900 illustrated in FIG. 9, this interface 1410 displays a plurality of tradeable assets, in this case stocks again, illustrated on a plurality of wedges within the wheel interface 1410. One or more tradeable asset may be displayed as a node 1420 within a wedge and at a specific radial position on the wheel interface 1410. While a “default portfolio” is displayed via the interface 1410, a subscribing user may make his own selections for display on the interface 1410 by clicking the “My trading watchlist” option from a left-side menu.

The wheel interface 1410 also again may include a plurality of wedges arranged within and revolving dynamically around a center of a common area. Wedges may correspond to various asset classes, and the shape, size, and movement of the wedges may comprise characteristics based, at least in part, on data regarding asset classes. As before, the size of a wedge may correspond to a first characteristic indicative of a volume of a tradeable assets within an asset class. In this illustrated embodiment, wedge size may correspond to a user's holding of tradeable assets within a class for that wedge. In contrast, wedges with smaller sizes may correspond to a user holding a smaller amount of tradeable assets within a class relative to his portfolio. Accordingly, a wedge significantly larger than another illustrated wedge may indicates that a user holds significantly more assets corresponding to a class in a first wedge than those in a second, smaller wedge. Selectable asset classes may be provided in a clickable list 1430 underneath the displayed wheel interface 1410. From this list 1430, a user can select which class of assets to display on the wheel interface 1410, with such selection(s) being displayed in real-time on the interface 1410.

Another “Legend” 1440 may be displayed along a right-side of the interface 1410, and which explains meanings of various symbols, colors, movements/velocities, and sizes/shapes of items displayed on the interface 1410. Again, a Settings button may be provided where a user is permitted to adjust various settings affecting a display of the interface 1410 as well as other parts of the screen 1400. A Share button may also again be provided to permit a user to share his interface 1410 with other users, which can again be a general selection to make his interface 1410 publicly viewable or may be selected sharing with only certain other users. In either case, as described in detail above, a user may be rewarded for his sharing of his interface 1410, whether a reward is monetary or in the form of some other benefit provided to the user, such as reduced or waived subscriber fees to a platform. Where monetary payments are awarded to a user, such money may be paid to the user from a platform, from users wanting access to the user's interface 1410, or both. In some embodiments where payment is made from other uses to a sharing user, a platform may monetize such arrangements by receiving a portion of monies paid to the sharing user. Moreover, an amount of monies paid to a user for sharing or making their interface publicly available to other users may be based, at least in part, on the success of the sharing user and/or some other measure(s), such as a status of the sharing user, a portfolio value of the sharing user, financial success of the sharing user within a predefined time frame, or any other measure(s) against which the sharing user may be compared to other users of a platform. Such measure(s) may further affect a monetary reward paid to a sharing user, as well.

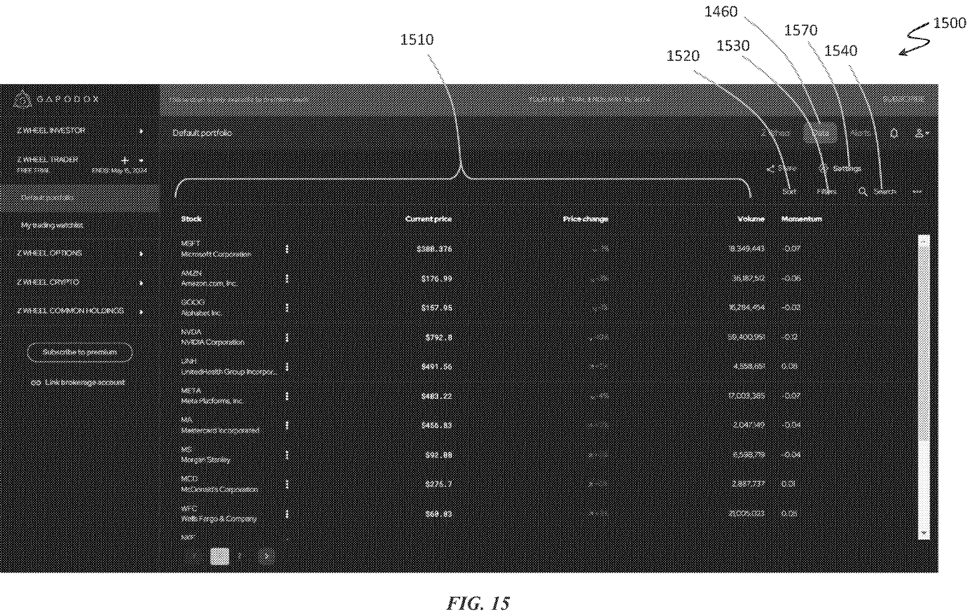

While the dynamic wheel interface 1410 is visually displayed on the screen 1400 when the “Z Wheel” button 1450 is selected, a viewing user may also temporarily navigate away from the displayed interface 1410 by selecting the “Data” button 1460 or the “Alerts” button 1470, with similar information being respectively provided in substantially the same manner as described above. For example, FIG. 15 illustrates a screenshot 1500 displaying information to a user when the “Data” button 1460 is selected. The displayed data 1510 may again be organized in rows, where one or more rows may be dedicated to a particular tradeable asset, such as stocks shown in the interface 1410. Columns may then be provided for one or more rows to provide certain information, such as current price, change in price, volume of assets owned by a user, and momentum of assets displayed on the wheel interface 1410, and any other information or data useful to users regarding the type of tradeable assets being presented. Data presented in the columns may again be sorted as desired with a “Sort” button 1520, as well as filtered by a “Filter” button 1530 as described above. Also, a user may search for a particular tradeable asset using a “Search” field 1540. Once again selecting the “Settings” button 1570 can access various items a user may select or change in order to alter data being displayed in columns for one or more tradeable assets.

The dynamic wheel interface 1410 is provided as one example of a circular, real-time visualization for tracking selected items and is not limited to tradeable assets or financial portfolio monitoring. In other configurations, an interface can be adapted to track entities such as sports teams, players, media content, system components, or other data objects, etc., with nodes and wedges representing domain-specific items and attributes. Selection via a watchlist or similar control can similarly define which entities are displayed, with updates rendered in real time or near real time based at least in part on changes in underlying data.

Likewise, asset class wedges, legends, settings controls, and sharing functionality are not limited to financial classification or trading systems. In other implementations, wedges can represent groupings such as sports categories, content genres, operational clusters, or performance segments, etc., with size, motion, and other visual properties reflecting relevant metrics in those domains. Legend and settings components can be used to explain and configure domain-specific indicators and visualization parameters, while sharing and monetization mechanisms can be applied to other user-generated analytical views or curated datasets, with rewards or access conditions determined based at least in part on user status, engagement, or platform-defined criteria.

Similarly, data and alerts views associated with an interface can be adapted to non-financial environments to present structured information and event-driven notifications for selected entities. In such implementations, rows and columns can correspond to domain-specific items and attributes, and alerts can be generated based, at least in part, on changes in performance, status, or other tracked metrics. Sorting, filtering, and search functionality can be applied across these datasets to support customized analysis and navigation without requiring modification of underlying system logic.

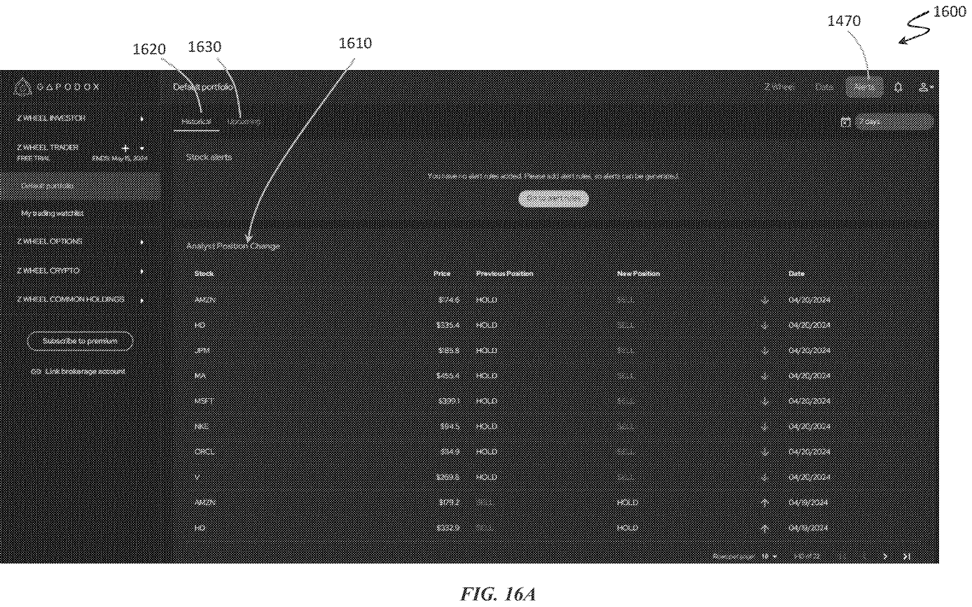

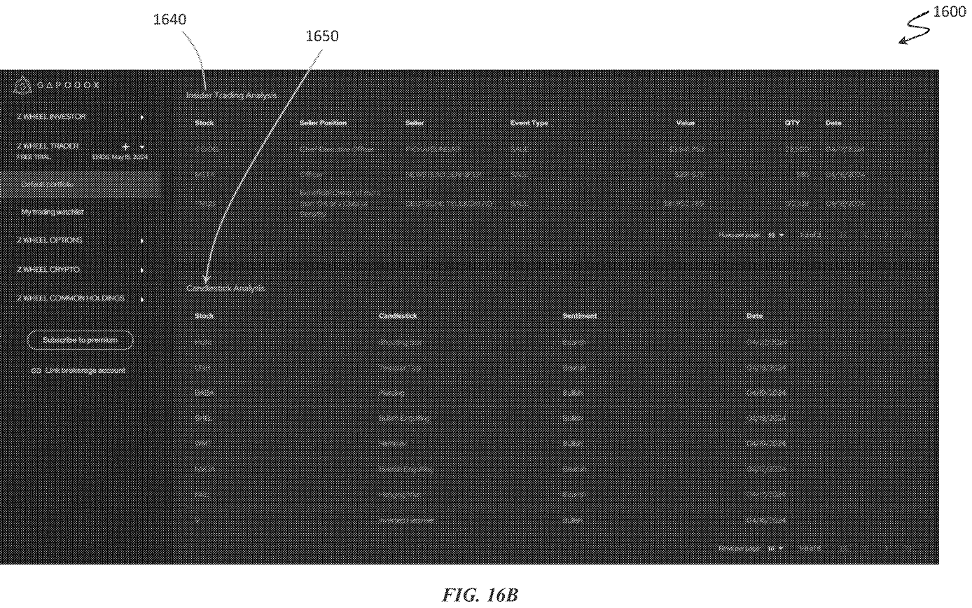

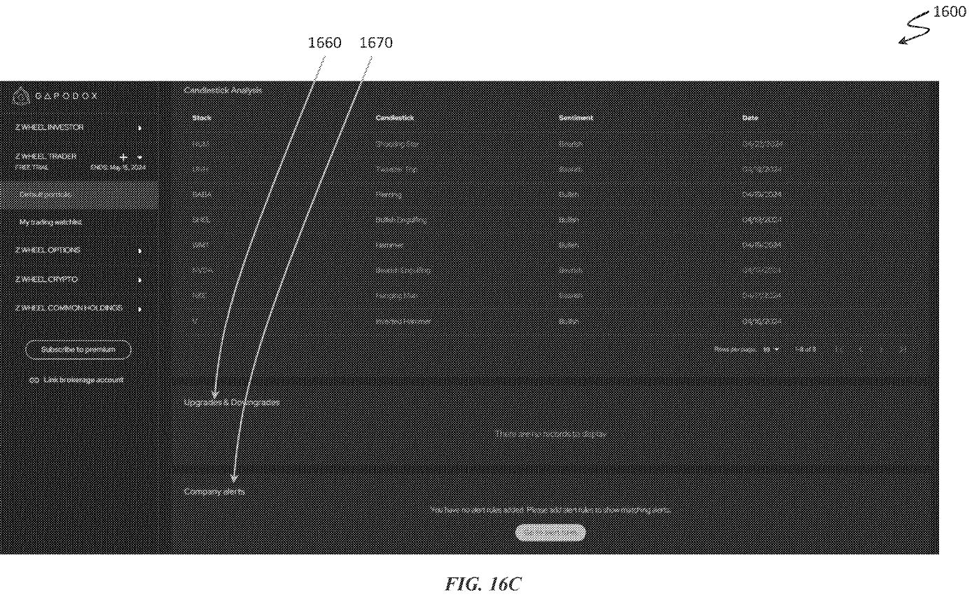

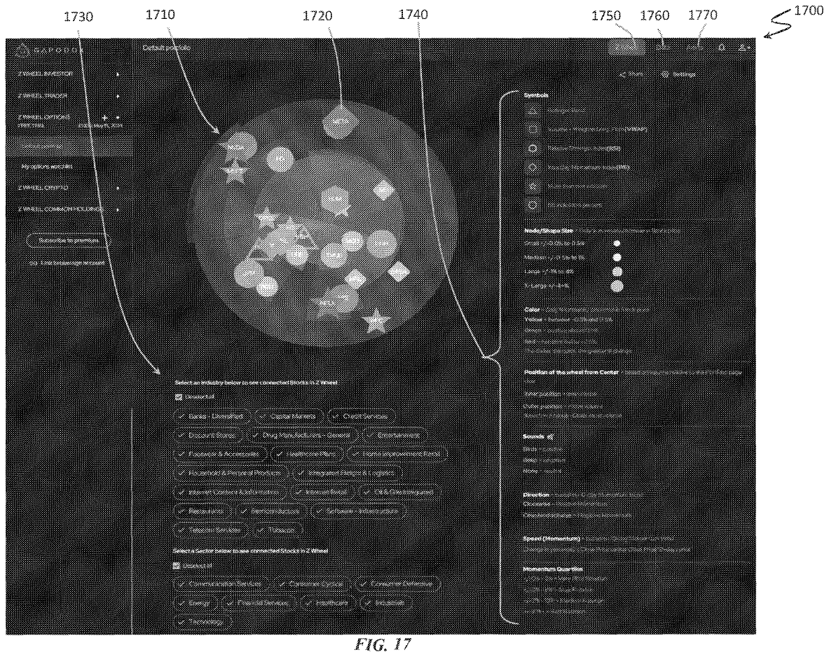

Looking now at FIG. 16A, illustrated is a screenshot 1600 displaying example alerts to a user regarding tradeable assets displayed in the interface 1410 when the “Alerts” button 1470 is selected. As with the example Alerts screen discussed above, a first portion of the alerts screen 1600, entitled “Analyst Position Change” 1610, may provide information regarding an increased or decreased value of one or more tradeable assets from the interface 1410, or perhaps suggestions by a platform (either via AI or tracking of other users'actions regarding a same or similar tradeable assets) of what to do with a tradeable asset (e.g., sell, buy, or hold). Such alerts may be customizable by users using “Alert Rules” or other settings, or may be provided as default alert settings set by a platform or an AI engine affiliated with the platform. Both a “Historical” tab 1620 and an “Upcoming” tab 1630 may also be provided to permit a user to view prior alerts as well as upcoming alerts, respectively, selectable for specified periods of time.

FIG. 16B illustrates a lower portion of the “Alerts” screens 1600 introduced above. In this scrolled-down portion of the Alerts screen 1600, additional alerts may be displayed to a user. In the illustrated embodiment, an “Insider Trading Analysis” section 1640 may display information to a user pertaining to known or perceived “insider trading” events regarding certain tradeable assets. Another section 1650 of the screen 1600 may display information to a user pertaining to “candlestick” events regarding certain tradeable assets. FIG. 16C illustrates a further lower portion of the screen 1600 of FIGS. 16A and 16B. This lowest area of the screen 1600 may include an “Upgrades & Downgrades” section 1660, as well as a “Company alerts” section 1670, where both sections can provide relevant alerts and accompanying information to a user.

The alerts interface 1600 is provided as one example of an event-driven notification view associated with the dynamic wheel interface 1410 and is not limited to tradeable assets or financial portfolio tracking. In other configurations, similar alert structures can be used to present notifications for domain-specific entities such as sports teams, players, content items, or monitored system components, etc. Alerts can be generated based at least in part on changes in performance, status updates, or other measurable events associated with the selected entities, and organized into categories corresponding to different event types.

Similarly, sections such as “Analyst Position Change,” “Insider Trading Analysis,” “Candlestick Events,” “Upgrades & Downgrades,” and “Company Alerts” represent examples of grouped event classifications that can be adapted to other domains. In alternative implementations, such sections can correspond to performance changes, anomaly detections, recommendation updates, or operational status alerts, etc., depending on the application context. Historical and upcoming tabs, along with customizable alert rules, can likewise be applied to non-financial datasets to enable user-defined filtering and temporal organization of event notifications.

Turning now to FIG. 17, illustrated is a screenshot 1700 of another embodiment of a dynamic wheel interface 1710, where this wheel interface 1710 provides a dynamic visual representation tracking a plurality of assets comprising stock options. In this “Options” wheel interface 1710, option assets being tracked may or may not be option assets held by a user viewing the interface 1710, but may instead be option assets selected by a user to dynamically track. Similar to the interfaces 900 and 1400 illustrated in FIGS. 9 and 14, respectively, this interface 1710 may display a plurality of option assets on a plurality of wedges within the wheel interface 1710. Option assets may displayed as a nodes 1720 within a wedge and at specific radial positions on the wheel interface 1710. While a “default portfolio” is again displayed via the interface 1710, a subscribing user may make his own selections for display on the interface 1710 by clicking the “My options watchlist” option from a left-side menu.

The wheel interface 1710 also again may include a plurality of wedges arranged within and revolving dynamically around a center of a common area. The wedges may correspond to various option asset classes, and the shape, size, and movement of wedges may comprise characteristics based, at least in part, on data regarding option asset classes. As before, the size of a wedge may correspond to a first characteristic indicative of a volume of option assets within an asset class. In this illustrated embodiment, wedge size may corresponds to a user's holding of an option assets within a class for a particular wedge. In contrast, wedges with smaller sizes may correspond to user holding a smaller amount of option assets within a class relative to his portfolio. Accordingly, a wedge significantly larger than another illustrated wedge may indicate that a user holds significantly more option assets corresponding to a class in a first wedge than those in a second, smaller wedge. Selectable asset classes may be provided in a clickable list 1730 underneath the displayed wheel interface 1710. From this list 1730, a user may be able to select which class of assets to display on the wheel interface 1710, with such selection(s) being displayed in real-time on the interface 1710.

Another “Legend” 1740 is displayed along the right-side of the interface 1710, and which may explain meanings of various symbols, colors, movements/velocities, and sizes/shapes of nodes displayed on the interface 1710. Again, a Settings button may be provided where a user may be permitted to adjust various settings affecting a display of the interface 1710 as well as other parts of the screen 1700. A Share button may also again be provided to permit a user to share his interface 1710 with other users, which can again be a general selection to make his interface 1710 publicly viewable or may be selected sharing with only certain other users. In either case, as described in detail above, a user may be rewarded for his sharing of his interface 1710, whether a reward is monetary or in the form of some other benefit provided to the user, such as reduced or waived subscriber fees to a platform. Monetization for the sharing of a user's interface 1710 may be in any one or more of the manners discussed above.

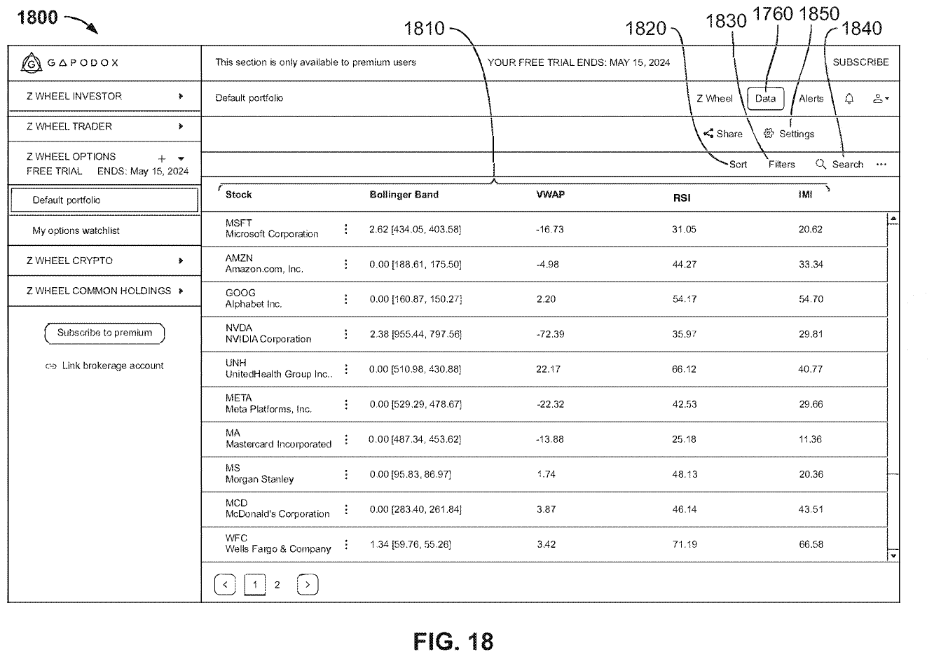

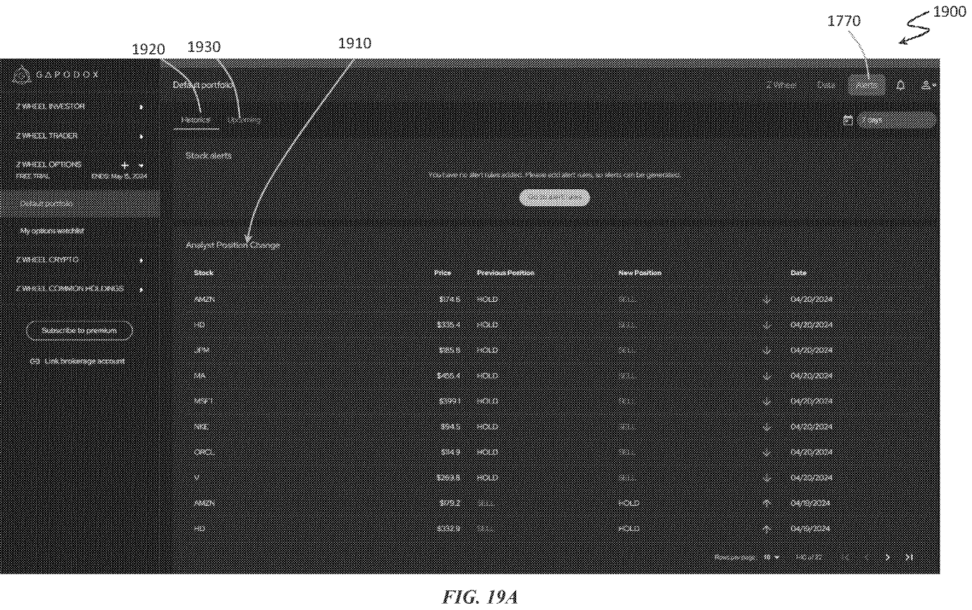

While the dynamic wheel interface 1710 is visually displayed on the screen 1700 when the “Z Wheel” button 1750 is selected, as with other wheel interfaces discussed above, the viewing user may again temporarily navigate away from the displayed interface 1710 by selecting the “Data” button 1760 or the “Alerts” button 1770, with similar information being respectively provided in substantially the same manner as described above. For example, FIG. 18 illustrates a screenshot 1800 displaying information regarding option assets displayed on the wheel interface 1710 when the “Data” button 1760 is selected. The displayed data 1810 may again be organized in rows, where one or more rows may be dedicated to a particular tradeable asset, such as stocks shown in the interface 1710. Columns may then be provided for one or more rows to provide certain information, such as Bollinger Band, VWAP, RSI, and IMI of the assets displayed on the wheel interface 1710, and any other information or data useful to users regarding a type of tradeable assets being presented. Data presented in columns may again be sorted as desired with a “Sort” button 1820, as well as filtered by a “Filter” button 1830 as described above. Also, a user may search for a particular option asset using a “Search” field 1840. Once again selecting the “Settings” button 1850 can access various items the user may select or change in order to alter data being displayed in columns for one or more option assets.

The dynamic wheel interface 1710 is provided as one example of a circular visualization for tracking selected items and is not limited to stock options or financial instruments. In other configurations, the interface can be adapted to track entities such as sports derivatives, predictive contracts, content engagement derivatives, system forecasts, or other derived or contingent data types, etc. Selection via a watchlist or similar control can define which entities are displayed, with real-time or near real-time updates based at least in part on changes in underlying data associated with the selected entities.

Similarly, wedges, asset class groupings, legends, and settings controls are not limited to option asset classes or financial analytics. In other implementations, wedges can represent grouped entities such as predictive categories, performance tiers, or structured datasets in non-financial domains, with size, motion, and other visual characteristics corresponding to domain-specific metrics such as exposure, probability, engagement level, or activity intensity, etc. The legend and settings functionality can be used to configure and interpret domain-specific indicators, while sharing and monetization features can be applied to user-generated analytical views or curated datasets across other platforms, with rewards or access conditions determined based at least in part on user-defined criteria or platform-defined metrics.

Likewise, data and alerts views associated with an interface can be adapted to present structured attributes and event-driven notifications for non-financial entities. In such implementations, tabular data can include domain-specific indicators or computed metrics, and alerts can reflect changes in performance, status, or predicted outcomes. Sorting, filtering, and search functionality can be used to organize and query displayed information across alternative datasets without requiring modification of underlying system architecture.

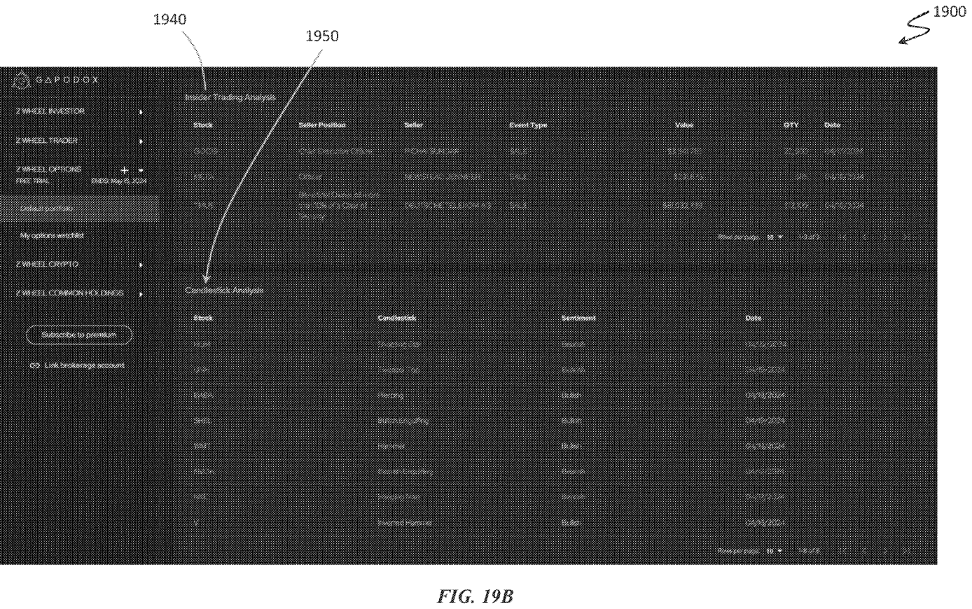

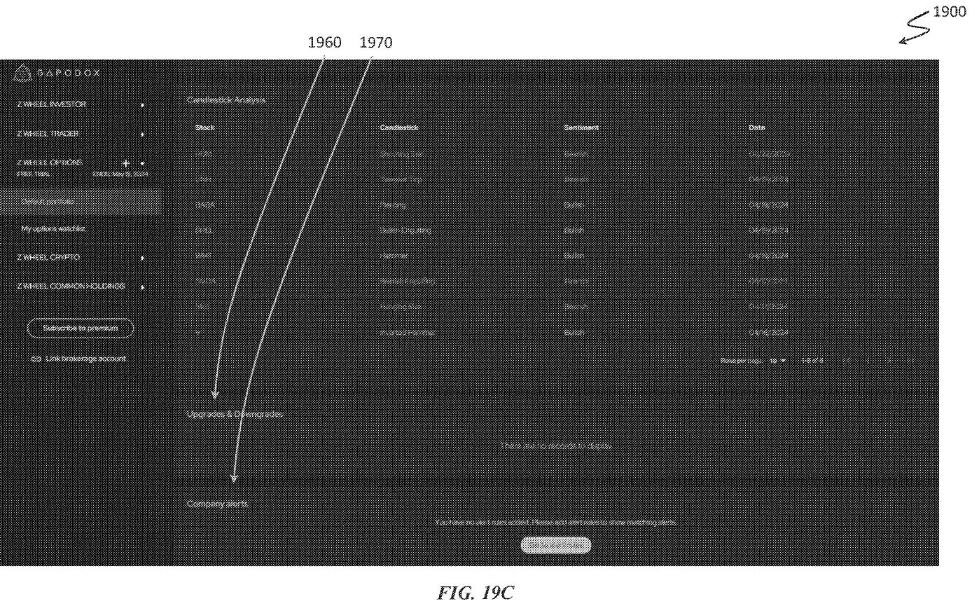

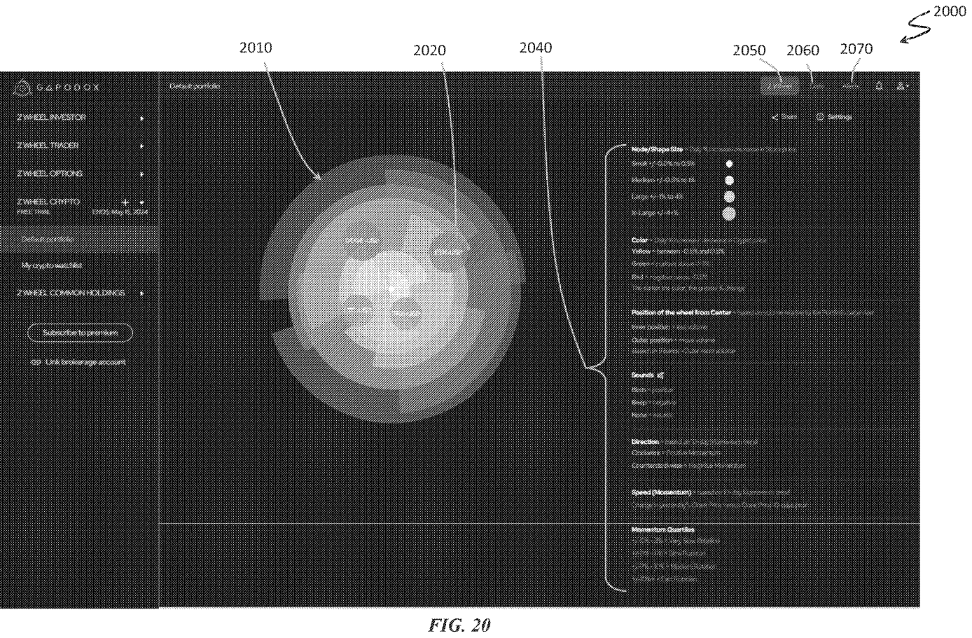

Looking now at FIG. 19A, illustrated is a screenshot 1900 displaying example alerts to a user regarding option assets displayed in the interface 1710 when the “Alerts” button 1770 is selected. As with the example Alerts screens discussed above, a first portion of the alerts screen 1900, entitled “Analyst Position Change” 1910, may provide information regarding an increased or decreased value of one or more option assets from the interface 1710, or perhaps suggestions by a platform (either via AI or tracking of other users'actions regarding a same or similar tradeable assets) of what to do with a tradeable asset (e.g., sell, buy, or hold). Such alerts may be customizable by users using “Alert Rules” or other settings, or may be provided as default alert settings set by a platform or an AI engine affiliated with the platform. Both a “Historical” tab 1920 and an “Upcoming” tab 1930 may also be provided to permit a user to view prior alerts as well as upcoming alerts, respectively, selectable for specified periods of time.

FIG. 19B illustrates a lower portion of the “Alerts” screens 1900 introduced above. In this scrolled-down portion of the Alerts screen 1900, additional alerts may be displayed to a user. In the illustrated embodiment, an “Insider Trading Analysis” section 1940 displays information to the user pertaining to known or perceived “insider trading” events regarding certain tradeable assets. Another section 1950 of the screen 1900 displays information to a user pertaining to “candlestick” events regarding certain option assets. FIG. 19C illustrates a further lower portion of the screen 1900 of FIGS. 19A and 19B. This lowest area of the screen 1900 may include an “Upgrades & Downgrades” section 1960, as well as a “Company alerts” section 1970, where both sections can provide relevant alerts and accompanying information to a user.

The alerts interface 1900 is provided as one example of an event-driven notification system associated with the dynamic wheel interface 1710 and is not limited to option assets or financial instruments. In other configurations, similar alert structures can be used to present notifications for domain-specific entities such as predictive events, performance changes, system status updates, or content-related signals, etc. Alerts can be generated based at least in part on changes in underlying data associated with selected entities and organized into categories corresponding to different event types within an application domain.

Similarly, sections such as “Analyst Position Change,” “Insider Trading Analysis,” “Candlestick Events,” “Upgrades & Downgrades,” and “Company Alerts” represent examples of grouped event classifications that can be adapted to non-financial contexts. In alternative implementations, such sections can correspond to performance shifts, anomaly detections, recommendation updates, or status transitions for tracked entities, etc., depending on the type of data being monitored. Historical and upcoming tabs, along with configurable alert rules, can likewise be applied to other datasets to enable temporal organization and user-defined filtering of event notifications.

Turning now to FIG. 20, illustrated is a screenshot 2000 of another embodiment of a dynamic wheel interface 2010, where this wheel interface 2010 provides a dynamic visual representation tracking a plurality of tradeable assets, which in this case are cryptocurrencies. In this “Crypto” wheel 2010, tradeable assets being tracked may or may not be tradeable assets held by a user viewing the interface 2010, but instead may be assets selected by a user to dynamically track. Similar to the interface 900 illustrated in FIG. 9, this interface 2010 may display a plurality of tradeable assets illustrated on a plurality of wedges within the wheel interface 2010. One or more tradeable assets may be displayed as a node 2020 within a wedge and at a specific radial position on the wheel interface 2010. While a “default portfolio” is displayed via the interface 2010, a subscribing user may make his own selections for display on the interface 2010 by clicking the “My crypto watchlist” option from a left-side menu.

The wheel interface 2010 also again may include a plurality of wedges arranged within and revolving dynamically around a center of a common area. Wedges may correspond to various asset classes, and the shape, size, and movement of wedges may comprise characteristics based, at least in part, on data regarding cryptocurrencies. As before, the size of a wedge may correspond to a first characteristic indicative of a volume of cryptocurrencies within a particular class or characteristic. In this illustrated embodiment, wedge size may correspond to a user's holding of cryptocurrencies for that wedge. In contrast, wedges with smaller sizes may correspond to a user holding a smaller amount of cryptocurrencies relative to his portfolio. Accordingly, a wedge significantly larger than another illustrated wedge may indicate that a user holds significantly more cryptocurrencies corresponding to cryptocurrencies in a first wedge than those in a second, smaller wedge. While just certain cryptocurrencies are shown displayed on the interface 2010, a list of all available cryptocurrencies may also be provided to a user from which he would select cryptocurrencies to be displayed on the interface 2010.

Another “Legend” 2040 may be displayed along the right-side of the interface 2010, and which may explain meanings of various symbols, colors, movements/velocities, and sizes/shapes of nodes 2020 displayed on the interface 2010. Again, a Settings button may be provided where a user may be permitted to adjust various settings affecting a display of the interface 2010 as well as other parts of the screen 2000. A Share button may also again be provided to permit a user to share his interface 2010 with other users, which can again be a general selection to make his interface 2010 publicly viewable or may be selected sharing with only certain other users. In either case, as described in detail above, a user may be rewarded for his sharing of his interface 2010, whether a reward is monetary or in the form of some other benefit provided to the user, such as reduced or waived subscriber fees to a platform. Monetization for sharing/socialization of a user's interface 1710 may be in any one or more of the manners discussed above.

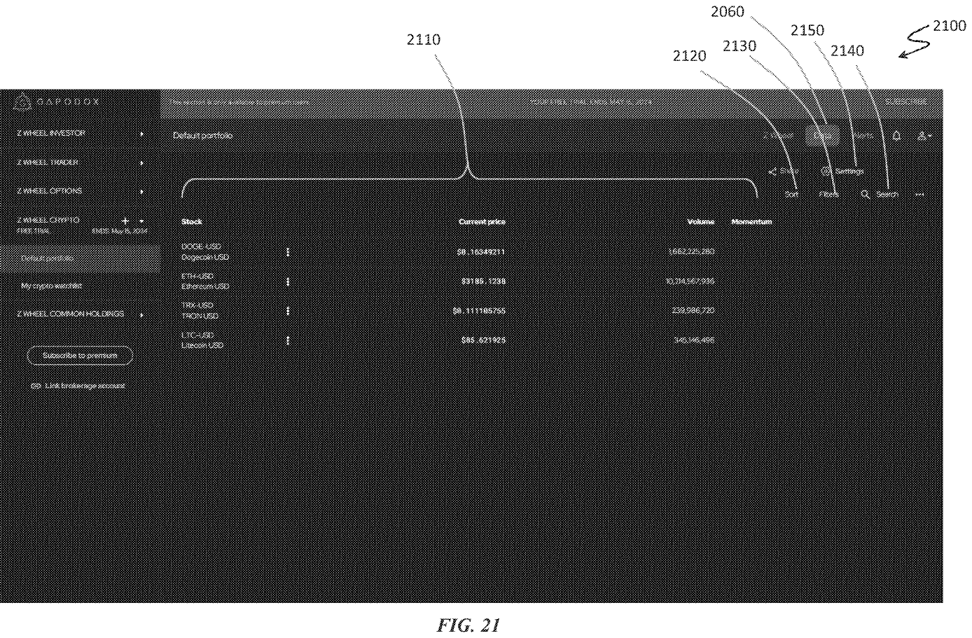

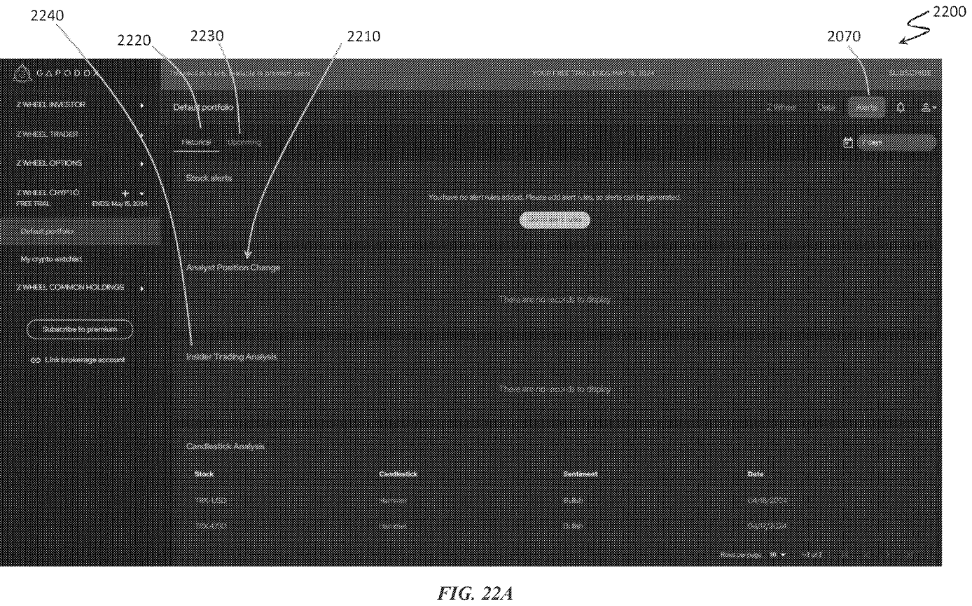

While the dynamic wheel interface 2010 is visually displayed on the screen 2000 when the “Z Wheel” button 2050 is selected, a viewing user may again temporarily navigate away from the displayed interface 2010 by selecting the “Data” button 2060 or the “Alerts” button 2070, with similar information being respectively provided in substantially the same manner as described above. For example, FIG. 21 illustrates a screenshot 2100 displaying information to a user when the “Data” button 2060 is selected. The displayed data 2110 may again be organized in rows, where one or more rows may be dedicated to a particular tradeable asset, such as the “stocks” (i.e., asset in this case) shown in the interface 2010. Columns may then be provided for one or more rows to provide certain information, such as current price, change in price, volume of assets owned by a user, and momentum of assets displayed on the wheel interface 2010, and any other information or data useful to users regarding a type of tradeable assets being presented. Data presented in columns may again be sorted as desired with a “Sort” button 2120, as well as filtered by a “Filter” button 2130 as described above. Also, a user may search for a particular tradeable asset using a “Search” field 2140. Once again selecting the “Settings” button 2150 can access various items a user may select or change in order to alter data being displayed in columns for one or more tradeable assets.

The dynamic wheel interface 2010 is provided as one example of a circular visualization for tracking selected items and is not limited to cryptocurrencies or financial instruments. In other configurations, an interface can be adapted to track entities such as digital assets in other ecosystems, gaming assets, media tokens, system resources, or other data objects, etc., with nodes and wedges representing domain-specific items selected by a user for monitoring. Watchlist-based selection can define which entities are displayed, with real-time or near real-time updates reflecting changes in underlying data associated with selected entities.

Similarly, wedges, asset groupings, legends, and settings controls are not limited to cryptocurrency classifications or portfolio management. In other implementations, wedges can represent grouped entities such as categories, clusters, or tiers in non-financial datasets, with size, motion, and other visual properties corresponding to relevant metrics such as activity level, usage, engagement, or relative distribution, etc. A legend and settings functionality can be used to interpret and configure domain-specific visual encodings, while sharing and monetization features can be applied to user-generated views or analytical configurations across other platforms, with access or rewards determined based at least in part on user-defined or platform-defined criteria.

Likewise, a data and alerts views associated with an interface can be adapted to present structured information and event-driven notifications for non-financial entities. In such implementations, tabular data can include domain-specific attributes and computed metrics, and alerts can reflect changes in status, performance, or other tracked conditions. Sorting, filtering, and search functionality can be applied across alternative datasets to support customized organization and retrieval of information without requiring modification of the underlying system architecture.

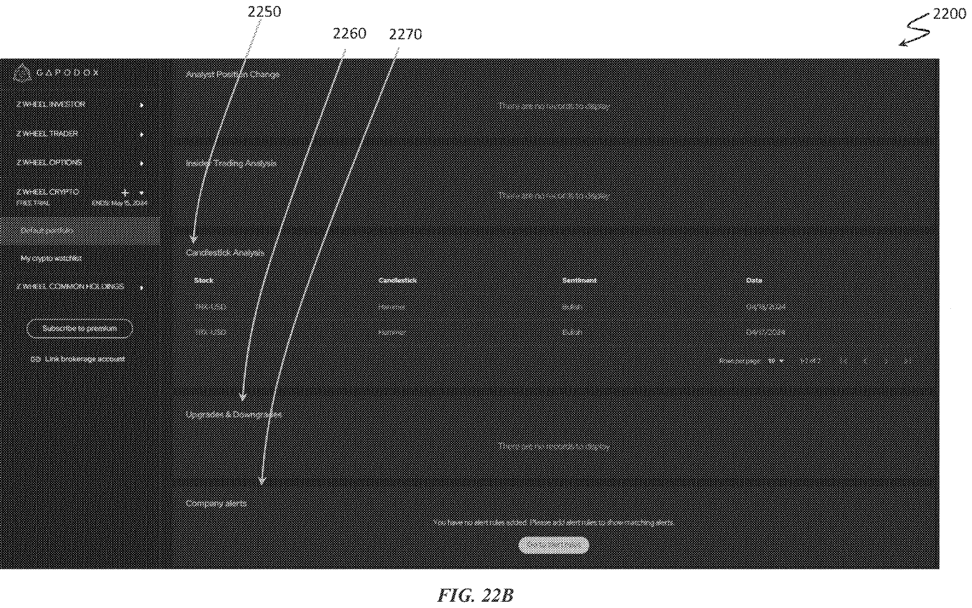

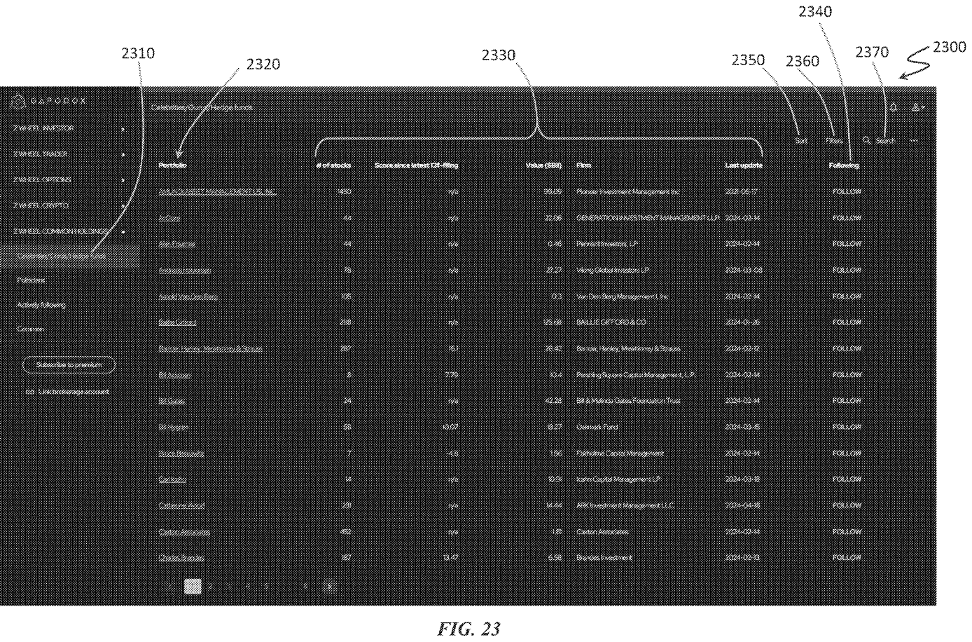

Looking now at FIG. 22A, illustrated is a screenshot 2200 displaying example alerts to a user regarding cryptocurrency assets displayed in the interface 2010 when the “Alerts” button 2070 is selected. As with an example Alerts screen discussed above, a first portion of the alerts screen 2200, entitled “Analyst Position Change” 2210, may provide information regarding an increased or decreased value of one or more tradeable assets from the interface 2010, or perhaps suggestions by a platform (either via AI or tracking of other users'actions regarding a same or similar tradeable assets) of what to do with a tradeable asset (e.g., sell, buy, or hold). Such alerts may be customizable by users using “Alert Rules” or other settings, or may be provided as default alert settings set by a platform or an AI engine affiliated with the platform. Both a “Historical” tab 2220 and an “Upcoming” tab 2230 may also be provided to permit a user to view prior alerts as well as upcoming alerts, respectively, selectable for specified periods of time.

FIG. 22B illustrates a lower portion of the “Alerts” screens 2200 introduced above. In this scrolled-down portion of the Alerts screen 2200, additional alerts may be displayed to a user. In the illustrated embodiment, an “Insider Trading Analysis” section 2240 may display information to a user pertaining to known or perceived “insider trading” events regarding certain tradeable assets. Another section 2250 of the screen 2200 may display information to the a pertaining to “candlestick” events regarding certain tradeable assets. FIG. 22B further illustrates an “Upgrades & Downgrades” section 2260, as well as a “Company alerts” section 2270, where both sections can provide relevant alerts and accompanying information to a user.

The alerts interface 2200 is provided as one example of an event-driven notification system associated with the dynamic wheel interface 2010 and is not limited to cryptocurrency assets or financial monitoring. In other configurations, similar alert structures can be used to present notifications for domain-specific entities such as digital ecosystem metrics, platform activity signals, system performance events, or other tracked data objects, etc. Alerts can be generated based at least in part on changes in underlying data associated with selected entities and organized into categories corresponding to different event types.

Similarly, sections such as “Analyst Position Change,” “Insider Trading Analysis,” “Candlestick Events,” “Upgrades & Downgrades,” and “Company Alerts” represent examples of grouped event classifications that can be adapted to non-financial contexts. In alternative implementations, these sections can correspond to status changes, anomaly detections, performance shifts, or recommendation updates for tracked entities in other domains, etc., depending on the type of data being monitored. Historical and upcoming tabs, along with configurable alert rules, can likewise be applied to other datasets to enable temporal organization and user-defined filtering of event notifications.

Turning now to FIG. 23, illustrated is a screenshot 2300 of a list of certain portfolios that may be known through a platform. In this embodiment, a portfolio list selected by a user to display on the screen 2300 may be selected from a left-side menu as “Celebrities/Gurus/Hedge funds” 2310. This selection may display a list of portfolios 2320 actually held by certain celebrities, “guru” investors and hedge funds affiliated or otherwise known to a platform, and which in this illustrated embodiment is presented alphabetically to a user.

For a investor/trader/fund displayed in the list 2320, a plurality of data/information 2330 regarding the tradeable assets held by a party/entity in the list 2320 may be displayed to a user. This data 2330 may include value and volume of tradeable assets held, what firm an investor/trader/fund has their tradeable assets affiliated with, and a date for data provided. Additionally, an option to “follow” 2340 any of an investor/trader/fund on the displayed list 2320 may also be provided to a user, where the user may simply click the “follow” link to do so. Following a portfolio not only provides important data regarding a portfolio, such as that displayed on the screen 2300, but may also permit a user to display the portfolio via one or more of the wheel interfaces disclosed herein.

As with other data presentations disclosed herein, the displayed data 2330 may again be organized in rows, where one or more rows are dedicated to a portfolio of a particular investor/trader/fund. Columns may then provide for one or more rows certain information that may be adjusted via a Settings option by a user. The presented data 2330 in the columns may again be sorted as desired with a “Sort” button 2350, as well as filtered by a “Filter” button 2360 as described above. Also, a user may search for a particular tradeable asset using a “Search” field 2370. Selecting a “Settings” button (not illustrated), which may be accessible via the ellipses ( . . . ) symbol, and can access various items a user may select or change in order to alter the data 2330 being displayed in columns for one or more portfolios.

The portfolio list interface 2300 is provided as one example of presenting curated collections of user-associated entities and is not limited to celebrity, investor, or hedge fund portfolios in a financial context. In other configurations, similar list-based views can be used to present collections of entities in domains such as sports teams and coaching staffs, content creator profiles, organizational groups, or curated datasets in other platforms, etc. Selection of a category from a menu can define which group of entities is displayed, with a list organized based at least in part on a selected ordering criterion such as name, performance metric, or platform-defined ranking.

Similarly, the displayed portfolio data 2330 and associated interaction controls, including follow functionality, sorting, filtering, and search, are not limited to financial portfolio analytics. In other implementations, these features can be applied to non-financial entity collections to enable users to follow and monitor selected profiles, entities, or datasets, with associated metrics tailored to the relevant domain. Settings controls can further allow customization of displayed attributes and organization of the underlying data, supporting flexible configuration of how entity collections are viewed and interacted with across different applications.

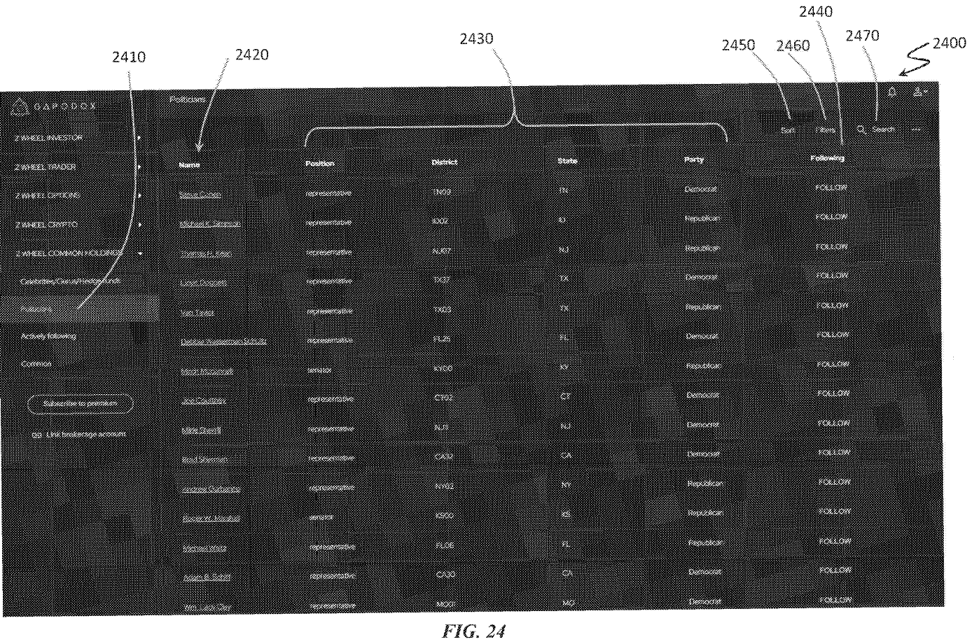

Looking now to FIG. 24, illustrated is a screenshot 2400 of a different list of portfolios that may be accessible through a platform. In this embodiment, the portfolio list selected by a user to display on the screen 2400 may be selected from a left-side menu as “Politicians” 2410. This selection may display a list of portfolios 2420 actually held by certain politicians affiliated or otherwise known to a platform.

For politicians displayed in the list 2420, a plurality of data/information 2430 regarding the politicians themselves may be displayed to a user. The displayed data 2430 may include a politician's position, district and state they represent, and their party affiliation. Alternatively, data regarding tradeable assets held by one or more politicians in the list 2420 may be displayed to a user via a selection to do so. Additionally, an option to “follow” 2440 any of the politicians on the displayed list 2420 may also be provided to a user, where the user may simply click the “follow” link to do so. Following a portfolio may not only provide important data regarding the portfolio, such as that displayed on the screen 2400, but may also permit a user to display a portfolio via one or more of the wheel interfaces disclosed herein.

As with other data presentations disclosed herein, the displayed data 2430 may again be organized in rows, where one or more rows may be dedicated to a portfolio of a particular politician. Columns then may then provide certain information one or more rows that may be adjusted via a Settings option by a user. The presented data 2430 in columns may again be sorted as desired with a “Sort” button 2450, as well as filtered by a “Filter” button 2460 as described above. Also, a user may search for a particular politician using a “Search” field 2470. Selecting a “Settings” button (not illustrated) but which may be accessible via an ellipses ( . . . ) symbol can access various items a user may select or change in order to alter the data 2430 being displayed in columns for a portfolio.

The portfolio list interface 2400 is provided as one example of presenting entity-specific profile data alongside curated collection lists and is not limited to politicians or financial contexts. In other configurations, similar list-based views can be used to present entities such as athletes, coaches, executives, content creators, or other public figures, etc., with domain-relevant attributes displayed alongside one or more entities in a list. Selection of a category such as “Politicians” 2410 from a menu illustrates how a platform can organize distinct groups of entities, and similar category-based navigation can define which group of entities is displayed in non-financial implementations.

Similarly, the displayed data 2430 and associated interaction controls, including the follow functionality 2440, sorting 2450, filtering 2460, and search 2470, are not limited to politician portfolios or financial data. In other implementations, these features can be applied to non-financial entity lists to enable users to follow and monitor selected profiles, with associated attributes tailored to the relevant domain. For example, in a sports context, displayed attributes may include a player's team, position, and performance statistics, etc., in place of political office or party affiliation. Settings controls can further allow customization of which attributes are displayed in columns for one or more entities, supporting flexible configuration of how entity collections are viewed and interacted with across different applications.

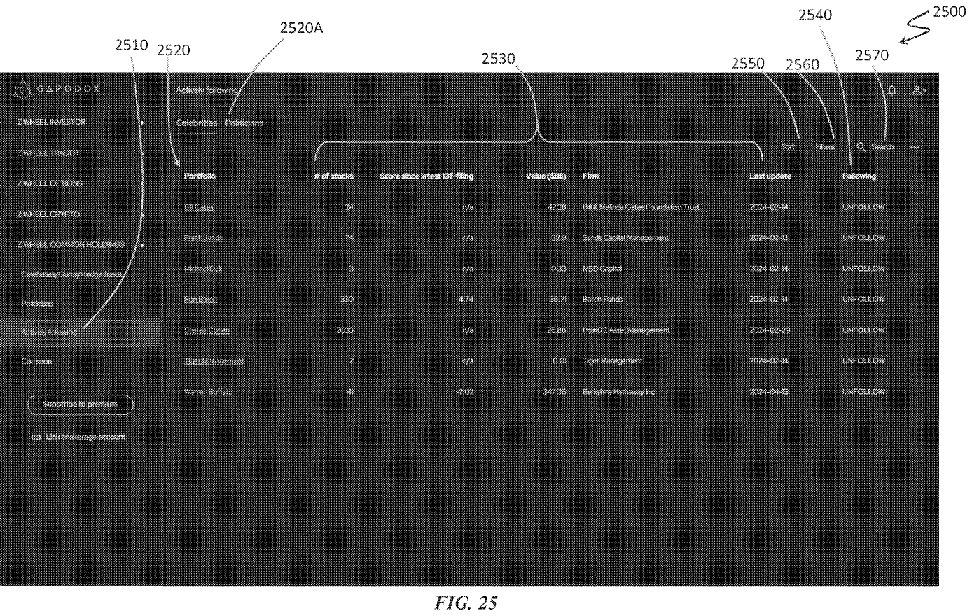

Referring now to FIG. 25, illustrated is a screenshot 2500 of a list of portfolios that are being “followed” by a user of a platform. In this embodiment, a displayed list of followed portfolios may be selected by a user from a left-side menu as “Actively followed” 2510. This selection may display a list of portfolios 2520 a user has previously selected to follow using a platform. Following a portfolio may not only provide important data regarding a portfolio, such as that displayed on the screen 2500, but also may permit a user to display the portfolio via one or more of the wheel interfaces disclosed herein.

For a portfolio displayed in the list 2520, a plurality of data/information 2530 regarding the followed portfolio may be displayed to a user. The displayed data 2530 may include value and volume of tradeable assets held, what firm an investor/trader/fund has their tradeable assets affiliated with, and a date for data provided. Alternatively, data regarding an investor/trader/fund being followed may be displayed to a user via a selection to do so. Additionally, an option to “unfollow” 2540 any followed portfolio may also be provided to a user, where the user may simply click an “unfollow” link to do so.

As with other data presentations disclosed herein, the displayed data 2530 may again be organized in rows, where one or more rows may be dedicated to a portfolio of a particular followed portfolio. Columns may then provide certain information one or more rows that may be adjusted via a Settings option by a user. The presented data 2530 in columns may again be sorted as desired with a “Sort” button 2550, as well as filtered by a “Filter” button 2560 as described above. Also, a user may search for a particular followed portfolio using a “Search” field 2570. Selecting a “Settings” button (not illustrated) but which may be accessible via the ellipses ( . . . ) symbol can access various items a user may select or change in order to alter the data 2530 being displayed in columns for a followed portfolio.

The actively followed portfolio list interface 2500 is provided as one example of presenting a user-curated collection of tracked entities and is not limited to financial portfolios or investment contexts. In other implementations, similar list-based views can be used to present collections of followed entities in domains such as sports, entertainment, academia, or other platforms, etc., where a user has previously selected specific profiles or datasets to monitor. Selection of a category such as “Actively followed” 2510 from a menu illustrates how a platform can surface a personalized subset of entities based at least in part on prior user actions, and similar category-based navigation can be applied across non-financial implementations.

Similarly, the displayed data 2530 and associated interaction controls, including the unfollow functionality 2540, sorting 2550, filtering 2560, and search 2570, are not limited to financial portfolio tracking. In other implementations, these features can be applied to non-financial followed entity lists to enable users to manage and monitor selected profiles, with associated attributes tailored to a relevant domain. For example, in a sports context, displayed attributes may include a player's team, position, and performance statistics, etc., in place of asset value, volume, or affiliated firm. Settings controls can further allow customization of which attributes are displayed in columns for one or more followed entities, supporting flexible configuration of how user-curated collections are viewed and interacted with across different applications.

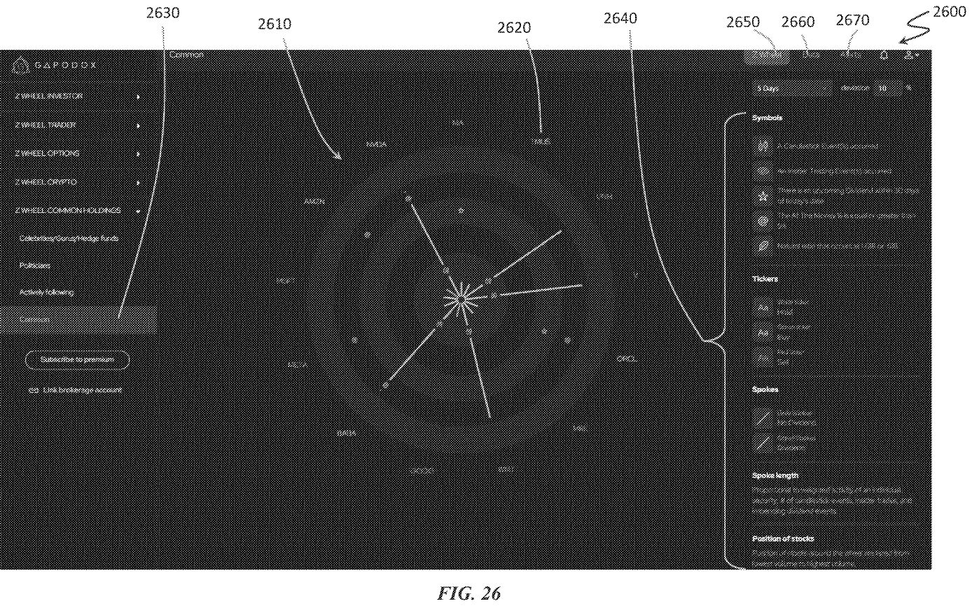

Turning now to FIG. 26, illustrated is a screenshot 2600 of another embodiment of a dynamic wheel interface 2610, where this wheel interface 2610 may provide a dynamic visual representation tracking a plurality of tradeable assets commonly held in portfolios being “followed” by a viewing user. In this example, commonly held tradeable assets are illustrated as labels 2620 organized around a circumference of the interface 2610. As such, this wheel interface 2610 may be accessed by clicking an appropriate “Common” button 2630 in the selectable menu 2630 on a left side of the display screen 2600.

As with the interface embodiment shown in FIGS. 5 and 11, the interface 2610 in FIG. 26 displays a plurality of commonly tradeable assets (shown by their ticker symbol) are arranged around a periphery of a plurality of concentrically-aligned annular regions. As with the other similar embodiments disclosed herein, information pertaining to a commonly held asset may be designated by placement of one or more graphical elements in these annular regions, extending in a radial direction from an origin at a center of the wheel interface 2610 outwards towards respective commonly held assets. Also as before, placement of ticker symbols may be indicative of a volume of commonly held tradeable assets corresponding to the ticker symbols. In one embodiment, placement of ticker symbols may be indicative on increasing volume, with volume increasing in a clockwise direction. In another embodiment, placement of ticker symbols may be indicative on increasing volume, with volume increasing in a counterclockwise direction.

Also as before, the interface 2610 may again include lines extending from an origin toward ticker symbols representing commonly held assets. These lines can be dividend symbols that include at least: (i) a first variable aspect, and (ii) a second variable aspect. An example of a first variable aspect can be an appearance of a line (such a different colors) that may graphically indicate whether or not a dividend is paid to holders of a commonly held asset. Similar to the interface 1100 of FIG. 11, line colors may be used to provide such information. A second variable aspect of lines can graphically indicate a relative quantity of events that occurred, or are scheduled to occur involving commonly held tradeable assets displayed on the interface 2610. For example, the longer the line, the greater the number of events that may have occurred, or may be scheduled to occur involving tradeable assets. However, other graphical aspects of a line such as a color code, a size, a shape, or any other graphical element can be utilized as a variable aspect.

According to some embodiments, examples of the events may include, but are not limited to: candlestick events, insider trades, impending dividend events, any other event, and any combination thereof. In this example screen 2600, a Legend 2640 is again provided along a right side of the display screen 2600 to explain to a user what certain symbols mean for a particular commonly held asset. As described above, such symbols can be arranged within an annular regions in a radial direction extending from an origin to a respective ticker symbol. For example, a marker such as the “at” symbol (@) can be placed in an annular region, which can be designated for markers that identify commonly held assets for which an “at the money” percentage may exceed a percentage specified in a configuration package, which may be user-defined. In the illustrative embodiment of FIG. 26, a defined tolerance was again specified as five (5%) in a configuration package. Similarly, another or a same annular region can be designated to display markers such as a star (★), which may be indicative of an upcoming dividend payment within a predefined period (perhaps by a user as well) from a date on which numeric and transaction data are received by an aggregation module 112 described above. In the example of FIG. 26, the stars (★) may indicate that two commonly held assets have an upcoming dividend payment within the next thirty (30) days.

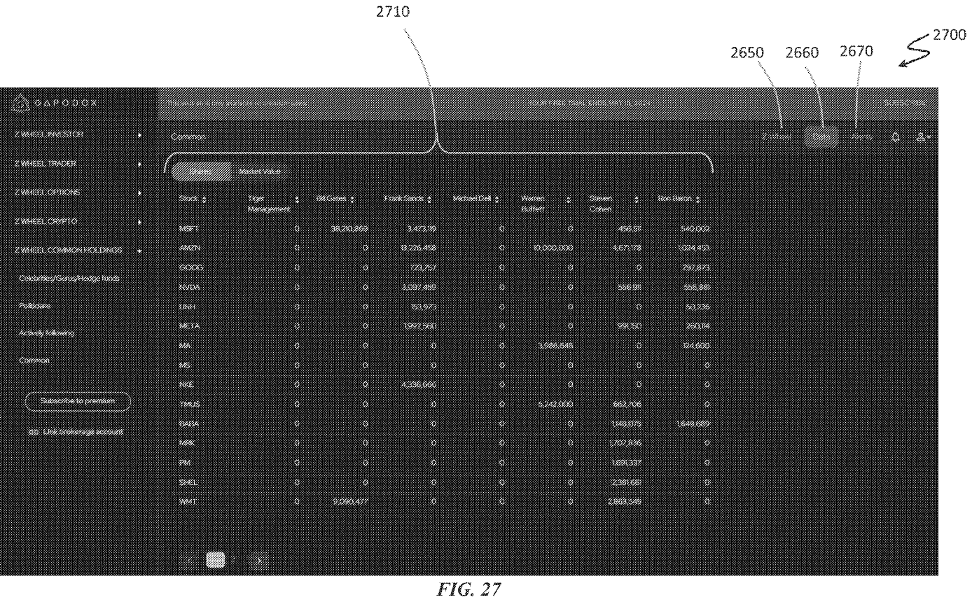

A display marker that is an eye may again also be used in one or more of the annular regions to indicate that an insider trading event has occurred. Also as before, a display marker that is a candlestick marker may also be displayed in an annular region to indicate a candlestick event has occurred. Any one or more visual indicators described above for other embodiments of a wheel interface in accordance with the disclosed principles may also be included on the wheel interface 2610 of FIG. 26. While presentation of the wheel interface 2610 of commonly held assets may be provided to a user when selecting the “Z Wheel” button 2650, a viewing user may again temporarily navigate away from the displayed interface 2610 by selecting the “Data” button 2660 or the “Alerts” button 2670, with similar information being respectively provided in substantially the same manner as described above. For example, FIG. 27 illustrates a screenshot 2700 displaying information regarding commonly held assets displayed on the wheel interface 2610 when the “Data” button 2660 is selected. The displayed data 2710 may again be organized in rows, where one or more rows is dedicated to a particular tradeable asset, such as commonly held stocks shown in the interface 2610. Columns may then be provided for one or more rows to provide certain information, which in this example is the name of the investor/trader/fund that holds shares of the commonly held stocks, and how much. Date presented in columns may be altered from a display by a “Shares” button of commonly held assets to a “Market Value” button that displays in the columns of holders of one or more commonly held stocks a market value of their respectively held assets, rather than a number of shares.

While not illustrated, the displayed data 2710 may optionally be sorted as desired with a “Sort” button as well as filtered by a “Filter” button as described above. Also, a user may search for a particular option asset using a “Search” field (not illustrated), as also described above. Once again, a “Settings” button (not illustrated) as also described can access various items a user may select or change in order to alter the data 2710 being displayed in columns and/or rows for one or more commonly held assets displayed.

The wheel interface 2610 is provided as one example of a dynamic visual representation of commonly held assets across followed portfolios and is not limited to financial contexts or tradeable assets. In other configurations, similar wheel-based views can be used to present commonly held entities across followed collections in domains such as sports, entertainment, or other platforms, etc., where multiple followed profiles or datasets share common elements such as players on a roster, tracks in a playlist, or titles in a catalog, and the like. Selection of a category such as “Common” 2630 from a menu illustrates how a platform can surface shared elements across a user's followed collections, and similar category-based navigation can be applied across non-financial implementations.

Similarly, visual encoding of the wheel interface 2610, including an arrangement of labels around a circumference, the use of lines extending from an origin with variable aspects such as color and length, and placement of display markers in annular regions, are not limited to financial asset data. In other implementations, these graphical elements can be applied to non-financial datasets, with line appearance and length based at least in part on domain-relevant metrics such as player performance trends, event frequency, or engagement statistics, etc. Display markers can likewise be tailored to surface domain-specific events, for example upcoming games, contract expirations, or milestone achievements, and the like, in place of dividend payments or insider trading events.

The associated data view 2710 and interaction controls, including sorting, filtering, search, and settings, are also not limited to financial portfolio data. In other implementations, a tabular data view can present non-financial attributes of commonly shared entities across followed collections, with columns configurable to display domain-relevant metrics in place of share counts or market values, supporting flexible configuration of how shared entity data is viewed and interacted with across different applications.

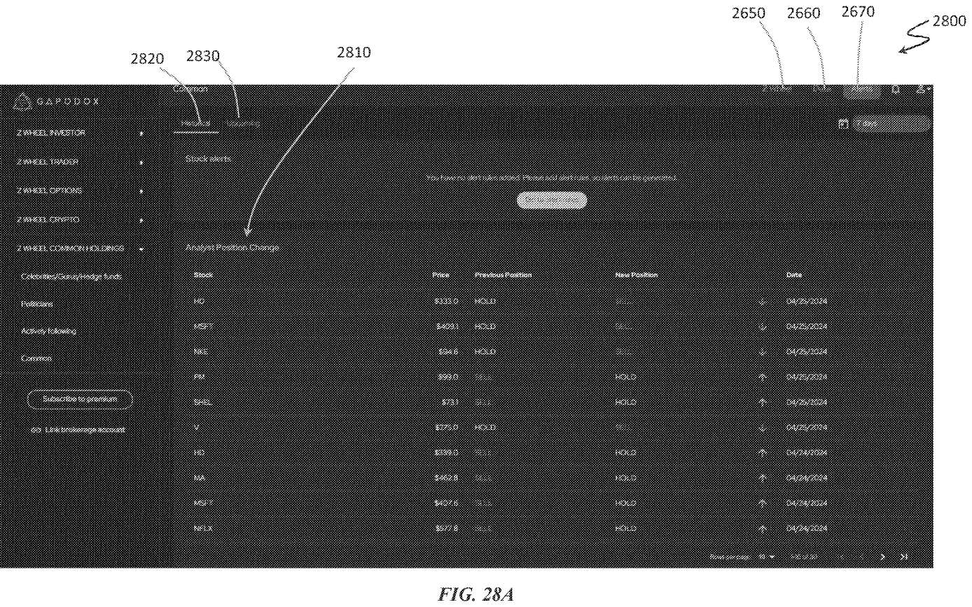

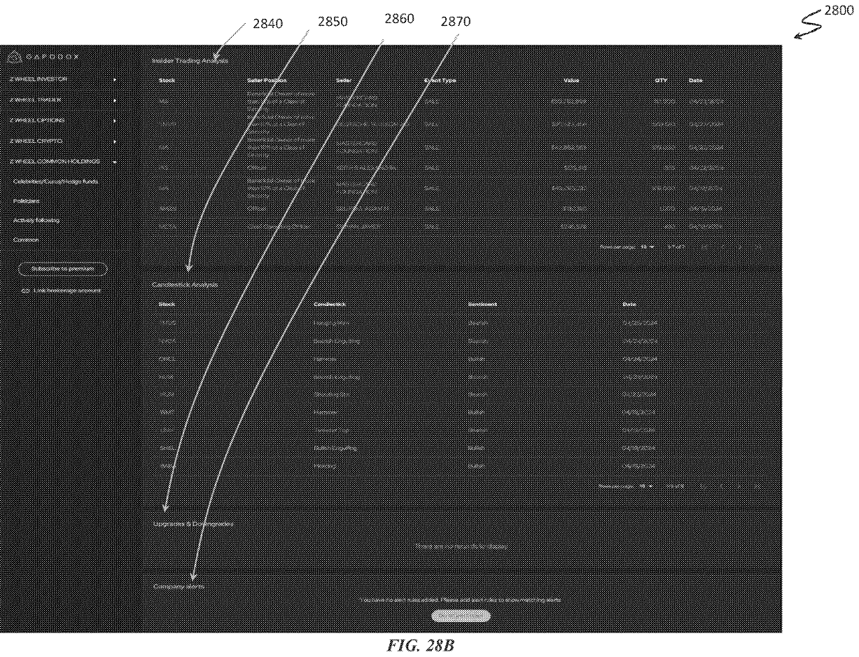

Looking now at FIG. 28A, illustrated is a screenshot 2800 displaying example alerts to a user regarding the option assets displayed in the interface 2610 when the “Alerts” button 2670 is selected. As with the example Alerts screens discussed above, a first portion of the alerts screen 2800, entitled “Analyst Position Change” 2810, provides information regarding the increased or decreased value of one or more option assets from the interface 2610, or perhaps suggestions by the platform (either via AI or tracking of other users'actions regarding the same or similar tradeable assets) of what to do with a tradeable asset (e.g., sell, buy, or hold). Such alerts may be customizable by users using “Alert Rules” or other settings, or may be provided as default alert settings set by the platform or an AI engine affiliated with the platform. Both a “Historical” tab 2820 and an “Upcoming” tab 2830 may also be provided to permit the user to view prior alerts as well as upcoming alerts, respectively, selectable for specified periods of time.

FIG. 28B illustrates a lower portion of the “Alerts” screens 2800 introduced above. In this scrolled-down portion of the Alerts screen 2800, additional alerts are displayed to a user. In the illustrated embodiment, an “Insider Trading Analysis” section 2840 displays information to the user pertaining to known or perceived “insider trading” events regarding certain commonly owned tradeable assets. Another section 2850 of the screen 2800 displays information to the user pertaining to “candlestick” events regarding certain option assets. In the lowest area of the screen 2800 includes an “Upgrades & Downgrades” section 2860, as well as a “Company alerts” section 2870, where both sections can provide relevant alerts and accompanying information to the user in the same manner as other embodiments discussed above.

The alerts interface 2800 is provided as one example of surfacing domain-specific notifications and analytical insights associated with entities displayed in a related visual interface and is not limited to financial assets or investment contexts. In other configurations, similar alert-based views can be used to present notifications for non-financial entities in domains such as sports, entertainment, or other platforms, etc., where alerts may pertain to events such as roster changes, performance milestones, or platform-defined recommendations based at least in part on user activity or AI-generated insights. The Historical 2820 and Upcoming 2830 tabs illustrate how an alerts interface can organize notifications across time, and similar tab-based navigation can be applied across non-financial implementations.

Similarly, the individual alert sections displayed within the screen 2800, including the Analyst Position Change section 2810, the Insider Trading Analysis section 2840, the candlestick events section 2850, the Upgrades & Downgrades section 2860, and the Company Alerts section 2870, are not limited to financial event types. In other implementations, analogous sections can surface domain-relevant event categories, for example coaching changes, disciplinary actions, performance trend signals, or organizational news, etc., in place of financial alerts. Alert rules and settings can further allow users to customize which event types are surfaced and for which entities, supporting flexible configuration of how notifications are presented and managed across different applications.

### Example Computing Device/system

Looking back to FIG. 29, illustrated is an example of a computing device that may be configured and/or programmed with one or more example systems and methods described herein, and/or equivalents. An example computing device may be a computer 2900 that includes a processor 2902, a memory 2904, and input/output ports 2910 operably connected by a bus 2908. In one example, the computer 2900 may include logic 2930 configured to control operation of a display 102 with respect to the system 100 shown in FIG. 1. In different examples, the logic 2930 may be implemented in hardware, a non-transitory computer-readable medium with stored instructions, firmware, and/or combinations thereof. While the logic 2930 is illustrated as a hardware component attached to the bus 2908, it is to be appreciated that in other embodiments, the logic 2930 could be implemented in the processor 2902, stored in memory 2904, or stored in disk 2906.

In one embodiment, logic 2930 or the computer 2900 may be a means (e.g., structure: hardware, non-transitory computer-readable medium, firmware) for performing the actions described. In some embodiments, the computer 2900 may be a server operating in a cloud computing system, a server configured in a Software as a Service (SaaS) architecture, a smartphone, laptop, tablet computing device, and so on.

The means may be implemented, for example, as an ASIC programmed to authorize communications between members, and limit communications to authorized members. Means may also be implemented as stored computer executable instructions that are presented to computer 2900 as data 2916 that are temporarily stored in memory 2904 and then executed by processor 2902.

The logic 2930 may also provide means (e.g., hardware, non-transitory computer-readable medium that stores executable instructions, firmware) for performing operations regarding controlling the display 102, via a display driver module 2926, as described herein.

Generally describing an illustrative configuration of the computer 2900, the processor 2902 may be a variety of various processors including dual microprocessor and other multi-processor architectures. The memory 2904 may include volatile memory and/or non-volatile memory. Non-volatile memory may include, for example, ROM, PROM, and so on. Volatile memory may include, for example, RAM, SRAM, DRAM, and so on.

The storage 2906 may be operably connected to the computer 2900 via, for example, an input/output (I/O) interface (e.g., card, device) 2918 and an input/output port 2910. The storage 2906 may be, for example, a magnetic disk drive, a solid-state disk drive, a floppy disk drive, a tape drive, a Zip drive, a flash memory card, a memory stick, and so on. Furthermore, the storage 2906 may be a CD-ROM drive, a CD-R drive, a CD-RW drive, a DVD-ROM, and so on. The memory 2904 can store a process 2914 and/or a data 2916, for example. The disk 2906 and/or the memory 2904 can store an operating system that controls and allocates resources of the computer 2900.

The computer 2900 may interact with input/output (I/O) devices via the I/O interfaces 2918 and the input/output ports 2910. Input/output devices may be, for example, a keyboard, a microphone, a pointing and selection device, cameras, video cards, displays, the disk 2906, the network devices 2920, and so on. The input/output ports 2910 may include, for example, serial ports, parallel ports, and USB ports.

The computer 2900 can operate in a network environment and thus may be connected to the network devices 2920 via the I/O interfaces 2918, and/or the I/O ports 2910. Through the network devices 2920, the computer 2900 may interact with a network. Through a network, the computer 2900 may be logically connected to remote computers. Networks with which the computer 2900 may interact include, but are not limited to, a LAN, a WAN, and other networks.

In one or more embodiments, the disclosed methods or their equivalents may be performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks.

### Example Artificial Intelligence Implementations

Advantageously, most or all the functionality of systems, methods, and platforms described discussed above may be implemented or assisted by use of artificial intelligence (AI). Those skilled in pertinent fields of art are knowledgeable about the development and use of artificial intelligence, and thus a detailed discussion of these will not be included here. However, AI principles for providing suggestions to manage a portfolio disclosed in U.S. Pat. No. 11,443,380 may be utilized and is incorporated by reference. Additionally, the implementation of AI into some or all of the unique functionality of systems, methods, and platforms designed or constructed in accordance with the disclosed principles results in novel applications and results. AI may not only do a better job of including all relevant information about the user's trading preferences that the user may forget to employ in a portfolio but may also better present that information. Such better presentation may also be tailored to a user's purpose for using the systems, methods, and platforms, such as tailoring the portfolio for the best presentation to trade assets.

For example, as mentioned above, an AI may suggest trading recommendations based, at least in part, on, for example, a user's trading tendencies. For example, an AI may provide buy or sell recommendations for a user's tradeable assets based, at least in part, on the user's historical actions for candlestick events, insider trading events, upcoming dividends (or no dividends), at the money, and/or natural ratio occurrence. An AI may provide buy or sell recommendations for a user's tradeable assets based, at least in part, on the user's historical actions with a same asset or similar assets. Additionally, an AI may ask the user questions about a portfolio to optimize holdings. For example, the AI may learn that a user has a preference for assets within a certain class or sector (e.g., energy, finance, healthcare, telecommunications, etc.) and provide recommendations for assets within that class or sector. Further, an AI may learn that a user has a preference for characteristics (e.g., pays dividends, short selling, etc.) of these assets and provide recommendations for assets within that class or sector that match the user's preferred characteristics.

Additionally, an AI may suggest trading recommendations based, at least in part, on, for example, a user's trading tendencies. For example, an AI may provide buy or sell recommendations for a user's tradeable assets based, at least in part, on the user's historical threshold values of performance indicators. Additionally, an AI may provide buy or sell recommendations for a user's tradeable assets based, at least in part, on the user's historical actions with a same asset or similar assets. For example, an AI may understand when a user prefers to buy or sell at certain trading momentum speed, momentum direction, percent change in price, etc. Additionally, an AI may ask a user questions about a portfolio to optimize holdings. For example, an AI may learn that a user has a preference for assets within a certain class or sector (e.g., energy, finance, healthcare, telecommunications, etc.) and provide recommendations for assets within that class or sector. Further, an AI may learn that a user has a preference for characteristics (e.g., pays dividends, short selling, momentum tendencies, etc.) of these assets and provide recommendations for assets within that class or sector that match the user's preferred characteristics. Additionally, in any and all of the described situations, a user may ask an AI questions about their portfolio to obtain information or recommendations. For example, a user may ask an AI for suggestions on investment strategy, how to manage the portfolio, buy/sell actions, or portfolios of other users that have better returns.

In yet another aspect, an AI may suggest portfolios of other users for a user to follow, based, at least in part, on the user's holdings and trading tendencies. For example, an AI may identify portfolios of other users with similar volume but higher returns. Additionally, an AI may identify portfolios of other users with similar trading tendencies but higher returns. An AI may suggest that a user follow these portfolios to help improve the user's returns. An AI may also suggest investment actions for a user to take based, at least in part, on suggested portfolios. For example, an AI may suggest that a user trade out of a certain asset and buy a similar asset that is held by a followed user and producing better returns.

Other potential implementations of AI for users are the use of AI to help customize the interface 500 and/or the dynamic interface 900, or any interface in accordance with the disclosed principles. For example, a user may interact with an AI to answer questions concerning preference about information presented in the interface 500 and/or the dynamic interface 900, or any interface in accordance with the disclosed principles. A user may learn how any such interface operates and why they should have certain information presented. Based at least in part on a user's answers, an AI may provide suggestions on which information should be presented in an interface, and the AI may generally provide the user with educational information on finance as well as how the educational information may be visualized on an interface. Additionally, an AI may periodically follow-up with a user about information preferences, as the preferences may change over time and based, at least in part, on the user's trading tendencies evolving.

The AI functionality described above is provided as one example of how artificial intelligence can be applied to enhance platform functionality and is not limited to financial portfolios or tradeable assets. In other configurations, AI can be applied to non-financial platforms in domains such as sports, entertainment, or other data-driven applications, etc., to surface personalized recommendations and insights based at least in part on a user's historical interactions, preferences, and followed entities. For example, in a sports context, an AI may learn that a user has a preference for entities within a certain category such as a particular sport, league, or position, and provide recommendations for players, teams, or collections that match those preferences.

Similarly, AI-driven recommendation features described above, including suggestions to follow other users'collections, identification of similar entities with stronger performance metrics, and proactive questioning to optimize a user's followed collections, are not limited to financial portfolio management. In other implementations, these features can be applied to non-financial domains to suggest, for example, athletes, coaches, or teams with similar characteristics but stronger performance outcomes, and the like, in place of tradeable assets with higher returns. An AI may likewise suggest that a user trade out of a followed entity in favor of a similar entity with better domain-relevant metrics.

The use of AI to customize and educate users about platform interfaces is also not limited to financial contexts. In other implementations, an AI can interact with users to answer questions about interface preferences, explain how domain-relevant metrics are visualized, and provide educational information tailored to the relevant domain, such as, for example sports analytics, media performance, or organizational data, etc. An AI may further periodically follow up with a user about evolving preferences based at least in part on changes in the user's interaction tendencies over time, supporting flexible and personalized configuration of any interface across different applications.

The following sections'content includes definitions of selected terms employed herein. These definitions include various examples and/or forms of components that fall within the scope of a term and that may be used for implementation. These examples are not intended to be limiting. Both singular and plural forms of terms may be included within these definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure,” as used herein, is an organization of data in a computing system that is stored in a memory medium, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium,” as used herein, refers to a non-transitory medium that stores instructions and/or data configured to perform one or more of the disclosed functions when executed by at least a single processor. Data may function as instructions in some embodiments. A computer-readable medium may take forms, including, but not limited to, non-volatile media or volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read-only memory (ROM), a memory chip or card, a memory stick, solid-state storage device (SSD), flash drive, and other media from which a computer, a processor or other electronic device can function with. Types of media, if selected for implementation in one embodiment, may include stored instructions of an algorithm configured to perform one or more of the disclosed and/or claimed functions.

“Logic,” as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based, at least in part, on desired system conditions or specifications. For example, if greater speed is a goal, then hardware would be selected to implement functions. If a lower cost is desired, then stored instructions/executable application would be selected to implement the functions.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described.

To the extent that the term “includes” or “including” is employed in the detailed description or the claims, it is intended to be inclusive in a manner similar to the term “comprising” as that term is interpreted when employed as a transitional word in a claim.

What is claimed is:

1. A computer-implemented method comprising:
electronically generating, via a graphical user interface rendered on a display device of a client computing device, a digital representation of one or more content categories, at least one content category of the one or more content categories comprising a dynamic wheel-type digital interface with a particular on-screen layout digitally rendered via a plurality of graphical elements based, at least in part, on the one or more content categories, wherein electronically generating comprises generating the plurality of graphical elements, the plurality of graphical elements arranged within a common region extending radially from an origin element;
receiving, by one or more processors of the computing device, one or more data streams from a plurality of sources, the one or more data streams comprising real-time updates and historical data records associated with one or more unique identifier values of the one or more content categories;
normalizing and temporally aligning the one or more data streams to generate one or more time-indexed datasets, the one or more time-indexed datasets organizing the real-time updates and historical data records according to the one or more unique identifier values and a time dimension;
computing, based at least in part on the one or more time-indexed datasets, one or more geometric relationships between two or more graphical elements of the plurality of graphical elements; and
incrementally updating the two or more graphical elements of the dynamic wheel-type digital interface as part of the particular on-screen layout in response to detected changes in the one or more data streams based at least in part on the one or more geometric relationships.

2. The method of claim 1, wherein the plurality of graphical elements comprises at least one or more of the following:
an origin element designating a rotation point for an on-screen rotation of at least a portion of the dynamic wheel-type digital interface about the origin element;
a common region comprising one or more concentrically-aligned annular regions extending radially from the origin element;
one or more digital fields comprising one or more unique identifier values geometrically arranged about a periphery of the one or more concentrically-aligned annular regions;
one or more digital lines extending outwardly from the origin element towards the one or more digital fields, the one or more digital lines having one or more variable aspects encoding qualitative or quantitative properties of the one or more unique identifier values;
one or more action-signal symbols positioned outside an outermost concentrically-aligned annular region of the one or more concentrically-aligned annular regions, the one or more action-signal symbols encoding a computed action state associated with a corresponding unique identifier value of the one or more unique identifier values; or
any combination thereof.

3. The method of claim 2, wherein the one or more data streams are continually processed by the one or more processors, and wherein incrementally updating comprises electronically combining the one or more data streams to generate a mixed digital signal and determining one or more positional relationships for at least a subset of the plurality of graphical elements based, at least in part, on the mixed digital signal.

4. The method of claim 3, wherein the one or more geometric relationships define a topological correlation between the plurality of graphical elements of the graphical user interface, the topological correlation comprising a visual framework transforming uncorrelated variables comprising the one or more data streams into correlated ones comprising at least the mixed digital signal.

5. The method of claim 3, wherein continually processing the one or more data streams comprises maintaining a persistent streaming connection to one or more remote data sources, and wherein incrementally updating the two or more graphical elements comprises triggering incremental positional updates to one or more graphical elements of the plurality of graphical elements responsive to a detected change in at least one computed indicator state value.

6. The method of claim 3, wherein electronically combining the one or more data streams to generate the mixed digital signal further comprises, for at least one of the one or more unique identifier values for which options data is available: computing a net debit or net credit for one or more covered call positions based on current market price, option premium, and strike price data from the one or more data streams; computing an annualized return for at least one of the one or more covered call positions; and generating a covered call opportunity marker within one or more concentrically-aligned annular regions of the dynamic wheel-type digital interface for unique identifier values for which the computed annualized return meets or exceeds a defined threshold.

7. The method of claim 2, wherein the one or more content categories comprise two or more of: an equity investor category; an active trader category; an options trader category; a first cryptocurrency category; a second cryptocurrency category; a Forex category; or any combination thereof, individual ones of the one or more content categories rendered as a distinct dynamic wheel-type digital interface having a respective on-screen layout encoding a distinct set of content-category-specific indicator state values within the one or more concentrically-aligned annular regions.

8. The method of claim 2, wherein the one or more unique identifier values are associated with one or more digital markers placed within the one or more concentrically-aligned annular regions, the one or more digital markers denoting at least one of: a ratio specifying whether the one or more unique identifier values is within a predetermined threshold; an upcoming event for the one or more unique identifier values; a recent event for the one or more unique identifier values; a chronological event; a forecasting event; or any combination thereof.

9. The method of claim 2, wherein at least one of the one or more action-signal symbols comprise: a unique identifier value comprising a ticker string; and a visual encoding applied to at least a portion of the ticker string representing one of a plurality of computed action states comprising buy, sell, or hold; and wherein the visual encoding comprises at least one of: color;
font weight; underline; border; iconography; animation; positional offset applied to at least a portion of the ticker string; or any combination thereof.

10. The method of claim 1, further comprising dynamically adjusting the particular on-screen layout of the dynamic wheel-type digital interface based at least in part on continually processing the one or more data streams by the one or more processors.

11. The method of claim 10, wherein the dynamically adjusting comprises repositioning the two or more graphical elements as part of the particular on-screen layout of the dynamic wheel-type digital interface based at least in part on continually processing the one or more data streams by the one or more processors.

12. The method of claim 10, wherein the dynamically adjusting comprises digitally rotating at least a portion of the dynamic wheel-type digital interface about a rotation point of the origin element based at least in part on at least one of: a qualitative event record for the one or more unique identifier values; a quantitative event record for the one or more unique identifier values;
or any combination thereof.

13. The method of claim 12, wherein the dynamically adjusting comprises digitally rotating at least a portion of the dynamic wheel-type digital interface in at least one of: a clockwise direction; a counterclockwise direction; or any combination thereof.

14. The method of claim 13, wherein the direction of the digitally rotating is based at least in part on an online activity for the one or more unique identifier values over a pre-determined period of time, the online activity comprising a total number of electronic transactions recorded for the one or more unique identifier values.

15. The method of claim 1, wherein the one or more unique identifier values comprise at least one of: a numerical value; an alphabetic value; an alphanumeric value; or any combination thereof, and wherein the one or more unique identifier values represent one or more digital items denoting at least one of: a digital representation of ownership; a tangible digital asset; a real-world asset recorded via a digital ledger; a digital item capable of being processed electronically;
or any combination thereof.

16. The method of claim 1, wherein the one or more data streams comprise, for individual ones of the one or more unique identifier values, one or more of: historical sale prices; real-time market prices; trade volume; corporate action data; dividend schedule data; options chain data;
options open interest; implied volatility data; or any combination thereof.

17. The method of claim 1, further comprising:
computing, for at least one of a plurality of user accounts, a performance score based, at least in part, on one or more quantitative metrics calculated from electronic activity records occurring on or after a performance baseline date corresponding to the earlier of an account creation date or a portfolio import date, the quantitative metrics comprising one or more of: realized return; unrealized return; risk-adjusted return; portfolio diversification across asset categories; consistency of returns over a defined evaluation period; or any combination thereof;
ranking the plurality of user accounts according to the computed performance scores within one or more trader categories; and
generating a leaderboard data structure associating the ranked user accounts with their respective computed performance scores and trader category rankings, and rendering the leaderboard data structure within the graphical user interface.

18. The method of claim 1, further comprising:
receiving, from a first user account, a monetization configuration specifying a content access type comprising at least one of: a point-in-time portfolio snapshot; a portfolio activity feed; a trading history record; or any combination thereof, together with an access price and an access duration;
receiving, from a second user account, a payment authorization for the access price;
upon confirmation of the payment authorization, generating a time-bounded access token associated with the second user account and the content access type of the first user account; and
transmitting, via a network interface to a computing device associated with the second user account, a data representation of the content access type of the first user account for the access duration.

19. The method of claim 1, further comprising:
receiving a sharing configuration from a first user account designating one or more second user accounts as authorized recipients of a shared portfolio display associated with the first user account;
transmitting, via a network interface to computing devices associated with the one or more designated second user accounts, a data representation of the shared portfolio display;
establishing a communication session among the first user account and the one or more designated second user accounts, the communication session comprising at least one of: a text-based messaging channel; a video conferencing channel rendered in association with the shared portfolio display; or any combination thereof; and
incorporating asset holdings from the shared portfolio display into a common holdings display region that aggregates asset holdings across two or more shared portfolio displays and updates incrementally in response to changes in any aggregated portfolio display.

20. An article, comprising:
a computer-readable medium having stored thereon instructions executable by a computing device to:
electronically generate, via a graphical user interface rendered on a display device of a client computing device, a digital representation of one or more content categories, at least one content category of the one or more content categories comprising a dynamic wheel-type digital interface with a particular on-screen layout digitally rendered via a plurality of graphical elements based, at least in part, on the one or more content categories, wherein electronically generating comprises generating the plurality of graphical elements, the plurality of graphical elements arranged within a common region extending radially from an origin element;
receive, by one or more processors of the computing device, one or more data streams from a plurality of sources, the one or more data streams comprising real-time updates and historical data records associated with one or more unique identifier values of the one or more content categories;
normalize and temporally aligning the one or more data streams to generate one or more time-indexed datasets, the one or more time-indexed datasets organizing the real-time updates and historical data records according to the one or more unique identifier values and a time dimension;
compute, based at least in part on the one or more time-indexed datasets, one or more geometric relationships between two or more graphical elements of the plurality of graphical elements; and
incrementally update the two or more graphical elements of the dynamic wheel-type digital interface as part of the particular on-screen layout in response to detected changes in the one or more data streams based at least in part on the one or more geometric relationships.

21. An apparatus, comprising:
a processor coupled to a memory of at least one computing device, the processor to:
electronically generate, via a graphical user interface rendered on a display device of a client computing device, a digital representation of one or more content categories, at least one content category of the one or more content categories comprising a dynamic wheel-type digital interface with a particular on-screen layout digitally rendered via a plurality of graphical elements based, at least in part, on the one or more content categories, wherein electronically generating comprises generating the plurality of graphical elements, the plurality of graphical elements arranged within a common region extending radially from an origin element;
receive, by one or more processors of the computing device, one or more data streams from a plurality of sources, the one or more data streams comprising real-time updates and historical data records associated with one or more unique identifier values of the one or more content categories;
normalize and temporally aligning the one or more data streams to generate one or more time-indexed datasets, the one or more time-indexed datasets organizing the real-time updates and historical data records according to the one or more unique identifier values and a time dimension;
compute, based at least in part on the one or more time-indexed datasets, one or more geometric relationships between two or more graphical elements of the plurality of graphical elements; and
incrementally update the two or more graphical elements of the dynamic wheel-type digital interface as part of the particular on-screen layout in response to detected changes in the one or more data streams based at least in part on the one or more geometric relationships.
